(19) United States
(12) Patent Application Publication
(10) Pub. No.: US 2024/0238771 A1
(43) Pub. Date: Jul. 18, 2024

(54) SUPPORTED RARE EARTH CATALYSTS AND CATALYTIC CH BORYLATION OF HYDROCARBONS

(71) Applicant: Iowa State University Research Foundation, Inc., Ames, IA (US)

(72) Inventors: Aaron David Sadow, Ames, IA (US); Long Qi, Ames, IA (US); Yuting Li, Ames, IA (US); Uddhav Kanbur, Ames, IA (US); Scott Southern, Ames, IA (US); Frederic A. Perras, Ames, IA (US); Takeshi Kobayashi, Ames, IA (US)

(21) Appl. No.: 18/405,475

(22) Filed: Jan. 5, 2024

Related U.S. Application Data
(60) Provisional application No. 63/437,186, filed on Jan. 5, 2023.

(51) Int. Cl. B01J 31/22; B01J 29/08; B01J 31/26; B01J 37/02; C07F 5/02

(52) U.S. Cl. CPC B01J 31/2208; B01J 29/088; B01J 31/2295; B01J 31/26; B01J 37/0217; B01J 37/0219; B01J 37/0228; C07F 5/025; B01J 2231/323; B01J 2531/0205; B01J 2531/31; B01J 2531/37

(57) ABSTRACT

The present application is directed to a supported rare earth-catalyst. This catalyst comprises a metal oxide support having Brønsted acid sites and a rare earth element-catalyst. The rare earth element-catalyst is bound to the Brønsted acid sites on the metal oxide support. The present application is also directed to methods of making supported rare earth-catalyst and methods for borylation of hydrocarbons using the supported rare earth-catalyst.

This application claims the benefit of U.S. Provisional Patent Application Ser. No. 63/437,186, filed Jan. 5, 2023, which is hereby incorporated by reference in its entirety.

This invention was made with government support under DE-AC02-07 CH11358 awarded by Department of Energy. The government has certain rights in the invention.

### FIELD

The present application relates to rare earth element borohydride supported inside metal oxide support and catalytic CH borylation of hydrocarbons.

### BACKGROUND

Hydrocarbon C—H borylation with pinacol diborane (B₂pin₂), efficiently catalyzed by Group 9 organometallics (Cook et al., “Catalyst-Controlled Selectivity in the C—H Borylation of Methane and Ethane,” Science 351:1421-1424 (2016); Smith et al., “Catalytic Borylation of Methane,” Science 351:1424-1427 (2016); Jones et al., “Iridium-Catalyzed sp3 C—H Borylation in Hydrocarbon Solvent Enabled by 2,2′-Dipyridylarylmethane Ligands,” J. Am. Chem. Soc. 142:6488-6492 (2020); Zhong et al., “Methane Borylation Catalyzed by Ru, Rh, and Ir Complexes in Comparison with Cyclohexane Borylation: Theoretical Understanding and Prediction,” J. Am. Chem. Soc. 142:16732-16747 (2020)), is a single-step functionalization that provides versatile organoboranes (Cook et al., “Catalyst-Controlled Selectivity in the C—H Borylation of Methane and Ethane,” Science 351:1421-1424 (2016); Smith et al., “Catalytic Borylation of Methane,” Science 351:1424-1427 (2016); Jones et al., “Iridium-Catalyzed sp3 C—H Borylation in Hydrocarbon Solvent Enabled by 2,2′-Dipyridylarylmethane Ligands,” J. Am. Chem. Soc. 142:6488-6492 (2020); J. F. Hartwig, “Borylation and Silylation of C—H Bonds: A Platform for Diverse C—H Bond Functionalizations,” Accounts Chem. Res. 45:864-873 (2012); Ishiyama et al., “Mild Iridium-Catalyzed Borylation of Arenes. High Turnover Numbers, Room Temperature Reactions, and Isolation of a Potential Intermediate,” J. Am. Chem. Soc. 124:390-391 (2002); Cho et al., “Remarkably Selective Iridium Catalysts for the Elaboration of Aromatic C—H Bonds,” Science 295:305-308 (2002)). Catalysts that access new mechanisms or distinct selectivity for C—H borylation, utilize earth-abundant metal centers such as lanthanum (an over-produced co-product of technologically essential rare earth elements), or use simpler boranes such as the pinacolborane (HBpin) reagent could complement late metal catalysts that currently dominate this transformation. In particular, catalysts employing d⁰ or d⁰fⁿ centers are appealing for new C—H borylations, given well-established C—H bond activations mediated (Watson et al., “Organolanthanides in Catalysis,” Accounts Chem. Res. 18:51-56 (1985); Thompson et al., “σ Bond Metathesis for Carbon-Hydrogen Bonds of Hydrocarbons and Sc—R (R═H, alkyl, aryl) Bonds of Permethylscandocene Derivatives. Evidence for Noninvolvement of the π System in Electrophilic Activation of Aromatic and Vinylic C—H Bonds,” J. Am. Chem. Soc. 109:203-219 (1987); Smith et al., “Carbon-Hydrogen Bond Activating Reactions of Thoracyclobutanes. Routes to Unusual Actinide-Transition Metal μ-Methylene Complexes,” J. Am. Chem. Soc. 109:1854-1856 (1987)) or catalyzed (Corker et al., “Catalytic Cleavage of the C—H and C—C Bonds of Alkanes by Surface Organometallic Chemistry: An EXAFS and IR Characterization of a Zr—H Catalyst,” Science 271:966-969 (1996); Sadow et al., “Catalytic Functionalization of Hydrocarbons by σ-Bond-Metathesis Chemistry: Dehydrosilylation of Methane with a Scandium Catalyst,” Angew. Chem. Int. Edit. 42:803-805 (2003); Sadow et al., “Synthesis and Characterization of Scandium Silyl Complexes of the Type Cp*2ScSiHRR′. σ-Bond Metathesis Reactions and Catalytic Dehydrogenative Silation of Hydrocarbons,” J. Am. Chem. Soc. 127:643-656 (2005)) via elementary σ-bond metathesis reactions (R. Waterman, “σ-Bond Metathesis: A 30-Year Retrospective,” Organometallics 32:7249-7263 (2013)). Despite early promise (Motry et al., “Facile, Metal-Mediated Dehydrogenative Borylation of Ethylene: Selective Conversion of a Titanium-Bound Olefin to a Vinylboronate Ester,” J. Am. Chem. Soc. 117:6615-6616 (1995)), the sole example of rare earth-catalyzed C—H borylation involves ortho-directed derivatization of aromatic ethers catalyzed by 5-10 mol % (C₅Me₄H)₂LnR (Ln=Y, Lu) (Xue et al., “Ortho-Selective C—H Borylation of Aromatic Ethers with Pinacol-Borane by Organo Rare-Earth Catalysts,” ACS Catal. 8:5017-5022 (2018)) was only recently supplemented with pyridine borylation using bent-sandwich yttrium compounds (Rothbaum et al., “Chemodivergent Organolanthanide-Catalyzed C—H α-Mono-Borylation of Pyridines,” J. Am. Chem. Soc. 144:17086-17096 (2022); Luo et al., “Yttrium-Catalyzed ortho-Selective C—H Borylation of Pyridines with Pinacolborane,” Angew. Chem. Int. Ed., 61: e202117750 (2022)). Reactants and ancillary ligands' steric properties, coordination of the aryl ether, and catalyst deactivation by ring-opening of HBpin are important factors in that catalysis.

The present application is directed to overcoming these and other deficiencies in the art.

### SUMMARY

One aspect of the present application relates to a supported rare earth-catalyst. This catalyst comprises a metal oxide support having Brønsted acid sites and a rare earth element-catalyst. The rare earth element-catalyst is bound to the Brønsted acid sites on the metal oxide support.

Another aspect of the present application relates to a method of producing a supported rare earth-catalyst. This method includes providing a metal oxide support having Brønsted acid sites and providing a capping agent. The metal oxide support is reacted with the capping agent under conditions effective to produce a metal oxide support containing capped functional groups. A rare earth element-catalyst is provided and deposited on the metal oxide support containing capped functional groups to produce the supported rare earth-catalyst. The rare earth element-catalyst is bound to the Brønsted acid sites on the metal oxide support.

Another aspect of the present application relates to a method for borylation of hydrocarbons. This method includes providing a hydrocarbon, providing a supported rare earth-catalyst, and providing a borylation reagent. The hydrocarbon is reacted with the borylation reagent in the presence of the supported rare earth-catalyst under conditions effective to borylate the hydrocarbon.

Oxide-supported, confined organolanthanide compounds could potentially tolerate elevated reaction temperatures and access low-coordinate metal centers needed for C—H bond activations. Because [Ln]H HBpin adducts were proposed to directly react with carbonyls or epoxides during catalytic hydroboration reactions or act as masked hydrides (Patnaik et al., “Interconverting Lanthanum Hydride and Borohydride Catalysts for C═O Reduction and C—O Bond Cleavage,” Angew. Chem. Int. Edit. 58:2505-2509 (2019); Wang et al., “Silica-Supported Organolanthanum Catalysts for C—O Bond Cleavage in Epoxides,” J. Am. Chem. Soc. 142:2935-2947 (2020), which are hereby incorporated by reference in their entirety), it was hypothesized that related species from lanthanide borohydrides could mediate borylation of hydrocarbons. Cationic molecular and surface-supported lanthanide borohydride complexes also have shown promise in ring-opening and addition polymerization of esters (Visseaux et al., “Borohydride Complexes of Rare Earths, and Their Applications in Various Organic Transformations,” Coord. Chem. Rev. 255:374-420 (2011); Robert et al., “Cationic Rare-Earth Metal Bis(Tetrahydridoborato) Complexes: Direct Synthesis, Structure and Ring-Opening Polymerisation Activity Toward Cyclic Esters,” Dalton Trans. 2667-2669 (2008); Ajellal et al., “Polymerization of Racemic β-Butyrolactone Using Supported Catalysts: a Simple Access to Isotactic Polymers,” Chem. Commun. 46:1032-1034 (2010); Del Rosal et al., “Supported Neodymium Catalysts for MMA Polymerization: On the Origin of Surface-Induced Stereoselectivity,” Polym. Chem. 3:1730-1739 (2012), which are hereby incorporated by reference in their entirety). In addition, late metal complexes supported on metal-organic frameworks (MOFs) (Zhang et al., “Catalytic Chemoselective Functionalization of Methane in a Metal-Organic Framework,” Nat. Cat. 1:356-362 (2018); Feng et al., “Metal-Organic Framework Stabilizes a Low-Coordinate Iridium Complex for Catalytic Methane Borylation,” J. Am. Chem. Soc. 141:11196-11203 (2019); Syed et al., “Mechanistic Insights into C—H Borylation of Arenes with Organoiridium Catalysts Embedded in a Microporous Metal-Organic Framework,” Organometallics 39:1123-1133 (2020); Manna et al., “Postsynthetic Metalation of Bipyridyl-Containing Metal-Organic Frameworks for Highly Efficient Catalytic Organic Transformations,” J. Am. Chem. Soc. 136:6566-6569 (2014); Manna et al., “Chemoselective Single-Site Earth-Abundant Metal Catalysts at Metal-Organic Framework Nodes,” Nat. Commun. 7:12610 (2016); Manna et al., “Bipyridine- and Phenanthroline-Based Metal-Organic Frameworks for Highly Efficient and Tandem Catalytic Organic Transformations via Directed C—H Activation,” J. Am. Chem. Soc. 137:2665-2673 (2015); Newar et al., “Single-Site Cobalt-Catalyst Ligated with Pyridylimine-Functionalized Metal-Organic Frameworks for Arene and Benzylic Borylation,” Inorg. Chem. 59:10473-10481 (2020), which are hereby incorporated by reference in their entirety) or periodic mesoporous silicates (PMOs)(Waki et al., “A Solid Chelating Ligand: Periodic Mesoporous Organosilica Containing 2,2′-Bipyridine Within the Pore Walls,” J. Am. Chem. Soc. 136:4003-4011 (2014); Grüning et al., “Bipyridine Periodic Mesoporous Organosilica: A Solid Ligand for the Iridium-Catalyzed Borylation of C—H Bonds,” Adv. Synth. Catal. 356:673-679 (2014); Maegawa et al., “Iridium-Bipyridine Periodic Mesoporous Organosilica Catalyzed Direct C—H Borylation Using a Pinacolborane,” Dalton Trans. 44:13007-13016 (2015); which are hereby incorporated by reference in their entirety) have provided efficient catalysts for C—H borylation, often showing the benefits of site isolation (Zhang et al., “Catalytic Chemoselective Functionalization of Methane in a Metal-Organic Framework,” Nat. Cat. 1:356-362 (2018); Feng et al., “Metal-Organic Framework Stabilizes a Low-Coordinate Iridium Complex for Catalytic Methane Borylation,” J. Am. Chem. Soc. 141:11196-11203 (2019); Syed et al., “Mechanistic Insights into C—H Borylation of Arenes with Organoiridium Catalysts Embedded in a Microporous Metal-Organic Framework,” Organometallics 39:1123-1133 (2020); Manna et al., “Postsynthetic Metalation of Bipyridyl-Containing Metal-Organic Frameworks for Highly Efficient Catalytic Organic Transformations,” J. Am. Chem. Soc. 136:6566-6569 (2014); Manna et al., “Chemoselective Single-Site Earth-Abundant Metal Catalysts at Metal-Organic Framework Nodes,” Nat. Commun. 7:12610 (2016), which are hereby incorporated by reference in their entirety). Metal centers supported on zeolites are well known to catalyze other conversions of hydrocarbons, including with size and shape selectivity (Li et al., “Applications of Zeolites in Sustainable Chemistry,” Chem 3:928-949 (2017); Grundner et al., “Single-Site Trinuclear Copper Oxygen Clusters in Mordenite for Selective Conversion of Methane to Methanol,” Nat. Commun. 6:7546 (2015); Ogino et al., “Molecular Chemistry in a Zeolite: Genesis of a Zeolite Y-Supported Ruthenium Complex Catalyst,” J. Am. Chem. Soc. 130:13338-13346 (2008), which are hereby incorporated by reference in their entirety). The lanthanide borohydride species grafted at the bridging Si—OH—Al Brønsted acid sites (BAS) in zeolite micropores were identified in the present application as catalysts for C—H borylation. The strategies for increasing turnover number (TON), characterization by diffuse reflectance infrared Fourier transform spectroscopy (DRIFTS) and solid-state NMR spectroscopy, and kinetic analysis are described in the present application.

The zeolite-supported lanthanide La(BH₄)ₓ—HY₃₀ catalyzes C—H borylation of benzene with pinacolborane (HBpin), providing a complementary approach to precious-metal catalyzed borylations. The sites for catalytic CH activation were generated from La and other rare earth ions grafted at the Brønsted acid sites (BAS) in micropores of the zeolite, whereas silanoate- and aluminoate-grafted sites were inactive under the reaction conditions. Under typical catalytic conditions, conversion to phenyl pinacolborane (PhBpin) was zero-order in HBpin concentration. A turnover number (TON) of 282 and a PhBpin yield of 25% was accessed by capping silanols, selectively grafting at BAS sites, treating the catalyst with AlMe₃, and adding HBpin slowly to the reaction.

### BRIEF DESCRIPTION OF THE DRAWINGS

FIGS. 1A-1B show ¹H NMR spectrum of La(BH₄)₃(THF)₃ in toluene-d₈ (FIG. 1A) and ¹¹B NMR spectrum of La(BH₄)₃(THF)₃ in toluene-d₈ (FIG. 1).

FIG. 2 shows diffuse reflectance infrared Fourier transform spectroscopy (DRIFTS) spectra of partially dehydroxylated metal oxides (treated at 500° C. under vacuum), reactants for grafting, and grafted materials. Bottom group: TPS-Cl, La(BH₄)₃(THF)₃, and La(BH₄)ₓ(THF)ₙ—HY₃₀; 2^{nd} group from the bottom: SiO₂—Al₂O₃ and La(BH₄)ₓ(THF)ₙ—SiO₂—Al₂O₃; 3^{rd} group from the bottom: Al₂O₃ and La(BH₄)ₓ(THF)ₙ—Al₂O₃; top group: SiO₂ and La(BH₄)ₓ(THF)ₙ—SiO₂.

FIG. 3 shows ¹¹B NMR of reaction solution before (black line) and after (grey line) it was spiked with 0.006 g (0.03 mmol) of PhBpin. Reaction conditions to produce the black spectrum: 0.050 g La(BH₄)₂(THF)_{2.5}-TPS—HY₃₀ (0.05 g), benzene (1 mL), HBpin added in four portions (0.10 mL each portion, 2.7 mmol in total) heated at 120° C. for a total of 24 hours.

FIG. 4 shows a representative structure of the zeolite HY₃₀, showing the major reactive surface sites.

FIG. 5 shows ¹H NMR spectra of the La(BH₄)₃(THF)₃ in benzene-d₆ solution before and after grafting on TPS—HY₃₀. Before grafting, there was 0.075 mmol of BH₄ and THE (corresponding to 0.025 mmol of La(BH₄)₃(THF)₃ added to the solution, as well as calculated from integrals of the TMB, BH₄⁻, and THF signals). After grafting, the concentration decreased to 0.024 and 0.033 mmol, respectively. The concentration difference of BH₄ indicated 0.017 mmol La was taken up by the zeolite through grafting (or physisorption). 0.009 mmol of THF was in excess in the solution compared to the residual BH₄ in La(BH₄)₃(THF)₃. Therefore, about 0.5 equivalents of THF was released into solution per grafted La species.

FIG. 6 shows DRIFTS spectra of HY₃₀ (top), TPS—HY₃₀ (middle), and La(BH₄)₂(THF)_{2.5}-TPS—HY₃₀ (bottom), normalized to the zeolite framework signal at 1860 cm⁻¹.

FIG. 7 is a graph showing benzene borylation, catalyzed by La(BH₄)₂(THF)_{2.5}-TPS—HY₃₀, showing zero-order concentration dependence for PhBpin production and a small, normal kinetic isotope effect for C—H/C-D bond activation.

FIGS. 8A-8B are a graph showing concentration of PhBpin (grey line) and HBpin (black line) as a function of time (FIG. 8A) and a table showing fitting parameters of two plots (FIG. 8B), respectively. The zero-order rate constants for PhBpin formation and pseudo-first-order rate constant for HBpin consumption are labeled as k₁ and k₂, respectively. The term a is a curve-fitting parameter.

FIG. 9 is a graph showing portion-wise addition of HBpin (0.10 mL, 0.69 mmol every 6 hours) in benzene borylation.

FIG. 10 shows DRIFTS spectrum of Sc(BH₄)₃(THF)₂ (bottom spectra), Sc(BH₄)₃(THF)₂ grafted to SiO₂ (middle spectra), and Sc(BH₄)₃(THF)₂ grafted on Ph₃Si—HY₃₀ (top spectra).

FIG. 11 is a graph showing portion-wise addition of HBpin to Sc(BH₄)₂(THF)₂-Ph₃Si—HY₃₀. HBpin (0.15 mL, 1.04 mmol) was added at 0 hours, and then every 8 hours afterwards (1.35 mL, 9.4 mmol total). Analysis was performed at the indicated times.

FIG. 12A shows ¹H{¹¹B, ⁴⁵Sc, ¹⁷O} symmetry-based rotational-echo saturation-pulse double-resonance (S-RESPDOR) NMIR data for 2. Fits are shown as shaded ranges which represent all structures within a 90% confidence level. FIG. 12B shows determined 3D structure featuring ORTEP-like probability ellipsoids.

FIGS. 13Ai-ii shows ⁴⁵Sc magic angle spinning (MAS) NMR spectra of 1-3 acquired at 9.4 T (100 K) (FIG. 13Ai) and 14.1 T (295 K) (FIG. 13Aii). Simulations are overlaid in dashed lines with a non-dynamic simulation also shown for 2. Asterisks (*) denote spinning sidebands, daggers (†) physisorbed precursor, and double daggers (‡) decomposition products.

FIG. 13B shows ⁴⁵Sc{²⁷Al} transfer of population double-resonance (TRAPDOR) data acquired on 2, with simulations carried out using varied Sc—Al distances.

FIG. 14A shows ¹H{¹¹B, ⁴⁵Sc, ²⁷Al} S-RESPDOR NMR data acquired for 2. Fits are shown as shaded ranges which represent all structures within the 90% confidence level. FIG. 14B shows determined 3D structure.

FIG. 15A shows room-temperature ¹H{¹¹B} and ¹H{⁴⁵Sc} S-RESPDORNNMR data acquired on Sc(BH₄)₂(THF)₂-Ph₃Si—HY₃₀. FIG. 15B shows Room-temperature ¹H{¹⁷O}, ¹H{¹¹B} and ¹H{⁴⁵Sc} S-RESPDOR NMR data acquired on Sc(BH₄)₂(THF)₂—SiO₂.

FIGS. 16A-16E show geometry-optimized cluster models of the Sc(BH₄)₃(THF)₂ (1) (FIG. 16A), monopodal Sc(BH₄)₂(THF)₂—SiO₂ (2a) (FIG. 16B), bipodal Sc(BH₄)₂(THF)₂—SiO₂ (2b) (FIG. 16C), monopodal Sc(BH₄)₂(THF)₂-Ph₃Si—HY₃₀ (3a) (FIG. 16D), and bipodal Sc(BH₄)₂(THF)₂-Ph₃Si—HY₃₀ on BAS (3b) (FIG. 16E).

FIG. 17 shows graphitic processes of La(BH₄)₂(THF)₂-Ph₃Si—HY₃₀ reacted with AlMe₃ to form La(BH₄)₂(AlMe₃)-Ph₃Si—HY₃₀ and Ph₃Si—HY₃₀ reacted with AlMe₃ to form AlMeₓ-Ph₃Si—HY₃₀.

FIG. 18 shows DRIFTS spectra of AlMeₓ-HY₃₀. The strong peaks at 2962 and 2944 cm⁻¹ were assigned to C—H stretches of AlMe₃.

FIG. 19 shows ¹H solid-state nuclear magnetic resonance (SSNMR) spectrum of AlMe₃-HY₃₀. Sharp signals at ˜7.0 ppm (phenyl) and ˜2.2 ppm (methyl) correspond to adsorbed residual toluene that was the solvent used for AlMe₃ treatment. The signals of -phenyl (˜7.1 ppm) of Ph₃Si— and -silanol (˜2.1 ppm) of zeolite support overlap with peaks of adsorbed toluene. Two small signals at 0.8 ppm and 1.1 ppm are absorbed pentane that was used for capping of Ph₃Si—Cl on zeolite HY₃₀.

FIG. 20 shows ¹¹B SSNMR spectra of BHₓ—HY₃₀ and AlMe₃-BHₓ—HY₃₀. The broad BOₓH_{y} signal is a peak at +10 ppm.

FIG. 21 shows DRIFTS spectra of La(AlMe₄)₃, La(AlMe₄)ₓ—SO, La(AlMe₄)ₓ—HY₃₀, La(AlMe₄)ₓ-Ph₃Si—HY₃₀ with labeled peaks (from bottom to top).

FIG. 22 shows DRIFTS spectra of La(BH₄)₃(THF)₃, La(BH₄)₂(THF)₂-Ph₃Si—HY₃₀, and La(BH₄)₂AlMe₃-Ph₃Si—HY₃₀ (normalized to the zeolite framework peak at 1860 cm⁻¹).

FIG. 23 shows DRIFTS spectra of La(BH₄)₃(THF)₃, La(BH₄)₂(THF)₂-Ph₃Si—HY₃₀, and La(BH₄)₂(AlMe₃)-Ph₃Si—HY₃₀ with labeled peaks (from bottom to top).

FIG. 24 shows DRIFTS spectra of La—HY₃₀, AlMe₃-La—HY₃₀, La—SO, and AlMe₃-La—SO with labeled peaks (from bottom to top).

FIG. 25 shows DRIFTS spectra of Ph₃Si—Cl, HY₃₀, Ph₃Si—HY₃₀, and SiO₂ (from bottom to top).

FIGS. 26A-26C show solid-state NMR analysis: ¹¹B NMR (FIG. 26A), ¹H NMR (FIG. 26B), and ¹³C NMR (FIG. 26C) spectra of La(BH₄)₃(THF)₃, La(BH₄)₂(THF)₂-Ph₃Si—HY₃₀, and La(BH₄)₂(AlMe₃)-Ph₃Si—HY₃₀ (from bottom to top). The full ¹H NMR spectra in range of 12 to −6 ppm is shown in FIG. 39. Toluene was used as the solvent for grafting and AlMe₃ reaction was adsorbed in Ph₃Si—HY₃₀, giving sharp signals at ˜2 and ˜7 ppm in ¹H SSNMR and signals at ˜20 and ˜130 ppm in ¹³C SSNMR spectra of La(BH₄)₂(THF)₂-Ph₃Si—HY₃₀ and La(BH₄)₂(AlMe₃)-Ph₃Si—HY₃₀.

FIG. 27 shows ¹¹B SSNMR spectra of La—SO. The Si—O—La(BH₄)ₓ(THF)ₙ signal is a peak at ˜23.0 ppm and broad BOₓH_{y} signal is a peak at +10 ppm.

FIG. 28 shows ¹H solid-state NMR spectra of HY₃₀ and Ph₃Si—HY₃₀ (from bottom to top). Brønsted acid sites (BAS) and silanol sites (SiOH) were at 4.1 ppm and 1.9 ppm. Sharp signals at ˜7.0 ppm (phenyl) and ˜2.2 ppm (methyl) were adsorbed residual toluene that was the solvent used for AlMe₃ treatment. The signals of -phenyl (˜7.1 ppm) of Ph₃Si— and -silanol (˜2.1 ppm) of zeolite support overlap with peaks of adsorbed toluene. Two small signals at 0.8 ppm and 1.1 ppm correspond to the absorbed pentane that was used for capping of Ph₃Si—Cl on zeolite HY₃₀.

FIGS. 29A-29B show solution ¹H NMR (FIG. 29A) and ¹³C NMR (FIG. 29B) spectra of La(BH₄)₂(THF)₂-Ph₃Si—HY₃₀ (0.010 g) dispersed in benzene-d₆ (1.00 mL) after treating with AlMe₃ (0.10 mL). In solution ¹H NMR spectrum, the signal of AlMe₃ is at 0.36 ppm and two signals of THF are at 3.3 and 0.9 ppm. In solution ¹³C NMR spectrum, the signal of AlMe₃ is at −7.5 ppm and two signals of THF are at 70 and 24 ppm.

FIG. 30 shows a proposed structure of La(BH₄)₂(AlMe₃)-Ph₃Si—HY₃₀. Zeolite framework is represented in a wire model.

FIG. 31 shows density functional theory (DFT) calculated ¹¹B signal in the ¹¹B triple-quantum magic-angle spinning (3QMAS) spectrum of La(BH₄)₂(AlMe₃)-Ph₃Si—HY₃₀.

FIGS. 32A-32B are graphs showing benzene borylation with catalyst La(BH₄)₂AlMe₄-Ph₃Si—HY₃₀ using various amounts of HBpin (FIG. 32A) or different amounts of catalysts (FIG. 32B). Reaction conditions for FIG. 32A: 1.0 mL benzene and 0.05, 0.10, 0.20, 0.30 mL HBpin (corresponding to 0.35, 0.69, 1.4, and 2.1 mmol, respectively) were combined with 0.025 g La(BH₄)₂(AlMe₃)-Ph₃Si—HY₃₀ and heated at 120° C. for 36-48 hours to reach >70% conversion of HBpin. Reaction condition for FIG. 32B: 1.0 mL benzene and 0.10 mL HBpin (0.70 mmol) were combined with 0.010, 0.030, 0.050, and 0.070 g of La(BH₄)₂AlMe₄-Ph₃Si—HY₃₀ (0.001, 0.002, 0.004, and 0.005 mmol of La) were heated at 120° C. for 36-72 hours to reach 70-82% conversion of HBpin.

FIG. 33 is a bar graph showing amount of MeBpin formation (left axis) and percentage of formed MeBpin in total HBpin conversion (right axis) during the benzene borylation reactions in the presence of different amount of La(BH₄)₂(AlMe₃)-Ph₃Si—HY₃₀. Reaction conditions: 0.010, 0.030, 0.050, 0.070 g of La(BH₄)₂(AlMe₃)-TPS—HY₃₀ were individually added to the mixture of benzene (1.00 mL) and HBpin (0.10 mL, 0.69 mmol) and heated to 120° C. for 72 hours, 60 hours, 48 hours, 36 hours, respectively to achieve conversion of HBpin at 82%, 77%, 80%, and 70%.

FIG. 34A is a graph showing HBpin conversion versus time during the borylation of benzene (diamond) and benzene-d₆ (circle) catalyzed by La(BH₄)₂(AlMe₃)-Ph₃Si—HY₃₀. FIGS. 34B-34C are graphs showing PhBpin concentration (FIG. 34B) and HBpin concentration (FIG. 34C) plotted as a function of reaction time. FIG. 34D shows fitting parameters for PhBpin formation and HBpin consumption. Reaction conditions: 1.00 mL benzene, 0.10 mL HBpin (0.69 mmol) and 0.030 mg La(BH₄)₂(AlMe₃)-Ph₃Si—HY₃₀ were heated to 120° C. for 3, 6, 12, 18, 24, 36, 48, 60, 72 hours; 1.00 mL benzene-d₆, 0.10 mL HBpin (0.69 mmol) and 0.030 mg La(BH₄)₂(AlMe₃)-Ph₃Si—HY₃₀ were heated to 120° C. for 6, 12, 24, 36 hours.

FIGS. 35A-35B are graphs showing temperature effect of benzene borylation via La(BH₄)₂(AlMe₃)-Ph₃Si—HY₃₀. Reaction conditions for FIG. 35A: 1.00 mL benzene, 0.10 mL HBpin (0.69 mmol) and 0.030 g of La(BH₄)₂(AlMe₃)-Ph₃Si—HY₃₀ (˜0.002 mmol La) were heated at 110, 120, 130, 140, and 150° C. for 48 hours, 36 hours, 24 hours, 18 hours, and 12 hours, respectively. Reaction conditions for FIG. 35B: 1.00 mL benzene, 0.10 mL HBpin (0.69 mmol) and 0.030 g of La(BH₄)₂(AlMe₃)-Ph₃Si—HY₃₀ (˜0.002 mmol La) were heated at 110, 120, 130, 140, and 150° C. for 24 hours, 20 hours, 16 hours, 12 hours, and 8 hours, respectively to control the conversion of HBpin less than 35% in each experiment. Squares show conversion, diamonds show selectivity, and circles show yield.

FIGS. 36A-36B are graphs showing concentrations of formed PhBpin (FIG. 36A) and concentrations of consumed HBpin (FIG. 36B), as a function of reaction time, during benzene borylation in presentence of La(BH₄)₂AlMe₃-Ph₃Si—HY₃₀ at 110-150° C., respectively. Reaction conditions: 1.0 mL benzene or benzene-d₆, 0.1 mL HBpin, 0.030 g La(BH₄)₂AlMe₃-Ph₃Si—HY₃₀ as the precatalyst.

FIGS. 37A-37B are graphs showing time study (FIG. 37A) and Eyring plot (FIG. 37B) of benzene borylation in presentence of La(BH₄)₂(AlMe₃)-Ph₃Si—HY₃₀ during 110-150° C. Time-resolved study was conducted by plotting turnovers of benzene and benzene-d₆ borylation as a function of reaction time. General reaction conditions: 1.0 mL benzene or benzene-d₆, 0.1 mL HBpin, 0.030 g La(BH₄)₂(AlMe₃)-Ph₃Si—HY₃₀ as the precatalyst. The reaction mixture was heated at 120° C. for a certain reaction time (0-72 hours).

FIG. 38 shows substrate scope of borylation reactions. Turnovers were calculated for the sum of borylated products when stereo isomers were formed.

FIG. 39 shows ¹H SSNMR spectrum of La(BH₄)₃(THF)₃, La(BH₄)₂(THF)₂-Ph₃Si—HY₃₀, and La(BH₄)₂(AlMe₃)-Ph₃Si—HY₃₀. Sharp signals at ˜7.0 ppm (phenyl) and ˜2.2 ppm (methyl) correspond to adsorbed residual toluene that was the solvent used for AlMe₃ treatment. The signals of -phenyl (˜7.1 ppm) of Ph₃Si— and -silanol (˜2.1 ppm) of zeolite support overlap with peaks of adsorbed toluene. Two small signals at 0.8 ppm and 1.1 ppm correspond to absorbed pentane that was used for capping of Ph₃Si—Cl on zeolite HY₃₀.

FIG. 40 is a graph showing results of experiments using portion addition of HBpin. Reaction conditions: 0.050 g of La(BH₄)₂(AlMe₃)-Ph₃Si—HY₃₀, 1.0 mL benzene, and 0.05 mL HBpin (0.35 mmol) were heated at 120° C. for the first 24 hours. Then the new portion of HBpin (0.05 mL, 0.35 mmol) was added into reaction solution every 24 hours. Products were measured from first reaction batch and after adding one new portion.

FIG. 41 shows ¹¹B NMR spectrum of the reaction solution after the 5^{th} portion addition of HBpin (in benzene-d₆), showing the formation of PhBpin (at ˜31.3 ppm).

FIG. 42 shows experimental ¹H MAS NMR spectra of Sc(BH₄)₃(THF)₂, Sc(BH₄)₂(THF)₂-Ph₃Si—HY₃₀, and Sc(BH₄)₂(THF)₂—SiO₂. In the case of Sc(BH₄)₂(THF)₂-Ph₃Si—HY₃₀ the α-THF resonance is broader and obscured by the Ph₃Si and β-THF resonances. It is most clearly viewed in a ¹H{⁴⁵Sc} S-RESPDOR difference spectrum due to its stronger ¹H—⁴⁵Sc dipolar coupling. Such a spectrum is shown in grey.

FIGS. 43A-43B show ¹¹B MAS NMR spectra of Sc(BH₄)₃(THF)₂, acquired at two temperatures (FIG. 43A), and room temperature (FIG. 43B). i. Sc(BH₄)₂(THF)₂-Ph₃Si—HY₃₀ and ii. Sc(BH₄)₂(THF)₂—SiO₂. The peak at c.a. −42 ppm is attributed to uncoordinated anionic borohydride. All spectra were acquired at 9.4 T.

FIG. 44 shows experimental (bottom spectra) and simulated (top spectra) static ⁴⁵Sc NMR spectra of Sc(BH₄)₃(THF)₂ acquired at 9.4 T.

FIG. 45 shows C—H borylation catalyzed by zeolite-supported La organometallic.

### DETAILED DESCRIPTION

One aspect of the present application relates to a supported rare earth-catalyst. This catalyst comprises a metal oxide support having Brønsted acid sites and a rare earth element-catalyst. The rare earth element-catalyst is bound to the Brønsted acid sites on the metal oxide support.

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

The term “hydrocarbon” refers to a compound consisting of hydrogen and carbon. The term is inclusive of both saturated and/or unsaturated aliphatic compounds, aromatic compounds, saturated and/or unsaturated aliphatic compounds substituted with aromatic functional groups, aromatic compounds substituted with saturated and/or unsaturated aliphatic functional groups, and combinations thereof. Aliphatic compounds are inclusive of linear and/or branched and/or cyclic aliphatic compounds.

The term “alkyl” means an aliphatic hydrocarbon group which may be straight or branched having about 1 to about 12 carbon atoms in the chain. Branched means that one or more lower alkyl groups such as methyl, ethyl, or propyl are attached to a linear alkyl chain. Exemplary alkyl groups include methyl, ethyl, n-propyl, i-propyl, n-butyl, t-butyl, n-pentyl, and 3-pentyl.

The term “cycloalkyl” means a non-aromatic mono- or multicyclic ring system of about 3 to about 12 carbon atoms, preferably of about 3 to about 6 carbon atoms. Exemplary monocyclic cycloalkyls include cyclopentyl, cyclohexyl, cycloheptyl, bicyclo[1.1.1]pentyl, adamantly, and the like.

The term “alkenyl” means an aliphatic hydrocarbon group containing a carbon carbon double bond and which may be straight or branched having about 2 to about 12 carbon atoms in the chain. Particular alkenyl groups have 2 to about 6 carbon atoms in the chain. Branched means that one or more lower alkyl groups such as methyl, ethyl, or propyl are attached to a linear alkenyl chain. Exemplary alkenyl groups include ethenyl, propenyl, n-butenyl, and i-butenyl.

The term “halogen” means fluoro, chloro, bromo, or iodo.

The term “aryl” means an aromatic monocyclic or multicyclic ring system of 6 to about 14 carbon atoms, preferably of 6 to about 10 carbon atoms. Representative aryl groups include phenyl and naphthyl.

As used herein, the term “alkane” refers to aliphatic hydrocarbons of formula CₙH₂ₙ₊₂, which may be straight or branched having about 1 to about 100 (e.g., 1-2, 1-3, 1-4, 1-5, 1-6, 1-7, 1-8) carbon atoms in the chain. Branched means that one or more lower alkyl groups such as methyl, ethyl, or propyl are attached to a linear alkyl chain. Exemplary alkanes include methane, ethane, n-propane, i-propane, n-butane, t-butane, n-pentane, and 3-pentane.

As used herein, the term “alkene” refers to aliphatic unsaturated hydrocarbons of formula CₙH₂ₙ, which may be straight or branched having about 2 to about 100 (e.g., 2-3, 2-4, 2-5, 2-6, 2-7, 2-8) carbon atoms in the chain. Exemplary alkenes include ethylene, propylene, n-butylene, and i-butylene.

As used herein, the term “alkyne” refers to aliphatic unsaturated hydrocarbons of formula CₙH_{2n -2}, which may be straight or branched having about 2 to about 100 (e.g., 2-3, 2-4, 2-5, 2-6, 2-7, 2-8) carbon atoms in the chain. Exemplary alkynes include acetylene, propyne, butyne, and pentyne.

As used herein, the term “cycloalkane” refers to aliphatic hydrocarbons of formula CₙH₂ₙ, which may be straight or branched having about 3 to about 8 carbon atoms in the chain. Exemplary cycloalkanes include cyclopropane, cyclobutane, cyclopentane, cyclohexane, and cycloheptane.

As used herein, “aromatic hydrocarbon” or “aromatic ring” and “heteroaromatic hydrocarbon” or “heteroaromatic ring” can be any single, multiple, or fused ring structures. For example, aromatic or heteroaromatic rings include 5- or 6-membered aromatic or heteroaromatic rings containing 0-3 (0, 1, 2, or 3) heteroatoms selected from O, N, and S; a bicyclic 9- or 10-membered aromatic or heteroaromatic ring system containing 0-3 (0, 1, 2, or 3) heteroatoms selected from O, N, and S; or a tricyclic 13- or 14-membered aromatic or heteroaromatic ring system containing 0-3 (0, 1, 2, or 3) heteroatoms selected from O, N, and S. Aromatic 5-to 14-membered (5-, 6-, 7-, 8-, 9-, 10-, 11-, 12-, 13-, or 14-membered) carbocyclic rings include, e.g., cyclopenta-1,3-diene, benzene, naphthalene, indane, indene, tetralin, and anthracene. 5-to 10-Membered (5-, 6-, 7-, 8-, 9-, or 10-membered) aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole, pyrazole, benzimidazole, pyridazine, pyrrole, imidazole, oxazole, isooxazole, indazole, isoindole, imidazole, purine, triazine, quinazoline, cinnoline, benzoxazole, acridine, benzisooxazole, and benzothiazole.

The term “substituted” or “substitution” of an atom means that one or more hydrogen on the designated atom is replaced with a selection from the indicated group, provided that the designated atom's normal valency is not exceeded.

The term “optionally substituted” is used to indicate that a group may have a substituent at each substitutable atom of the group (including more than one substituent on a single atom), provided that the designated atom's normal valency is not exceeded, and the identity of each substituent is independent of the others. Up to three H atoms in each residue are replaced with alkyl, halogen, haloalkyl, hydroxy, alkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, heteroaryl, phenoxy, benzyloxy, or heteroaryloxy.

“Unsubstituted” atoms bear all of the hydrogen atoms dictated by their valency. When a substituent is keto (i.e., ═O), then two hydrogens on the atom are replaced. Combinations of substituents and/or variables are permissible only if such combinations result in stable compounds; by “stable compound” or “stable structure” is meant a compound that is sufficiently robust to survive isolation to a useful degree of purity from a reaction mixture.

The term “about” for any numerical values or ranges indicate a suitable dimensional tolerance that allows the part or collection of components to function for its intended purpose as described herein. More specifically, “about” may refer to the range of values±20% of the recited value, e.g. “about 90%” may refer to the range of values from 71% to 99%.

The term “lanthanide” or “lanthanide metal atom” refers to the element with atomic numbers 57 to 71. Lanthanides include La, Ce, Pr, Nd, Pm, Sm, Eu, Gd, Tb, Dy, Ho, Er, Tm, Yb, and Lu.

The term “rare earth metal” refers to Y, Sc, and lanthanides. Rare earth metals include Sc, Y, La, Ce, Pr, Nd, Pm, Sm, Eu, Gd, Tb, Dy, Ho, Er, Tm, Yb, and Lu.

The metal oxide supports that can be used according to the present application include inorganic oxides, clay minerals, zeolites, mesoporous oxides, metal-organic frameworks (MOF), and the like.

Suitable metal oxide supports include, without limitation, main-group metal oxides and transition metal oxides, such as SiO₂, Al₂O₃, MgO, ZrO₂, TiO₂, HfO₂, B₂O₃, La₂O₃, CaO, ZnO, BaO, ThO₂ and mixtures thereof, e.g., SiO₂—Al₂O₃, SiO₂—MgO, and SiO₂—TiO₂—MgO. The materials can be non-porous or containing porous structures. Example clay minerals useful in accordance with the present application include kaolin, bentonite, kibushi clay, geyloam clay, allophane, hisingerite, pyrophylite, talc, micas, montmorillonites, vermiculite, chlorites, palygorskite, kaolinite, nacrite, dickite, halloysite and the like.

In some embodiments, the metal oxide support can comprise silica, alumina, or silica-alumina. In one embodiment, the metal oxide support is a silica-alumina support.

In at least one embodiment, zeolite is used as the metal oxide support.

Zeolites are a group of minerals that include hydrated aluminosilicates, silicophosphates, aluminosilicophosphates, borosilicates, and gallosilicates of proton (acidic version of the zeolite), sodium, potassium, magnesium, and/or barium. While some zeolites can be found in nature, many commercially available zeolites are synthetically manufactured.

Zeolites that can be used according to the present application include zeolites having SiO₂/Al₂O₃ mole ratio from about 0.2 to about 1000. Preferably, zeolites having a SiO₂/Al₂O₃ mole ratio from about 25 to about 500 (zeolites having Si/Al mole ratio from about 12.5 to about 250). Suitable zeolites that can be used include FAU, BEA, MFI, FER, MOR, LTA, LTL, AEL, AFO, and JZO. In one embodiment, the zeolite is a microporous faujasite zeolite (FAU with SiO₂/Al₂O₃=60, namely HY₃₀).

Faujasite (FAU) has SiO₂/Al₂O₃ mole ratio of 5.1, 5.2, 12, 30, 60, 80, 100, or 500. Beta polymorph A zeolite (BEA) has SiO₂/Al₂O₃ mole ratio of 25-300. Pentasil zeolite (MFI) has SiO₂/Al₂O₃ mole ratio of 20-1000. Ferrierite zeolite (FER) has SiO₂/Al₂O₃ mole ratio of 18-20. Mordenite (MOR zeolite) has SiO₂/Al₂O₃ mole ratio of 13-240. Linde type A framework zeolite (LTA) (zeolite A) has SiO₂/Al₂O₃ mole ratio of 6.1. Linde type L framework zeolite (LTL) (zeolite L) has SiO₂/Al₂O₃ mole ratio of 6. AEL type framework zeolite (SAPO-11) has SiO₂/Al₂O₃ mole ratio of ˜0.25. AFO type framework zeolite (SAPO-34) has SiO₂/Al₂O₃ mole ratio of ˜0.5. JZO type framework zeolite (ZEO-1) has SiO₂/Al₂O₃ mole ratio of 14.5.

Mesoporous metal oxides are a class of metal oxide materials with mesopores, typically with diameters ranging from 2-5 nm. The metal oxide may be a single component material (e.g., mesoporous silica, mSiO₂) or a mixed-metal oxide (e.g., mesoporous silica-alumina, mSiO₂—Al₂O₃). The metal oxide framework may be amorphous, semicrystalline, or crystalline. The mesopores may be ordered or non-ordered. Mesoporous silica (mSiO₂) can be defined as a form of silica with mesoporous structure, having pores of 2-50 nm, exemplified by MCM-41, MCM-48, or SBA-15.

Metal-organic frameworks (MOFs) are a class of porous, crystalline materials with a broad range of applications. MOFs are composed of metal ions or clusters, which act as the joints, bound by multidirectional organic ligands, which act as linkers in the network structure. These networks can be 1-D, 2-D, or 3-D extended, periodic structures. The joints and linkers assemble in such a way that regular arrays are formed, resulting in robust (often porous) materials analogous to zeolites.

The metal oxide support can be porous or non-porous. Zeolites are unique in that their regular crystalline structure results in the zeolite having significant microporosity formed by interconnected voids. Most zeolites have inner voids with pore openings ranging from 3-15 Å. The pore opening of the zeolite is defined as the size of the opening into the pore (the size of the largest sphere that could diffuse into the pore) and may be determined by the size of the molecular ring forming the opening of the pore. For example, a zeolite with a 12-membered ring pore opening has a pore opening of 7.4 Å. The size of the inner cavity of the pore may be larger than the pore size. Pore opening may be measured using any conventional technique, such as physisorption.

The metal oxide support can be amorphous or crystalline.

In one embodiment, the metal oxide support has capped functional groups.

In another embodiment, the metal oxide support is zeolite having capped silanol groups and micropores within which are Brønsted acid sites.

The Brønsted acid sites (BAS) are metal-hydroxyl groups or bimetallic bridging hydroxyl structures.

In some embodiments, the Brønsted acid sites have the following structure: Al—OH—Si.

In some embodiments, the rare earth element-catalyst is located within about 2.0 Å to about 4.0 Å from the Brønsted acid sites. For example, the metal atom from rare earth element-catalyst is located within about 2.3 Å to about 3.9 Å, about 2.3 Å to about 3.8 Å, about 2.3 Å to about 3.7 Å, about 2.3 Å to about 3.6 Å, about 2.3 Å to about 3.5 Å, about 2.3 Å to about 3.3 Å, about 2.5 Å to about 3.3 Å, about 2.6 Å to about 3.3 Å, about 2.7 Å to about 3.3 Å, about 2.8 Å to about 3.3 Å, about 2.9 Å to about 3.3 Å, about 2.7 Å to about 3.2 Å, about 2.9 Å to about 4.0 Å, about 3.0 Å to about 3.9 Å, about 3.1 Å to about 3.9 Å, or about 3.3 Å to about 3.6 Å from the Al atom from Brønsted acid sites. For example, the metal atom from rare earth element-catalyst is located within about 2.3 Å, about 2.4 Å, about 2.5 Å, about 2.6 Å, about 2.7 Å, about 2.8 Å, about 2.9 Å, about 3.0 Å, about 3.1 Å, about 3.2 Å, about 3.3 Å, about 3.4 Å, about 3.5 Å, about 3.6 Å, about 3.7 Å, about 3.8 Å, about 3.9 Å, or about 4.0 Å from the Al atom from Brønsted acid sites.

In some embodiments, the metal atom from rare earth element-catalyst is located within about 2.3 Å to about 3.9 Å, about 2.3 Å to about 3.8 Å, about 2.3 Å to about 3.7 Å, about 2.3 Å to about 3.6 Å, about 2.3 Å to about 3.5 Å, about 2.3 Å to about 3.3 Å, about 2.5 Å to about 3.3 Å, about 2.6 Å to about 3.3 Å, about 2.7 Å to about 3.3 Å, about 2.8 Å to about 3.3 Å, about 2.9 Å to about 3.3 Å, about 2.7 Å to about 3.2 Å, about 2.9 Å to about 4.0 Å, about 3.0 Å to about 3.9 Å, about 3.1 Å to about 3.9 Å, or about 3.3 Å to about 3.6 Å from the O atom from Brønsted acid sites. For example, the metal atom from rare earth element-catalyst is located within about 2.3 Å, about 2.4 Å, about 2.5 Å, about 2.6 Å, about 2.7 Å, about 2.8 Å, about 2.9 Å, about 3.0 Å, about 3.1 Å, about 3.2 Å, about 3.3 Å, about 3.4 Å, about 3.5 Å, about 3.6 Å, about 3.7 Å, about 3.8 Å, about 3.9 Å, or about 4.0 Å from the O atom from Brønsted acid sites.

In some embodiment, the rare earth element-catalyst is a group 3 or lanthanide containing catalyst.

In one embodiment, the rare earth element-catalyst contains Sc, Y, La, Ce, Pr, Nd, Sm, Eu, Gd, Tb, Dy, Ho, Er, Tm, Yb, or Lu.

In one embodiment, the rare earth element-catalyst has the formula M(BH₄)ₓ(THF)ₙ, where M is a rare earth metal; x is from 0-2; and n is 0-4. When x is 0 and y is 0, the rare earth element-catalyst has the formula MH or MH₂.

In some embodiments, the rare earth element-catalyst has the formula La(BH₄)ₓ(THF)ₙ, where x is from 0-2 and n is 0-4.

In some embodiments, the rare earth element-catalyst has the formula Sc(BH₄)ₓ(THF)ₙ, where x is from 0-2 and n is 0-4.

In some embodiments, the rare earth element-catalyst has the formula Y(BH₄)ₓ(THF)ₙ, where x is from 0-2 and n is 0-4.

In some embodiments, the rare earth element-catalyst has the formula Lu(BH₄)ₓ(THF)ₙ, where x is from 0-2 and n is 0-4.

In some embodiments, the rare earth element-catalyst has the formula M(AlMe₄)_{y}, where M is a rare earth metal and y is from 0-2. When y is 0, the rare earth element-catalyst has the formula MH or MH₂. In some embodiments, the rare earth element-catalyst has the formula LaH, LaH₂, LnH, LnH₂, YH, or YH₂.

In another embodiment, the rare earth element-catalyst has the formula M(AlMe₄)_{y}, where M is a rare earth metal and y is from 1-2.

In some embodiments, the rare earth element-catalyst has the formula La(AlMe₄)_{y}, where y is from 1-2.

In some embodiments, the rare earth element-catalyst has the formula M(AlEt₄)_{y}, where M is a rare earth metal and y is from 1-2.

In some embodiments, the rare earth element-catalyst has the formula Ln(AlEt₄)_{y}, where y is from 1-2.

In some embodiments, the rare earth element-catalyst has the formula Y(AlMe₄)_{y}, where y is from 1-2.

In a further embodiment, the zeolite-supported rare earth-catalyst has the formula M(BH₄)ₓ(THF)ₙ-CG-HY₃₀, where M is a rare earth metal; CG is a capping group; and HY₃₀ is a microporous faujasite zeolite.

In another embodiment, the zeolite-supported rare earth-catalyst has the formula M(BH₄)ₓ(THF)ₙ-CG-HY₃₀, wherein
M is a rare earth metal;
CG is a capping group;
x is 0-3;
n is 0-4; and
HY₃₀ is a microporous faujasite zeolite.

In some embodiments, the zeolite-supported rare earth-catalyst has the formula La(BH₄)ₓ(THF)ₙ-CG-HY₃₀, wherein
CG is a capping group;
x is 0-3;
n is 0-4; and
HY₃₀ is a microporous faujasite zeolite.

According to the present application, x is 0-3. Thus, x can be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0.

In some embodiments, x is 0-2. Thus, x can be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0.

In some embodiments, x is 1-2. Thus, x can be 1.0, 1.1, 1.2, 1.3, 1.4, 1.5, 1.6, 1.7, 1.8, 1.9, or 2.0.

According to the present application, n is 0-4. Thus, n can be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.

According to the present application, y is 0-4. Thus, y can be 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.

CG is a capping group that is used to blocks unwanted grafting of the rare earth-catalyst on the external surface of the zeolite. In zeolites, the Si—OH—Al Brønsted acid sites (BAS) are primarily located in microporous cages while silanols are mainly on the external surface after thermal treatment at 500° C. (Medeiros-Costa et al., “Silanol Defect Engineering and Healing in Zeolites: Opportunities to Fine-Tune their Properties and Performances,” Chem. Soc. Rev. 50:11156-11179 (2021), which is hereby incorporated by reference in its entirety). Capping groups react with the silanols located at the external surface of zeolites, thus, leading to the selective placement of lanthanum borohydrides at all bridging Si—OH—Al moieties.

Suitable capping groups (CG) that can be used include R₃Si— and R_{3n -1}Alₙ—, where R is C₁₋₆ alkyl, or aryl, where aryl can be optionally substituted 1 to 3 times with C₁₋₆ alkyl and n is 1, 2, 3, or 4. Suitable capping agents that can be used to introduce CG include AlR₃ and R₃SiR′, where each R is independently selected at each occurrence from C₁₋₆ alkyl or aryl, where aryl can be optionally substituted 1 to 3 times with C₁₋₆ alkyl; R′ is halogen, —OTf, C₂₋₆ alkenyl, allyl CH₂CH═CH₂ or CH₂CH═CHR (R=Me, Et, etc.), and NR″₂; and R″ is H, C₁₋₆ alkyl, aryl, Ph₃Si, Ph₂MeSi, or PhMe₂Si.

In one embodiment, the capping agent is a silanol capping agent. Suitable silanol capping agents than can be used according to the present application include, but not limited to, Ph₃SiCl (TPSCl), Ph₃SiI, Ph₃SiBr, Ph₃SiF, Ph₃SiOTf, Ph₃SiNR₂, Ph₃Si(C₃H₅), Ph₂MeSiCl, Ph₂MeSiI, Ph₂MeSiBr, Ph₂MeSiF, Ph₂MeSiOTf, Ph₂MeSiNR₂, Ph₂MeSi(C₃H₅), PhMe₂SiCl, PhMe₂SiI, PhMe₂SiBr, PhMe₂SiF, PhMe₂SiOTf, PhMe₂SiNR₂, or PhMe₂Si(C₃H₅), where R is H, C₁ 6 alkyl, aryl, Ph₃Si, Ph₂MeSi, or PhMe₂Si and where each Ph can be optionally substituted 1 to 3 times with C₁₋₆ alkyl. In some embodiments, the silanol capping agent is selected from the group consisting of Ph₃SiCl (TPSCl), Ph₃SiI, Ph₃SiBr, Ph₃SiF, Ph₃SiOTf, Ph₃Si(C₃H₅), (C₆H₄Me)₃SiCl, (C₆H₄Me)₃SiI, (C₆H₄Me)₃SiBr, (C₆H₄Me)₃SiF, (C₆H₄Me)₃SiOTf, (C₆H₄Me)₃Si(C₃H₅), (C₆H₃Me₂)₃SiCl, (C₆H₃Me₂)₃SiI, (C₆H₃Me₂)₃SiBr, (C₆H₃Me₂)₃SiF, (C₆H₃Me₂)₃SiOTf, (C₆H₃Me₂)₃Si(C₃H₅), Ph₂MeSiCl, Ph₂MeSiI, Ph₂MeSiBr, Ph₂MeSiF, Ph₂MeSiOTf, Ph₂MeSi(C₃H₅), Ph₂EtSiCl, Ph₂EtSiI, Ph₂EtSiBr, Ph₂EtSiF, Ph₂EtSiOTf, Ph₂EtSi(C₃H₅), PhMe₂SiCl (DMPSCl), PhMe₂SiI, PhMe₂SiBr, PhMe₂SiF, PhMe₂SiOTf, and PhMe₂Si(C₃H₅).

In another embodiment, the capping agent is a selected from the group consisting of AlMe₃, AlEt₃, AlⁿPr₃, AlⁱPr₃, AlⁿBu₃, Al^{s}Bu₃, Al^{t}Bu₃, AlⁱBu₃, Al(C₅H₁₁)₃, Al(C₅H₉)₃, Al(C₆H₁₃)₃, Al(C₆H₁₁)₃.

In some embodiments, the capping group has a hydrodynamic radius greater than the radius of the micropore of the zeolite. For example, the capping group has a hydrodynamic radius greater than 14 Å, greater than 13.5 Å, greater than 13 Å, greater than 12.5 Å, greater than 12 Å, greater than 11.5 Å, greater than 11 Å, greater than 10.5 Å, greater than 10 Å, greater than 9.5 Å, greater than 9 Å, greater than 8.5 Å, greater than 8 Å, greater than 7.5 Å, greater than 7 Å, greater than 6.5 Å, greater than 6 Å, greater than 5.5 Å, greater than 5 Å, greater than 4.5 Å, greater than 4 Å, greater than 3.5 Å, or greater than 3 Å.

In some embodiments, the zeolite-supported rare earth-catalyst has the formula La(BH₄)ₓ(THF)ₙ-CG-HY₃₀, where
CG is a capping group; and
HY₃₀ is a microporous faujasite zeolite.

In some embodiments, the zeolite-supported rare earth-catalyst has the formula CG/M(BH₄)ₓ(THF)ₙ-CG′-HY₃₀ or M(BH₄)ₓ(THF)ₙ-CG-HY₃₀-CG′,
where
   M is a rare earth metal;
   CG is a capping group;
   CG′ is a secondary capping group; and
   HY₃₀ is a microporous faujasite zeolite.

In some embodiments, the zeolite-supported rare earth-catalyst has the formula CG/M(BH₄)ₓ(THF)ₙ-CG′-HY₃₀ or M(BH₄)ₓ(THF)ₙ-CG-HY₃₀-CG′,
where
   M is a rare earth metal;
   x is 0-3;
   n is 0-4;
   CG is a capping group;
   CG′ is a secondary capping group; and
   HY₃₀ is a microporous faujasite zeolite.

CG′ is a secondary capping group that is used to react with any protic species remaining in the zeolite pores or on the external zeolite surface after primary capping or grafting of M(BH₄)₃(THF)ₙ species. The secondary capping group should not deactivate the M(BH₄)ₓ catalytic sites.

In some embodiments, the secondary capping group has a hydrodynamic radius that is the same as or smaller than the hydrodynamic radius of the capping group. For example, the secondary capping group has a hydrodynamic radius from about 1 Å to about 15 Å, from about 2 Å to about 14 Å, from about 2 Å to about 13 Å, from about 3 Å to about 12 Å, from about 3 Å to about 11 Å, from about 3 Å to about 10 Å, from about 4 Å to about 9 Å, from about 4 Å to about 8 Å, or from about 4 Å to about 7 Å. In some embodiments, the secondary capping group has a hydrodynamic radius smaller than 14 Å, smaller than 13.5 Å, smaller than 13 Å, smaller than 12.5 Å, smaller than 12 Å, smaller than 11.5 Å, smaller than 11 Å, smaller than 10.5 Å, smaller than 10 Å, smaller than 9.5 Å, smaller than 9 Å, smaller than 8.5 Å, smaller than 8 Å, smaller than 7.5 Å, smaller than 7 Å, smaller than 6.5 Å, smaller than 6 Å, smaller than 5.5 Å, smaller than 5 Å, smaller than 4.5 Å, smaller than 4 Å, smaller than 3.5 Å, or smaller than 3 Å.

Suitable secondary capping groups (CG′) that can be used include R₃Si— and R_{3n -1}Alₙ—, where R is C₁₋₆ alkyl, or aryl, where aryl can be optionally substituted 1 to 3 times with C₁₋₆ alkyl and n is 1, 2, 3, or 4. Suitable capping agents that can be used to introduce CG include AlR₃ and R₃SiR′, where each R is independently selected at each occurrence from C₁₋₆ alkyl or aryl, where aryl can be optionally substituted 1 to 3 times with C₁₋₆ alkyl; R′ is halogen, —OTf, C₂₋₆ alkenyl, allyl CH₂CH═CH₂ or CH₂CH═CHR (R=Me, Et, etc.), and NR″₂; and R″ is H, C₁₋₆ alkyl, aryl, Ph₃Si, Ph₂MeSi, or PhMe₂Si.

Suitable secondary capping agents that can be used include, but not limited to, Ph₃SiCl (TPSCl), Ph₃SiI, Ph₃SiBr, Ph₃SiF, Ph₃SiOTf, Ph₃SiNR₂, Ph₃Si(C₃H₅), Ph₂MeSiCl, Ph₂MeSiI, Ph₂MeSiBr, Ph₂MeSiF, Ph₂MeSiOTf, Ph₂MeSiNR₂, Ph₂MeSi(C₃H₅), PhMe₂SiCl, PhMe₂SiI, PhMe₂SiBr, PhMe₂SiF, PhMe₂SiOTf, PhMe₂SiNR₂, or PhMe₂Si(C₃H₅), where R is H, C₁₋₆ alkyl, aryl, Ph₃Si, Ph₂MeSi, or PhMe₂Si and where each Ph can be optionally substituted 1 to 3 times with C₁₋₆ alkyl. In some embodiments, the silanol capping agent is selected from the group consisting of Ph₃SiCl (TPSCl), Ph₃SiI, Ph₃SiBr, Ph₃SiF, Ph₃SiOTf, Ph₃SiNMe₂, Ph₃Si(C₃H₅), (C₆H₄Me)₃SiCl, (C₆H₄Me)₃SiI, (C₆H₄Me)₃SiBr, (C₆H₄Me)₃SiF, (C₆H₄Me)₃SiOTf, (C₆H₄Me)₃SiNMe₂, (C₆H₄Me)₃Si(C₃H₅), (C₆H₃Me₂)₃SiCl, (C₆H₃Me₂)₃SiI, (C₆H₃Me₂)₃SiBr, (C₆H₃Me₂)₃SiF, (C₆H₃Me₂)₃SiOTf, (C₆H₃Me₂)₃SiNMe₂, (C₆H₃Me₂)₃Si(C₃H₅), Ph₂MeSiCl, Ph₂MeSiI, Ph₂MeSiBr, Ph₂MeSiF, Ph₂MeSiOTf, Ph₂MeSi(C₃H₅), Ph₂EtSiCl, Ph₂EtSiI, Ph₂EtSiBr, Ph₂EtSiF, Ph₂EtSiOTf, Ph₂EtSi(C₃H₅), PhMe₂SiCl (DMPSCl), PhMe₂SiI, PhMe₂SiBr, PhMe₂SiF, PhMe₂SiOTf, PhMe₂Si(C₃H₅), PhMeHSiCl, PhMeHSiI, PhMeHSiBr, PhMeHSiF, PhMeHSiOTf, PhMeHSi(C₃H₅), Ph₂HSiCl, Ph₂HSiI, Ph₂HSiBr, Ph₂HSiF, Ph₂HSiOTf, Ph₂HSi(C₃H₅), PhH₂SiCl, PhH₂SiI, PhH₂SiBr, PhH₂SiF, PhH₂SiOTf, PhH₂Si(C₃H₅), Me₃SiCl, Me₃SiI, Me₃SiBr, Me₃SiF, PhMe₂SiOTf, PhMe₂Si(C₃H₅), Me₂HSiCl, Me₂HSiI, Me₂HSiBr, Me₂HSiF, Me₂HSiOTf, and Me₂HSi(C₃H₅).

In some embodiments, the secondary capping group (CG′) is the same as the capping group (CG).

In some embodiments, the supported rare earth-catalyst has the formula:

La(BH₄)ₓ-CG-CG′-HY₃₀, where
x is 0-3;
CG is a capping group;
CG′ is a secondary capping group; and
HY₃₀ is a microporous faujasite zeolite.

In some embodiments, the supported rare earth-catalyst has the formula:

M(BH₄)ₓ—(AlR₃)_{y}-CG-HY₃₀, where
M is a rare earth metal;
R is C₁₋₆ alkyl, C₃₋₆ cycloalkyl, aryl, or H;
x is 0-3;
y is 0-4;
CG is a capping group; and
HY₃₀ is a microporous faujasite zeolite.

In some embodiments, the supported rare earth-catalyst has the formula:

La(BH₄)ₓ—(AlR₃)_{y}-CG-HY₃₀, where
R is C₁₋₆ alkyl, C₃₋₆ cycloalkyl, aryl, or H;
x is 0-3;
y is 0-4;
CG is a capping group; and
HY₃₀ is a microporous faujasite zeolite.

In some embodiments, R is C₁₋₆ alkyl or H.

Another aspect of the present application relates to a method of producing a supported rare earth-catalyst. This method includes providing a metal oxide support having Brønsted acid sites and providing a capping agent. The metal oxide support is reacted with the capping agent under conditions effective to produce a metal oxide support containing capped functional groups. A rare earth element-catalyst is provided and deposited on the metal oxide support containing capped functional groups to produce the supported rare earth-catalyst. The rare earth element-catalyst is bound to the Brønsted acid sites on the metal oxide support.

In some embodiments, the method further includes a step of reacting the supported rare earth-catalyst with a secondary capping agent.

Any suitable metal oxide support described above can be used in accordance with this aspect of the present application.

Any suitable capping agent (CG) described above can be used in accordance with this aspect of the present application.

Any suitable rare earth element-catalyst described above can be used in accordance with this aspect of the present application.

Any suitable secondary capping agent (CG′) described above can be used in accordance with this aspect of the present application.

The reaction between the capping agent and the metal oxide support can be carried out for at least 4 hours, at least 8 hours, at least 10 hours, at least 12 hours, at least 18 hours, at least 24 hours, at least 36 hours, at least 48 hours, at least 60 hours, or at least 72 hours. Suitable solvents that can be used for the reaction between the capping agent and the metal oxide support include, pentane, hexane, ether, toluene, benzene, petroleum ether, methylene chloride, and chloroform. The capping reaction can also be performed solvent-free by boiling or melting and boiling the capping agent and allowing it to react with the metal oxide support.

The reaction between the capping agent and the metal oxide support can be carried out at room temperature or at elevated temperatures. For example, the reaction between the capping agent and the metal oxide support can be carried out at a temperature of from about −10° C. to about 100° C., about −5° C. to about 90° C., about 0° C. to about 80° C., about 5° C. to about 70° C., about 10° C. to about 60° C., about 15° C. to about 50° C., about 15° C. to about 40° C., about 15° C. to about 30° C., or about 15° C. to about 25° C. Preferably, this reaction is carried out at room temperature.

The reaction between the rare earth element-catalyst dissolved in a suitable solvent and the metal oxide support containing capped functional groups can be carried out for at least 4 hours, at least 8 hours, at least 10 hours, at least 12 hours, at least 18 hours, at least 24 hours, at least 36 hours, or at least 48 hours. Suitable solvents that can be used include toluene, benzene, pentane, hexane, petroleum ether, ether, dichloromethane, chlorobenzene, and fluorobenzene.

The reaction between the rare earth element-catalyst and the metal oxide support containing capped functional groups can be carried out at room temperature or at elevated temperatures. For example, the reaction between the rare earth element-catalyst and the metal oxide support containing capped functional groups can be carried out at a temperature of from about −10° C. to about 100° C., about −5° C. to about 90° C., about 0° C. to about 80° C., about 5° C. to about 70° C., about 10° C. to about 60° C., about 15° C. to about 50° C., about 15° C. to about 40° C., about 15° C. to about 30° C., or about 15° C. to about 25° C. Preferably, this reaction is carried out at room temperature.

The reaction between the secondary capping agent dissolved in a suitable solvent and the supported rare earth-catalyst can be carried out for at least 4 hours, at least 8 hours, at least 10 hours, at least 12 hours, at least 18 hours, at least 24 hours, at least 36 hours, at least 48 hours, at least 60 hours, or at least 72 hours. Suitable solvents that can be used include pentane, hexane, ether, toluene, benzene, petroleum ether, methylene chloride, and chloroform.

The reaction between the secondary capping agent and the supported rare earth-catalyst can be carried out at room temperature or at elevated temperatures. For example, the reaction between the secondary capping agent and the supported rare earth-catalyst can be carried out at a temperature of from about −10° C. to about 100° C., about −5° C. to about 90° C., about 0° C. to about 80° C., about 5° C. to about 70° C., about 10° C. to about 60° C., about 15° C. to about 50° C., about 15° C. to about 40° C., about 15° C. to about 30° C., or about 15° C. to about 25° C. Preferably, this reaction is carried out at room temperature.

In some embodiments, the method further includes providing a compound of Formula (A):

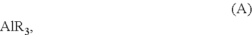

wherein R is C₁₋₆ alkyl, C₃₋₆ cycloalkyl, aryl, or H. The method further includes reacting the supported rare earth-catalyst with the compound of Formula (A) under conditions effective to produce a modified supported rare earth-catalyst.

In some embodiments, R is C₁₋₆ alkyl or H.

In some embodiments, the compound of Formula (A) is selected form the group AlMe₃, AlEt₃, AlⁿPr₃, AlⁱPr₃, AlⁿBu₃, Al^{s}Bu₃, Al^{t}Bu₃, AlⁱBu₃, AlHⁱBu₂, Al(C₅H₁₁)₃, Al(C₅H₉)₃, Al(C₆H₁₃)₃, and Al(C₆H₁₁)₃.

The reaction between the supported rare earth-catalyst and the compound of Formula (A) can be carried out at room temperature or at elevated temperatures. For example, the reaction between the secondary capping agent and the supported rare earth-catalyst can be carried out at a temperature of from about −10° C. to about 100° C., about −5° C. to about 90° C., about 0° C. to about 80° C., about 5° C. to about 70° C., about 10° C. to about 60° C., about 15° C. to about 50° C., about 15° C. to about 40° C., about 15° C. to about 30° C., or about 15° C. to about 25° C. Preferably, this reaction is carried out at room temperature.

Another aspect of the present application relates to a method of producing a modified supported rare earth-catalyst. This method includes providing a metal oxide support having Brønsted acid sites and providing a capping agent. The metal oxide support is reacted with the capping agent under conditions effective to produce a metal oxide support containing capped functional groups. A rare earth element-catalyst is provided and deposited on the metal oxide support containing capped functional groups to produce a supported rare earth-catalyst. The rare earth element-catalyst is bound to the Brønsted acid sites on the metal oxide support. The method further includes providing a compound of Formula (A).

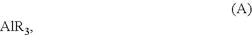

wherein R is C₁₋₆ alkyl, C₃₋₆ cycloalkyl, aryl, or H; and reacting the supported rare earth-catalyst with the compound of Formula (A) under conditions effective to produce the modified supported rare earth-catalyst.

In some embodiments, R is C₁₋₆ alkyl or H.

Any of the above-described metal oxide support(s), capping agent(s), rare earth element-catalyst(s), and compound(s) of Formula (A) can be used in accordance with this aspect of the present application.

Another aspect of the present application relates to a method for borylation of hydrocarbons. This method comprises:
providing a hydrocarbon;
providing a supported rare earth-catalyst;
providing a borylation reagent; and
reacting the hydrocarbon with the borylation reagent in the presence of the supported rare earth-catalyst under conditions effective to borylate the hydrocarbon.

Any of the supported rare earth-catalysts described above can be used in accordance with this aspect of the present application.

In one embodiment, the supported rare earth-catalyst comprises a metal oxide support having Brønsted acid sites and a rare earth element-catalyst, where said rare earth element-catalyst is bound to the Brønsted acid sites on the metal oxide support.

Suitable hydrocarbons that can be borylated using the methods described in the present application include, but are not limited to, unsubstituted and substituted aromatic hydrocarbons, unsubstituted and substituted heteroaromatic hydrocarbons, unsubstituted and substituted polyolefins, unsubstituted and substituted alkanes, unsubstituted and substituted cycloalkanes, unsubstituted and substituted alkenes, and unsubstituted and substituted alkynes.

In one embodiment, the hydrocarbon is benzene.

In another embodiment, the hydrocarbon is toluene.

In another embodiment, the hydrocarbon is selected from the group consisting of poly(propylene), poly(butene), and poly(ethylene-co-octene).

In yet another embodiment, the hydrocarbon is an unsubstituted or substituted alkane or unsubstituted or substituted cycloalkane.

In a further embodiment, the hydrocarbon is methane.

Borylation reagents that can be used according to the present application include pinacolborane, bis(pinacolborane), catechol borane, 9-BBN, R₃N—BH₃, R₂S—BH₃, pyridine-BH₃, NaBH₄, RBH₂, and R₂BH, where R is C₁₋₆ alkyl or aryl.

The borylation reaction can be conducted at room temperature or at elevated temperatures. For example, the borylation reaction can be conducted at a temperature from about 50° C. to about 300° C., about 60° C. to about 250° C., about 70° C. to about 200° C., about 50° C. to about 150° C., about 60° C. to about 150° C., about 70° C. to about 150° C., about 80° C. to about 150° C., about 90° C. to about 150° C., about 100° C. to about 150° C., about 110° C. to about 150° C., about 120° C. to about 150° C., about 130° C. to about 150° C., about 100° C. to about 140° C., about 100° C. to about 130° C., or about 100° C. to about 120° C.

In one embodiment, the borylation reactions were conducted under inert atmosphere, such as argon or nitrogen atmosphere.

The borylation reaction can be conducted for at least 30 min, at least 1 hour, at least 2 hours, at least 3 hours, at least 4 hours, at least 5 hours, at least 10 hours, at least 15 hours, at least 20 hours, at least 24 hours, at least 36 hours, at least 48 hours, or at least 60 hours. For example, the borylation reaction can be conducted for about 0.5 to about 96 hours, about 1 to about 96 hours, about 2 to about 96 hours, about 3 to about 96 hours, about 3 to about 84 hours, about 3 to about 72 hours, about 3 to about 60 hours, about 3 to about 48 hours, about 3 to about 36 hours, about 3 to about 24 hours, about 4 to about 96 hours, about 4 to about 84 hours, about 4 to about 72 hours, about 4 to about 60 hours, about 4 to about 48 hours, about 4 to about 36 hours, about 4 to about 24 hours, about 5 to about 96 hours, about 5 to about 84 hours, about 5 to about 72 hours, about 5 to about 60 hours, about 5 to about 48 hours, about 5 to about 36 hours, about 5 to about 24 hours, about 6 to about 96 hours, about 6 to about 84 hours, about 6 to about 72 hours, about 6 to about 60 hours, about 6 to about 48 hours, about 6 to about 36 hours, about 6 to about 24 hours, about 7 to about 96 hours, about 7 to about 84 hours, about 7 to about 72 hours, about 7 to about 60 hours, about 7 to about 48 hours, about 7 to about 36 hours, about 7 to about 24 hours, about 8 to about 96 hours, about 8 to about 84 hours, about 8 to about 72 hours, about 8 to about 60 hours, about 8 to about 48 hours, about 8 to about 36 hours, about 8 to about 24 hours, about 9 to about 96 hours, about 9 to about 84 hours, about 9 to about 72 hours, about 9 to about 60 hours, about 9 to about 48 hours, about 9 to about 36 hours, about 9 to about 24 hours, about 10 to about 96 hours, about 10 to about 84 hours, about 10 to about 72 hours, about 10 to about 60 hours, about 10 to about 48 hours, about 10 to about 36 hours, or about 10 to about 24 hours.

The borylation reaction can be conducted in any suitable solvent. For example, this reaction can be carried out in benzene, toluene, dimethyl formamide, xylene, mesitylene cyclohexane, cyclopentane, methylcyclohexane, cyclooctane, tetrahydrofuran, decalin, perfluorohexane, or perfluoromethylcyclohexane.

The borylation reaction can be conducted under ambient pressure or in a high-pressure reactor.

According to the present application, when the borylated hydrocarbon is substituted, the nature of the supported rare earth-catalyst can influence the selectivity of the borylation reaction. In some embodiments, the hydrocarbon is borylated selectively in ortho position. In some embodiments, hydrocarbon is borylated selectively in meta position.

In some embodiments, when the borylated hydrocarbon is substituted, the hydrocarbon is borylated primarily in ortho and meta positions. In some embodiments, when the borylated hydrocarbon is substituted, the hydrocarbon is borylated primarily in ortho position. In some embodiments, when the borylated hydrocarbon is substituted, the hydrocarbon is borylated primarily in meta position.

For example, when toluene is borylated using La(BH₄)ₓ(THF)ₙ-TPS—HY₃₀—Al(CH₃)₃, the yield of borylated products is about 11% and molar ratio of ortho-:meta-:para-products are 23:42:31. Wherein, when toluene is borylated using La(BH₄)ₓ(THF)ₙ-TPS—HBEA12—Al(CH₃)₃, the yield of borylated products is about 7% and molar ratio of ortho-:meta-:para-products are 29:68:3.

In one embodiment, the borylated hydrocarbon is monoborylated.

In another embodiment, the borylated hydrocarbon is diborylated.

The borylation reagent can be added to the reaction mixture in a single portion or over several portions. For example, the borylation reagent can be added one or more times during the reaction: two times, tree times, four times, or five times during the reaction.

The above disclosure is general. A more specific description is provided below in the following examples. The examples are described solely for the purpose of illustration and are not intended to limit the scope of the present application. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present application, but are not intended to limit the scope of the claimed application.

### Example 1—Chemicals and Materials

All manipulations were performed under a dry argon atmosphere using standard Schlenk techniques or under a nitrogen atmosphere in a glovebox unless otherwise indicated. Dry and deoxygenated reagents were used throughout. Water and oxygen were removed from anhydrous toluene, pentane, and tetrahydrofuran (THF) purchased from Sigma Aldrich and dried and deoxygenated using an IT PureSolv System. 4,4,5,5-Tetramethyl-1,3,2-dioxaborolane (HBpin, 97%), 4,4,5,5-tetramethyl-2-phenyl-1,3,2-dioxaborolane (PhBpin, 97%), chlorotriphenylsilane (TPSCl, 96%), NaBH₄ (99.99%), and 3,5-di-tert-4-butylhydroxytoluene (BHT, 99%) were purchased from Sigma Aldrich. LaCl₃ (99.9% anhydrous) was obtained from Strem. Benzene-d₆ and toluene-d₈ were heated to reflux over Na/K and vacuum-transferred. Dichloromethane-d₂ was dried and deoxygenated by stirring over activated calcium hydride overnight, followed by distillation. SiO₂ (Aerosil® 380) was purchased from Evonik, Al₂O₃ was purchased from Strem, SiO₂—Al₂O₃ (grade 135) was purchased from Sigma Aldrich, and HY₃₀ (CBV760, Si/Al=30) was purchased from Zeolyst. All metal oxides were treated at 500° C. for 5 hours under dynamic vacuum and stored in a N₂-filled glovebox.

### Example 2—Characterization

### Analysis of Solutions

¹H and ¹¹B NMR spectra were collected on a Bruker Avance NEO-400 spectrometer. Gas chromatography-mass spectrometry (GC-MS) analyses were performed using an Agilent 7890A GC and 5975C MS, equipped with a capillary Agilent J&W DB-5ht column.

### Analysis of Materials

Inductively coupled plasma-optical emission spectrometry (ICP-OES) was performed on an Optima 2100 DV to determine elemental composition (wt %) of lanthanum and boron in the catalysts. Diffuse reflectance infrared Fourier transform spectroscopy (DRIFTS) were collected using a Bruker VERTEX 80 IR spectrometer equipped with a Harrick “Praying Mantis” accessory, and spectra of samples were recorded within the 4000-400 cm⁻¹ wavenumber range. Samples were prepared in the glovebox under N₂ and sealed before measurements.

### Example 3—Catalyst Preparation and Characterization

Synthesis of La(BH₄)₃(THF)₃

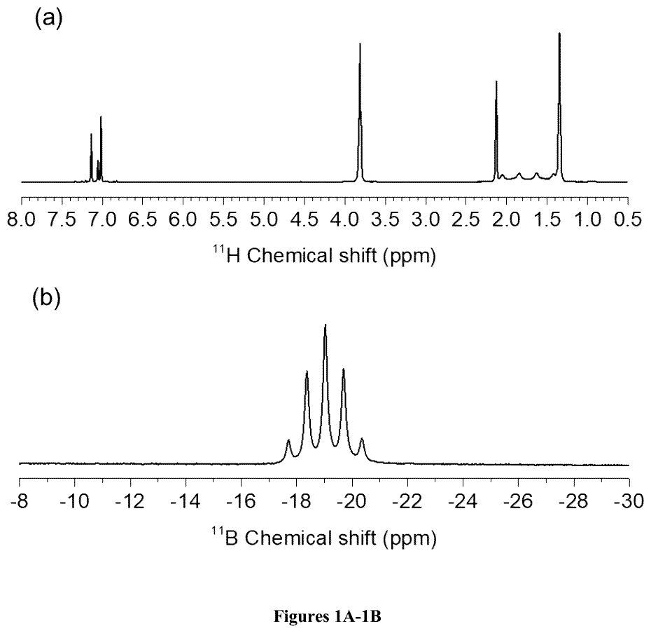

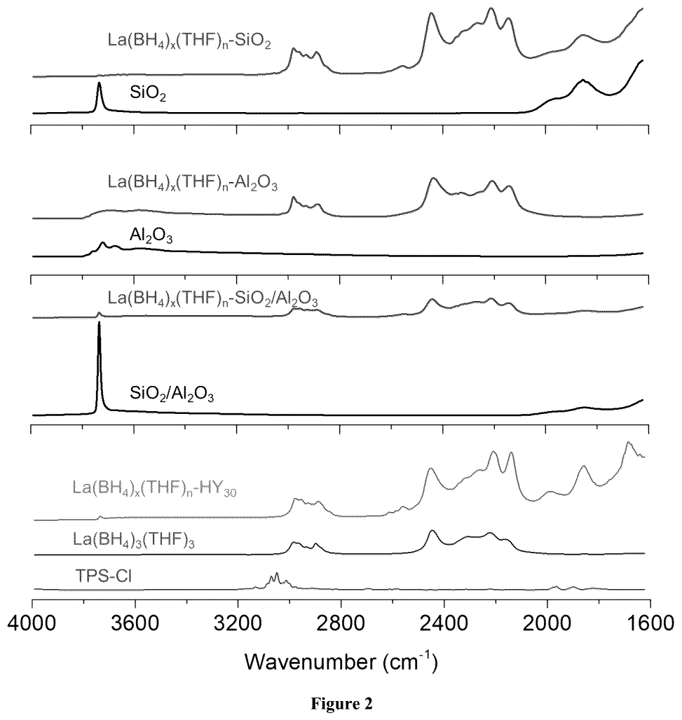

La(BH₄)₃(THF)₃ was synthesized via a reported method (Mostajeran et al., “Base-Metal Nanoparticle-Catalyzed Hydrogen Release from Ammine Yttrium and Lanthanum Borohydrides,” Chem. Mater. 29:742-751 (2017), which is hereby incorporated by reference in its entirety). LaCl₃ (2.455 g, 10.01 mmol) and excess sodium borohydride (1.515 g, 40.05 mmol) were heated at reflux in dry THF for 5 days. The solution was filtered using a cannula filtration to remove the residual NaBH₄ and NaCl. The filtrate was then evaporated under vacuum, giving a solid residue that was extracted with toluene. The extracts were concentrated and then cooled to −30° C., giving La(BH₄)₃(THF)₃ as a colorless powder that was isolated and stored under N₂ in a glovebox. The ¹H and ¹¹B NMR (FIGS. 1A-1B) and DRIFTS spectra (FIG. 2) matched the literature (Guillaume et al., “Polymerization of ε-Caprolactone Initiated by Nd(BH₄)₃(THF)₃: Synthesis of Hydroxytelechelic Poly(ε-caprolactone),” Macromolecules 36:54-60 (2003); Ajellal et al., “Polymerization of Racemic β-Butyrolactone Using Supported Catalysts: A Simple Access To Isotactic Polymers,” Chem. Commun. 46:1032-1034 (2010), which are hereby incorporated by reference in their entirety). ¹H NMR (toluene-d₈, 400 MHz, 25° C.): δ 1.35 (t, 12H, THF—CH₂), 1.73 (br q, 12 H, ¹J_{BH}=80 Hz, BH₄), δ 3.82 (t, 12H, THF—OCH₂). ¹¹B NMR (toluene-d₈, 400 MHz, 25° C.): δ 19.03 (p, ¹J_{BH}=85 Hz, BH₄). DRIFTS of La(BH₄)₃(THF)₃ (cm⁻¹): 3100-2850 (m, vC_{H}) 2450 (s, ν_{BH-terminal}) 2250-2050 (m, ν_{BH}-bridging).

### Preparation of TPS—HY₃₀

In a typical small-scale synthesis, TPSCl (0.065 g, 0.22 mmol) was dissolved in pentane (5 mL) and HY₃₀ (0.300 g) was added. The mixture was stirred at room temperature for 24 hours. The supernatant was decanted, the solid was washed with pentane (3×5 mL), and the isolated material was dried under dynamic vacuum (10-4 mbar) at room temperature for 24 hours.

In a typical moderate scale synthesis, TPSCl (0.435 g, 1.48 mmol) was dissolved in pentane (30 mL). HY₃₀ (2.000 g) was added and the mixture was stirred at room temperature for 48 hours. The supernatant was decanted, the solid was washed with pentane (3×30 mL), and the solid was dried under dynamic vacuum (10⁻⁴ mbar) at room temperature for 24 hours.

General Procedure for Grafting of La(BH₄)₃(THF)₃ Onto Supports

A toluene solution of La(BH₄)₃(THF)₃ (0.040 g, 0.10 mmol, 5 mL) was added to the support (0.300 g). The mixture was stirred at room temperature for 20 hours. The supernatant was decanted, the solid was washed with toluene (3×5 mL), and the material was dried under dynamic vacuum (10-4 mbar) at room temperature for 20 hours. The isolated materials were characterized by DRIFTS (FIG. 2), and La loading was determined by ICP-OES (Table 5). La(BH₄)ₓ(THF)ₙ—SiO₂—Al₂O₃ (cm⁻¹): 3735 (w, ν_{SiOH}) 3100-2850 (m, ν_{CH}) 2445 (s, ν_{BH-terminal}) 2250-2050 (m, ν_{BH-bridging}). La(BH₄)ₓ(THF)ₙ—Al₂O₃ (cm⁻¹): 3720 (w, ν_{AlOH}) 3100-2850 (m, ν_{CH}) 2450 (s, ν_{BH-terminal}) 2250-2050 (m, ν_{BH}-bridging). La(BH₄)ₓ(THF)ₙ—SiO₂ (cm⁻¹): 3740 (w, ν_{SiOH}) 3100-2850 (m, ν_{CH}) 2450 (s, ν_{BH}-terminal) 2250-2050 (m, ν_{BH-bridging}).

### Analysis of Release of THF Per La During Grafting

La(BH₄)₃(THF)₃ (0.010 g, 0.025 mmol) and 1,3,5-trimethoxybenzene (TMB; 0.005 g, 0.03 mmol) were dissolved in benzene-d₆ (1.0 mL) in a J. Young NMR tube. TPS—HY₃₀ (0.030 g) was added and the mixture was agitated at room temperature for 20 hours using an orbital shaker. Solution-phase ¹H NMR spectra of the mixture were acquired before and after the addition of TPS—HY₃₀. The concentrations of La(BH₄)₃ and THF were determined by integration of these signals, the TMB signals, and the residual ¹H signal in the benzene-d₆ solvent.

Poisoning Spectrochemical Analysis Experiments with BHT

BHT (0.005 g, 0.02 mmol) was dissolved in toluene (2.0 mL). La(BH₄)ₓ(THF)ₙ—HY₃₀ (0.100 g) or La(BH₄)₂(THF)_{2.5}-TPS—HY₃₀ (0.100 g) was added and the reaction mixture was stirred at room temperature for 4 hours. The solid materials were recovered, washed with anhydrous toluene (3×5 mL), dried under vacuum (10-4 mbar) overnight, and then analyzed.

General Procedure for Supported Lanthanum Catalysts Treated with Trimethylaluminum

A toluene solution of excess trimethylaluminum (0.029 g, 0.4 mmol, 5 mL) was added the grafted catalyst La(BH₄)ₓ(THF)ₙ-TPS—HY₃₀ (0.200 g, dispersed in 5 mL toluene). The mixture was stirred at room temperature overnight. The supernatant was decanted, the solid was washed with toluene (3×10 mL), and the material was dried under dynamic vacuum (10-4 mbar) at room temperature for 24 hours. The isolated materials were characterized by DRIFTS, and La loading was determined by ICP-OES.

### Example 4—Catalytic Borylation Experiments

### Catalyst Testing and Optimization Studies

In a typical experiment, an air-tight, Teflon valved, re-sealable glass reactor was charged with the pre-catalyst (˜0.004 mmol La, 0.050-0.150 mg), benzene (1.0 mL), and HBpin (0.30 mL, 2.1 mmol) in the glovebox. The reaction vessel heated in an oil bath at 120° C. for 12 hours. The reaction mixture was cooled, the solution was separated from the solid catalyst, and then the reaction mixture was characterized by calibrated GC-MS and ¹¹B NMR spectroscopy. Each experiment was repeated at least two times.

### Kinetic Investigations

The time-resolved studies of benzene borylation catalyzed by La(BH₄)₂(THF)_{2.5}-TPS—HY₃₀ were performed by heating the catalyst (0.050 g, 0.0025 mmol La), benzene (1.0 mL), and HBpin (0.30 mL, 2.1 mmol) at 120° C. The experiments were then stopped (cooled) after 2, 4, 6, 8, 10, 12, 16 or 24 hours. The TON was determined by calibrated GC-MS analysis. Each time point was a separate experiment.

### Product Analysis

The yield of PhBpin in the above experiments was determined using calibrated GC-MS. An aliquot of the reaction solution (0.100 g) was withdrawn and mixed with TMB in benzene (100 mM, 0.20 mL). This mixture was then diluted to 1.0 mL solution by adding benzene.

Quantification was achieved using external calibration with TMB. A calibration curve for quantifying PhBpin was constructed by plotting the molar amount of PhBpin as a function of ratio of peak area between PhBpin and TMB to obtain the response factor (RF). The amount of PhBpin obtained with the calibration curve, using the following equation:

$$Molar amount of PhBpin = \frac{Peak Area ( PhBpin )}{Peak Area ( TMB )} \times RF \times \frac{weight ( total reaction mixture )}{weight ( withdrawn reaction mixture )} \qquad ( Eq . 1 )$$

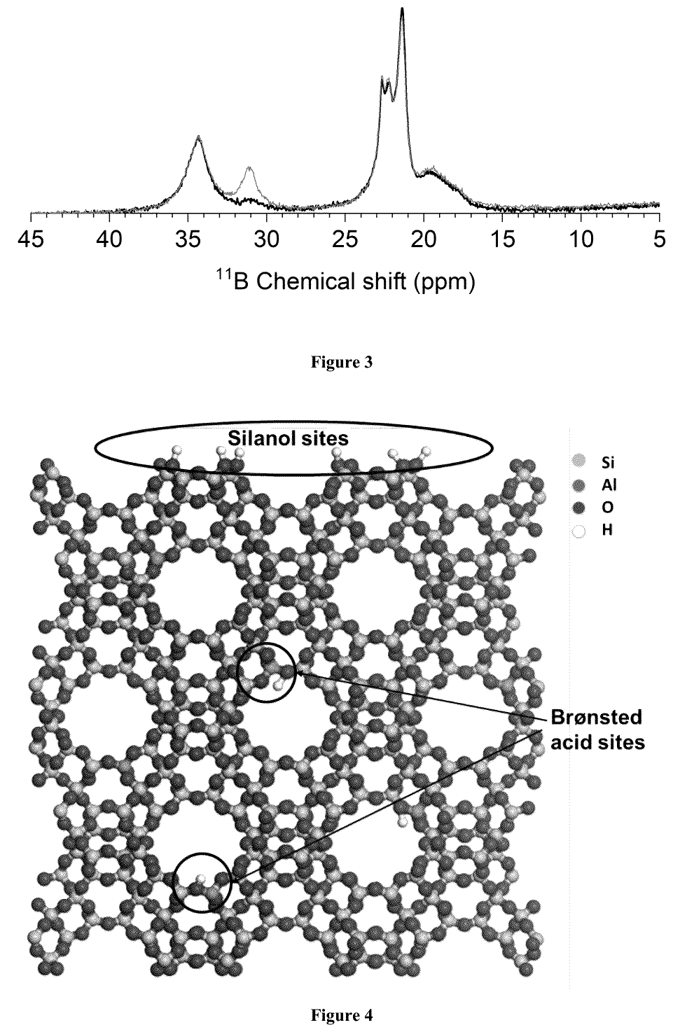

The conversion of HBpin was monitored with solution ¹H and ¹¹B NMR spectroscopy. Typically, 0.100 g reaction solution was added and mixed with 0.4 mL CD₂Cl₂ to measure NMR spectra. The recycle delay for to obtain quantitative ¹¹B NMR spectra is 20 s. The production of PhBpin was further confirmed using ¹¹B NMR spectroscopy by spiking the reaction solution with authentic PhBpin (FIG. 3).

### Example 5—Results and Discussion of Examples 1-4

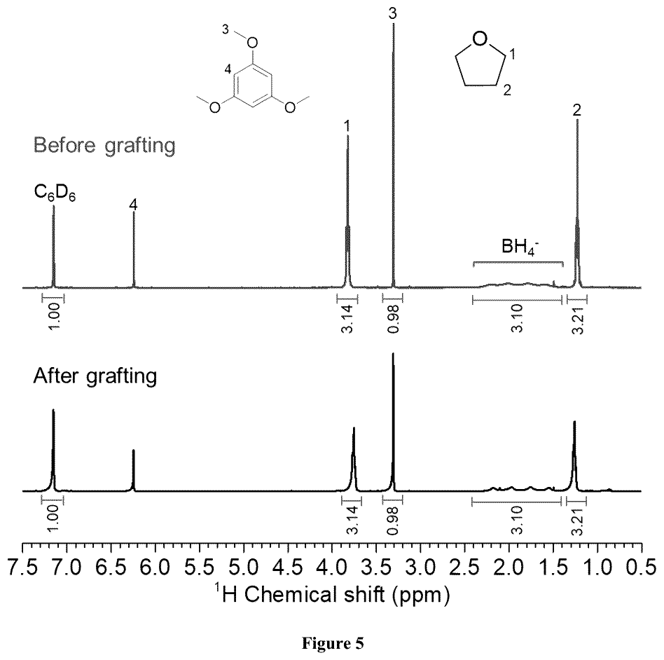

La(BH₄)₃(THF)₃ grafted onto inorganic supports, including SiO₂, γ-Al₂O₃, SiO₂—Al₂O₃, or the microporous faujasite zeolite HY₃₀ (Si/Al=30), were compared as potential catalysts for C—H borylation of benzene (FIG. 45). The latter two supports contain heteroatomic bridging hydroxy as BAS, which are mostly isolated in the highly siliceous HY₃₀ (<one per supercage; FIG. 4). All oxide supports were treated at 500° C. under dynamic vacuum, and then La(BH₄)₃(THF)₃ was grafted in toluene for 24 hours at room temperature (FIGS. 1A-1B and 5). The isolated materials (Table 1) were characterized by elemental analysis to determine lanthanum loading, as well as by DRIFTS spectroscopy to identify BH-containing groups, organic species, Brønsted acids, and silanols on the support before and after grafting.

TABLE 1
C—H Borylation of Benzene Catalyzed by Lanthanum Borohydride Complexes^{[a]}

| | La | La | | | | |
|---|---|---|---|---|---|---|
| Catalyst | (mmol/g)^{[b]} | (mol %)^{[c]} | Conversion | Yield | Turnovers | Selectivity |
| La(BH₄)₃(THF)₃ | n/a | 0.18 | ~0% | 0% | n/a | n/a |
| La(BH₄)ₓ(THF)ₙ—SiO₂ | 0.14 | 0.36 | ~0% | 0% | n/a | n/a |
| La(BH₄)ₓ(THF)ₙ—Al₂O₃^{[d]} | 0.02 | 0.18 | ~0% | 0% | n/a | n/a |
| La(BH₄)ₓ(THF)n—SiO₂—Al₂O₃ | 0.09 | 0.22 | 100% | 1.3% | 6 | 1.1% |
| La(BH₄)ₓ(THF)n—HY₃₀ | 0.07 | 0.18 | 100% | 1.8% | 10 | 1.8% |
| La(BH₄)₂(THF)_{2.5}—TPS—HY₃₀ | 0.05 | 0.12 | 95% | 7.4% | 62 | 7.8% |

^{[a]}Reaction conditions: 50 mg catalyst, 1 mL benzene and 0.3 mL HBpin (0.002 mol) at 120° C. for 12 hours.
^{[b]}Loading of La (mmol/g) in catalytic materials measured by ICP-OES.
^{[c]}Molar percentage (mol %) of La to HBpin.
^{[d]}150 mg.

The HBpin starting material was the only borane species observed in attempted CH borylations of benzene using ˜0.2 mol % of either unsupported La(BH₄)₃(THF)₃, La(BH₄)ₓ(THF)ₙ—SiO₂, or La(BH₄)ₓ(THF)ₙ—Al₂O₃ as pre-catalysts, and phenyl pinacolborane (PhBpin) was not detected in the mixture. It was inferred that neither (≡SiO)₃₋ₓLa(BH₄)ₓ(THV)ₙ-type sites grafted by reaction with surface OH in silica or alumina nor cationic [La(BH₄)ₓ(THF)]⁺ resulting from activation at Lewis acid sites (LAS) in γ-Al₂O₃ were catalytically active for C—H borylation of benzene under these conditions. In contrast, HBpin was completely consumed in neat benzene and in the presence of La(BH₄)ₓ(THF)₁—SiO₂—Al₂O₃ or La(BH₄)ₓ(THF)ₙ—HY₃₀ as precatalysts, giving 1.1% and 1.8% yield of PhBpin, which corresponded to turnovers of 6 and 10 (moles PhBpin/mols La). Although the initial pre-catalyst formulations and reaction conditions gave low yields and poor selectivity for PhBpin, the experiments importantly provided new insight that La(BH₄)ₓ species bonded at BAS, the functionality that is common to SiO₂—Al₂O₃ and zeolite HY₃₀ but not SiO₂ or γ-Al₂O₃, were catalytically active for CH borylation of benzene.

The surface species on the bare La-free supports capable of decomposing HBpin were then identified, by examining reactions of HBpin with the calcined oxides, to develop strategies for increasing benzene borylation yields by limiting the undesired pathway. SiO₂ or γ-Al₂O₃ gave constant HBpin concentration after heating with HBpin and benzene for 2 hours at 120° C. (Table 2), ruling out silanol, aluminol, and LAS groups as catalysts for HBpin decomposition. In contrast, HBpin was quantitatively consumed within 2 hours in the presence of BAS-containing HY₃₀ and SiO₂—Al₂O₃, while PhBpin was not detected in these experiments. Considering these observations and the hypothesis that lanthanum species grafted on BAS were the active sites, strategies to improve catalytic performance could involve selective placement of lanthanum borohydrides at all bridging Si—OH—Al moieties. DRIFTS analysis (FIG. 2), however, showed that nearly all silanols in the SiO₂—Al₂O₃ and HY₃₀ had been consumed during grafting, giving inactive La species.

TABLE 2
HBpin Decomposition With Metal Oxide Supports

| Entry | Support | C₆H₆ (mL) | HBpin (mL) | T (° C.) | t (h) | Conversion of HBpin (%) |
|---|---|---|---|---|---|---|
| 1 | HY₃₀ | 1.0 | 0.5 | 120 | 2 | 100 |
| 2 | SiO₂ | 1.0 | 0.5 | 120 | 2 | 0 |
| 3 | Al₂O₃ | 1.0 | 0.5 | 120 | 2 | 0 |
| 4 | SiO₂—Al₂O₃ | 1.0 | 0.5 | 120 | 2 | 100 |
| 5 | TPS—HY₃₀ | 1.0 | 0.5 | 120 | 2 | 100 |

An approach for grafting La selectively at the BAS in HY₃₀ was designed to improve the performance of this catalyst. The Si—OH—Al BAS are primarily located in microporous cages (FIG. 4) while silanols are mainly on the external surface after thermal treatment at 500° C. (Medeiros-Costa et al., “Silanol Defect Engineering and Healing in Zeolites: Opportunities to Fine-Tune their Properties and Performances,” Chem. Soc. Rev. 50:11156-11179 (2021), which is hereby incorporated by reference in its entirety). This spatial segregation suggested that silanol capping with Ph₃SiCl (TPSCl) could block unwanted grafting of La(BH₄)₃(THF)₃ on the external surface. TPSCl is too large (˜10 Å diameter) to enter the 7.35 Å micropores and react with BAS in HY₃₀. La(BH₄)ₓ(THF)ₙ—HY₃₀ also provided slightly higher turnovers, yield, and selectivity for PhBpin than the SiO₂—Al₂O₃-grafted catalyst, which cannot be selectively capped. In addition, selective grafting of La(BH₄)₃(THF)₃ on the BAS adjacent to crystallographically equivalent Al-based T4 positions in HY₃₀ could provide a single-site catalyst with structurally uniform sites.

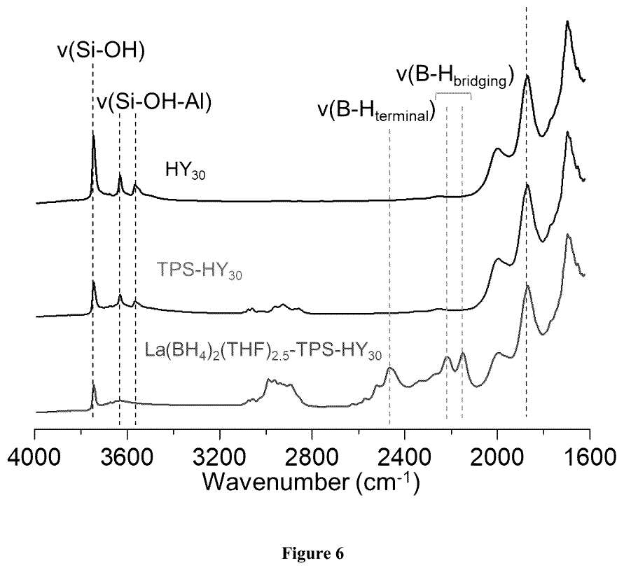

Silanol capping with TPSCl afforded the silylated zeolite TPS—HY₃₀ on a 2 g scale. The normalized intensity of the ν_{vSIOH} signal at 3746 cm⁻¹ in the DRIFTS of TPS—HY₃₀ was decreased by 54% compared to that of the HY₃₀ starting material (FIG. 6) (Cairon et al., “Brønsted Acidity of Extraframework Debris in Steamed Y Zeolites from the FTIR Study of CO Adsorption,” J. Chem. Soc., Faraday Trans. 94:3039-3047 (1998), which is hereby incorporated by reference in its entirety), while BAS-assigned signals at 3630 and 3566 cm⁻¹ were constant in the two samples (Prodinger et al., “Improving Stability of Zeolites in Aqueous Phase via Selective Removal of Structural Defects,” J. Am. Chem. Soc. 138:4408-4415 (2016), which is hereby incorporated by reference in its entirety). In addition, the similar pattern of peaks from ca. 3100-2850 cm⁻¹ associated with vC_{H} in TPSCl (FIG. 2) and in the modified zeolite indicated that organosilyl groups were grafted on HY₃₀. Finally, TPS—HY₃₀ and HY₃₀ mediated HBpin decomposition in comparable times (2 hours), reinforcing the notion that BAS were similarly available inside the pores of TPS—HY₃₀ and HY₃₀, as well as that capping primarily sequestered the external silanols.

Reaction of La(BH₄)₃(THF)₃ and TPS—HY₃₀ afforded La(BH₄)₂(THF)_{2.5}-TPS—HY₃₀. The 0.75 La wt % in the TPS-capped zeolite was expectedly lower than 1.0 La wt % in unprotected La(BH₄)ₓ(THF)ₙ—HY₃₀. DRIFTS revealed new bands at ˜2500 and 2200-2300 cm⁻¹ (FIG. 2) assigned to terminal and bridging ν_{B-H} from grafted borohydride species (Ajellal et al., “Polymerization of Racemic β-Butyrolactone Using Supported Catalysts: a Simple Access to Isotactic Polymers,” Chem. Commun. 46:1032-1034 (2010), which is hereby incorporated by reference in its entirety). Moreover, the normalized intensity of peaks associated with BAS diminished while the silanol signal retained equivalent intensity, suggesting that the La complex was selectively grafted at BAS and residual silanols were not accessible.

In addition, elemental analysis revealed a ca. 3.2:1 ratio of B:La in the TPS—HY₃₀-supported catalyst (Table 3). Thus, EA data suggested that the B₂H₆ byproduct from borohydride protonolysis reacted with the zeolite. The final composition of the active site was assigned as La(BH₄)₂(THF)_{2.5}-TPS—HY₃₀ from these data and the loss of one THF per two La after grafting revealed by quantitative solution-phase ¹H NMR (FIG. 5).

TABLE 3
Comparison of Activity of
Reported Catalysts for Borylation of Benzene

| | | Boron | T | t | |
|---|---|---|---|---|---|
| Reference | Catalyst | reagent | (° C.) | (h) | TON |
| (a) | (η⁵-C₅Me₅)Rh(η⁴-C₆Me₆) | HBpin | 150 | 45 | 328 |
| (b) | (η⁵-C₉H₇)Ir(η⁴-C₈H₁₂) + dmpe | HBpin | 150 | 61 | 4500 |
| (b) | (η⁵-C₉H₇)Ir(η⁴-C₈H₁₂) | HBpin | 150 | 18 | 3 |
| (b) | (η⁶-C₆H₃Me₃)Ir(Bpin)₃ | HBpin | 150 | 15 | 3 |
| (c) | [Ir(η⁴-C₈H₁₂)Cl]₂ + | B₂Pin₂ | 80 | 16 | 8000 |
| | 2,2′-bipyridine | | | | |

(a) Chen et al., “Thermal, Catalytic, Regiospecific Functionalization of Alkanes,” Science 287: 1995-1997 (2000), which is hereby incorporated by reference in its entirety.
(b) Cho et al., “Remarkably Selective Iridium Catalysts for the Elaboration of Aromatic C—H Bonds,” Science 295: 305-308 (2002), which is hereby incorporated by reference in its entirety.
(c) Ishiyama et al., “Mild Iridium-Catalyzed Borylation of Arenes. High Turnover Numbers, Room Temperature Reactions, and Isolation of a Potential Intermediate,” J. Am. Chem. Soc. 124: 390-391 (2002), which is hereby incorporated bv reference in its entirety.

(a) Chen et al., “Thermal, Catalytic, Regiospecific Functionalization of Alkanes,” Science 287:1995-1997 (2000), which is hereby incorporated by reference in its entirety.
(b) Cho et al., “Remarkably Selective Iridium Catalysts for the Elaboration of Aromatic C—H Bonds,” Science 295:305-308 (2002), which is hereby incorporated by reference in its entirety.
(c) Ishiyama et al., “Mild Iridium-Catalyzed Borylation of Arenes. High Turnover Numbers, Room Temperature Reactions, and Isolation of a Potential Intermediate,” J. Am. Chem. Soc. 124:390-391 (2002), which is hereby incorporated by reference in its entirety.

The La(BH₄)₂(THF)_{2.5}-TPS—HY₃₀-catalyzed reaction of benzene and HBpin at 120° C. gave PhBpin in substantially improved yield and turnovers (7.4±0.3% and 61±2, respectively). The four-fold increase in PhBpin yield and six-fold increase in turnovers validated the silanol capping approach. This indicated that a larger fraction of BAS reacted with the La precursor after TPS capping affirmed the hypothesis that ≡Si(≡Al)O—La(BH₄)₂-type sites lead to catalytically active benzene borylation.

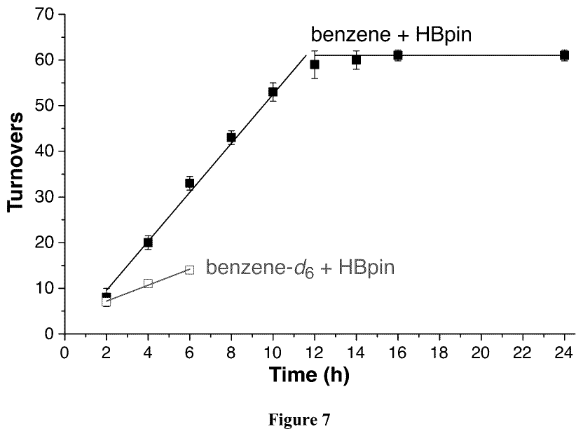

A time-resolved study of the La(BH₄)₂(THF)_{2.5}-TPS—HY₃₀-catalyzed benzene borylation revealed a ˜6 hour half-life for HBpin and a linear increase in turnovers over that time (FIG. 7). The much longer half-life for HBpin during benzene borylation than during its TPS—HY₃₀-mediated decomposition (<1 hour) indicated that this modified catalyst contained few accessible BAS to mediate the unwanted pathway. The rate of PhBpin formation had zero-order dependence in [HBpin]. Comparison of the slopes of turnovers vs time for borylation reactions of benzene and benzene-d₆ revealed a kinetic isotope effect (k_{H}/k_{D}=2.9), which was in the range of metalations of sp² hybridized C—H bonds via σ-bond metathesis steps (Thompson et al., “σ Bond Metathesis for Carbon-Hydrogen Bonds of Hydrocarbons and Sc—R (R═H, alkyl, aryl) Bonds of Permethylscandocene Derivatives. Evidence for Noninvolvement of the π System in Electrophilic Activation of Aromatic and Vinylic C—H Bonds,” J. Am. Chem. Soc. 109:203-219 (1987), which is hereby incorporated by reference in its entirety).

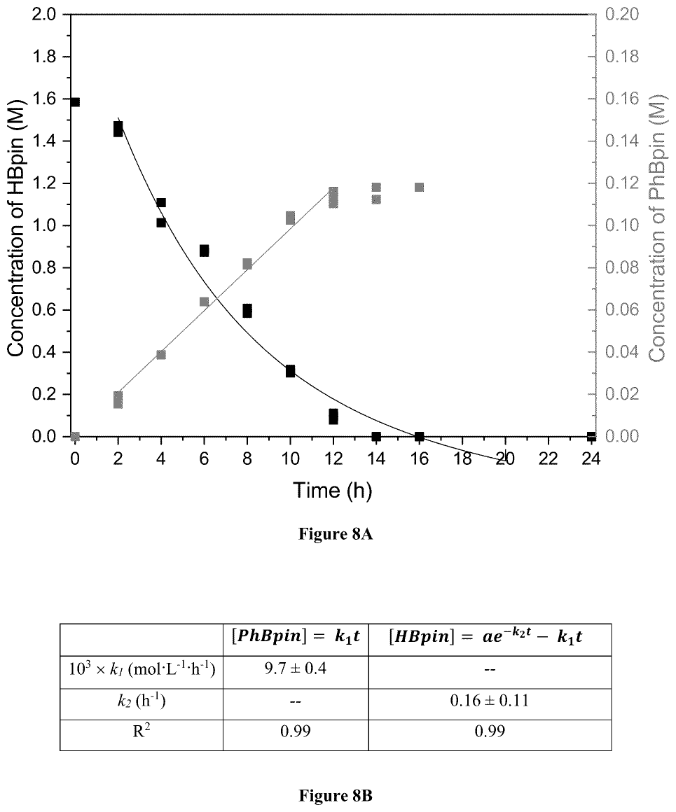

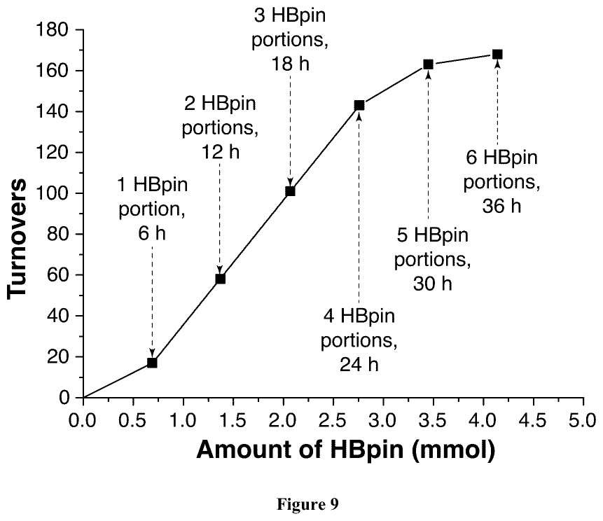

Because the rate of HBpin decomposition depended on its concentration (FIGS. 8A-8B), reactions employing low [HBpin] could lead to increased yields and improved selectivity. This idea was tested through experiments in which HBpin was added in smaller portions (0.69 mol every 6 hours) to a heated mixture of benzene and the La(BH₄)₂(THF)_{2.5}-TPS—HY₃₀ catalyst (FIG. 9). Addition of HBpin in 3 portions (totaling 2.1 mmol) gave full conversion of HBpin, 101 turnovers, and 12% yield of PhBpin, after 18 hours, which favorably compared to the 61 turnovers and 7% yield from the experiment involving an addition of HBpin in a single portion. Clearly, the inequivalent [HBpin] dependences for benzene borylation and HBpin decomposition may be leveraged to access higher catalytic performance.

Addition of 2.8 mmol of HBpin, in four portions, gave 143 turnovers, corresponding to a linear increase in product over 24 hours. Smaller increases, however, were observed in subsequent additions of HBpin. For example, addition of 4.1 mmol divided over six portions gave the maximum TON of 167. Separation of the catalytic material from the PhBpin product and HBpin decomposition product after addition of four portions of HBpin, washing the material with pentane and drying, and performing additional catalytic experiments provided approximately equivalent conversion as addition of HBpin in situ. Thus, under these conditions, the catalyst began to deactivate for PhBpin production after ˜140 turnovers. The side reactions which decompose HBpin were also assumed to be related to catalyst deactivation, since these conditions that lead to greater selectivity also provided a higher absolute TON. Thus, improved yields and TON were likely achievable by avoiding HBpin decomposition, giving comparable performance to iridium catalysts (Table 4).

TABLE 4
Concentration of La and B in Precatalysts Measured by ICP—OES

| Entry | Catalyst | La (wt %) | La (mmol/g) | B (wt %) | B (mmol/g) | B/La |
|---|---|---|---|---|---|---|
| 1 | La(BH₄)ₓ(THF)ₙ—SiO₂ | 2.01 | 0.14 | — | — | — |
| 2 | La(BH₄)ₓ(THF)ₙ—Al₂O₃ | 0.33 | 0.02 | — | — | — |
| 3 | La(BH₄)ₓ(THF)ₙ—SiO₂—Al₂O₃ | 1.28 | 0.09 | — | — | — |
| 4 | La(BH₄)ₓ(THF)ₙ—HY₃₀ | 1.01 | 0.07 | 0.22 | 0.20 | 2.9 |
| 5 | La(BH₄)₂(THF)_{2.5}—TPS—HY₃₀ | 0.75 | 0.05 | 0.18 | 0.16 | 3.2 |

The identification of BAS both as detrimental, leading to HBpin decomposition, and as essential for creating the reactive lanthanum sites for benzene borylation enabled future systematic and rational investigations to design catalysts with greater selectivity and efficiency. In this context, the porous and crystalline zeolite framework was particularly enticing, giving specific loadings of BAS which were either accessible or inaccessible based on the size and shape of the reactant. These catalysts are currently being investigated for such molecular sieving properties in reactive separations and to access enhanced selectivity. In addition, the behavior of C—H borylation versus HBpin decomposition at lower HBpin concentrations, suggested by the observed rate law, further implies improved conversions will develop by influencing concentrations of HBpin and reactant in microporous environment of the catalytic sites.

The functionalization of the zeolite support HY₃₀ was tested with additional capping agents including chloromethyldiphenylsilane (DPMS-Cl), chlorodimethyphenyllsilane (DMPS-Cl), and chlorotrimethylsilane (TMS-Cl), synthesized via the wetness impregnation method described for TPS-Cl. After functionalization, the lanthanum borohydride precursors were grafted on these four as-synthesized supports, labeled as La(BH₄)ₓ(THF)ₙ-TPS—HY₃₀, La(BH₄)ₓ(THF)ₙ-DPMS-HY₃₀, La(BH₄)ₓ(THF)ₙ-DMPS—HY₃₀, La(BH₄)ₓ(THF)ₙ-TMS-HY₃₀, respectively. The loadings of lanthanum complexes of these catalysts were measured by ICP-OES. These materials were also characterized by DRIFTS. The IR peak at 3740 cm⁻¹ associated with the silanol sites (≡Si—OH) was partially reduced by reacting with chlorotriphenylsilane and chloromethyldiphenylsilane, and the two peaks (at 3650 and 3610 cm⁻¹) associated to Brønsted acid sites (Si—OH—Al) were still similar intensity after functionalization with these two capping agents.

The DRIFTS peak of silanol sites was less decreased and peaks of Brønsted acid sites were not readily detected in HY₃₀ modified with chlorodimethylphenylsilane. Likewise, neither silanol site peak nor Brønsted acid sites peaks can be observed by DRIFTS in HY₃₀ modified by reaction with chlorotrimethylsilane.

Catalytic studies of all catalysts were conducted and measured under same conditions, and turnovers were calculated by dividing molar amount of ideal product by molar amount of active sites in catalysts. As demonstrated in Table 5, turnovers of the formation of benzene borylated product, PhBpin, reached 55 and 62 when reactions were in the presence of TPS-Cl- and DPMS-Cl-modified HY₃₀ grafted lanthanum complexes as precatalysts. The turnovers were 27 and 9 by using the lanthanum complexes grafted on HY₃₀ tailored by DMPS-Cl and TMS-Cl as precatalysts, respectively.

TABLE 5
Benzene Borylation Catalyzed by Lanthanum Borohydrides
Grafted on Functionalized Zeolite HY₃₀

| | | Conversion | Yield of | Selectivity | |
|---|---|---|---|---|---|
| | La | of HBpin | PhBpin | of PhBpin | |
| Catalyst | (mmol/g) | (%) | (%) | (%) | Turnovers |
| La(BH₄)ₓ(THF)ₙ-TPS-HY₃₀ | 0.06 | 95 | 6.5 | 6.8 | 55 |
| La(BH₄)ₓ(THF)ₙ-DPMS-HY₃₀ | 0.05 | 100 | 5.6 | 5.6 | 62 |
| La(BH₄)ₓ(THF)ₙ-DMPS-HY₃₀ | 0.07 | 100 | 3.7 | 3.7 | 27 |
| La(BH₄)ₓ(THF)ₙ-TMS-HY₃₀ | 0.08 | 100 | 1.2 | 1.2 | 9 |

[a] reaction condition of all entries was 25 mg catalyst, 0.5 mL Benzene, 0.15 mL HBpin at 120° C. for 12 hours.

Excess trimetyaluminum was added to grafted catalysts a La(BH₄)ₓ(THF)ₙ-TPS—HY₃₀, La(BH₄)ₓ(THF)ₙ-DPMS-HY₃₀, and La(BH₄)ₓ(THF)ₙ-DMPS—HY₃₀, respectively, through the grafting process. La(BH₄)ₓ(THF)ₙ-TPS—HY₃₀-TMA was characterized by DRIFTS. The prepared catalysts were labeled as La(BH₄)ₓ(THF)ₙ-TPS—HY₃₀-TMA, La(BH₄)ₓ(THF)ₙ-DPMS-HY₃₀-TMA, and La(BH₄)ₓ(THF)ₙ-DMPS—HY₃₀-TMA, respectively. The catalytic performances of three catalysts are summarized in Table 6. The turnovers of benzene borylation were increased considerably through the catalysts with TMA treatment, reaching to 104, 100 and 51, respectively. In particular, the La(BH₄)ₓ(THF)-TPS—HY₃₀-TMA present the best activity for benzene borylation under the same reaction condition.

TABLE 6
Benzene Borylation Catalyzed by supported La catalysts treated with AlMe₃

| | | Conversion | Yield of | Selectivity of | |
|---|---|---|---|---|---|
| | La | of HBpin | PhBpin | PhBpin | |
| Catalyst | (mmol/g) | (%) | (%) | (%) | Turnovers |
| La(BH₄)ₓ(THF)ₙ-TPS-HY₃₀ | 0.06 | 100 | 25 | 25 | 104 |
| La(BH₄)ₓ(THF)ₙ-DPMS-HY₃₀ | 0.06 | 100 | 18 | 18 | 100 |
| La(BH₄)ₓ(THF)ₙ-DMPS-HY₃₀ | 0.07 | 100 | 14 | 14 | 51 |

[a] reaction condition of all entries was 25 mg catalyst, 0.5 mL benzene and 0.05 mL HBpin at 120° C. for 60 hours.

### Example 6—Chemicals, Materials, and Characterization Methods for Examples 7-13

### Chemicals and Materials

All anhydrous chemicals were stored in an N₂-filled MBraun glove box (long term) or an Ar-filled LC technologies glove box immediately prior to NMR experiments. Anhydrous solvents including tetrahydrofuran (THF), pentane, and toluene were obtained from Sigma Aldrich and dried and deoxygenated using an IT PureSolv System. Anhydrous benzene from Sigma Aldrich was further dried over activated 3 Å molecular sieves. Benzene-d₆ was heated to reflux over NaK alloy and vacuum-transferred to remove water and oxygen. 4,4,5,5-Tetramethyl-1,3,2-dioxaborolane (HBpin, 97%), 4,4,5,5-tetramethyl-2-phenyl-1,3,2-dioxaborolane (PhBpin, 97%), chlorotriphenylsilane (Ph₃SiCl, 96%), 1,3,5-trimethoxylbenzene, and NaBH₄ (99.99%) were purchased from Sigma Aldrich. ScCl₃ (99.9% anhydrous) was obtained from Strem. HY₃₀ (CBV760, Si/Al=30) was purchased from Zeolyst and was heated at 500° C. for 5 hours under dynamic vacuum. Silica gel (Davisil Grade 643) was purchased from Sigma Aldrich, enriched with ¹⁷O as previously described (Perras et al., “Double-Resonance ¹⁷C NMR Experiments Reveal Unique Configurational Information for Surface Organometallic Complexes,” Chem. Commun. 59:4604-4607 (2023), which is hereby incorporated by reference in its entirety), and heated at 550° C. overnight under dynamic vacuum to affect partial dehydroxylation.

### Summary of Characterization Methods

Solution-phase ¹H and ¹¹B NMR spectra were acquired on a Bruker Avance NEO-400 spectrometer. Gas chromatography-mass spectrometry (GC-MS) analyses were performed using an Agilent 7890A GC and 5975C MS, equipped with a capillary Agilent J&W DB-5ht column. Inductively coupled plasma-optical emission spectrometry (ICP-OES) was performed on an Agilent 5800 to determine the elemental composition (wt %) of scandium in catalysts. Diffuse reflectance infrared Fourier transform spectroscopy (DRIFTS) experiments were conducted using a Bruker VERTEX 80 IR spectrometer equipped with a Harrick “Praying Mantis” accessory, and spectra of samples were recorded within the 4000-400 cm⁻¹ wavenumber range. Samples were prepared in the glovebox under N₂ and sealed before measurements.

### Example 7—Catalyst Preparation

Synthesis of Sc(BH₄)₃(THF)₂

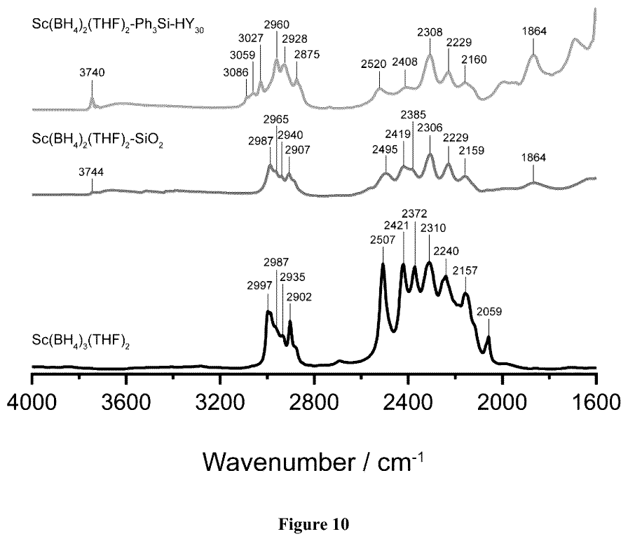

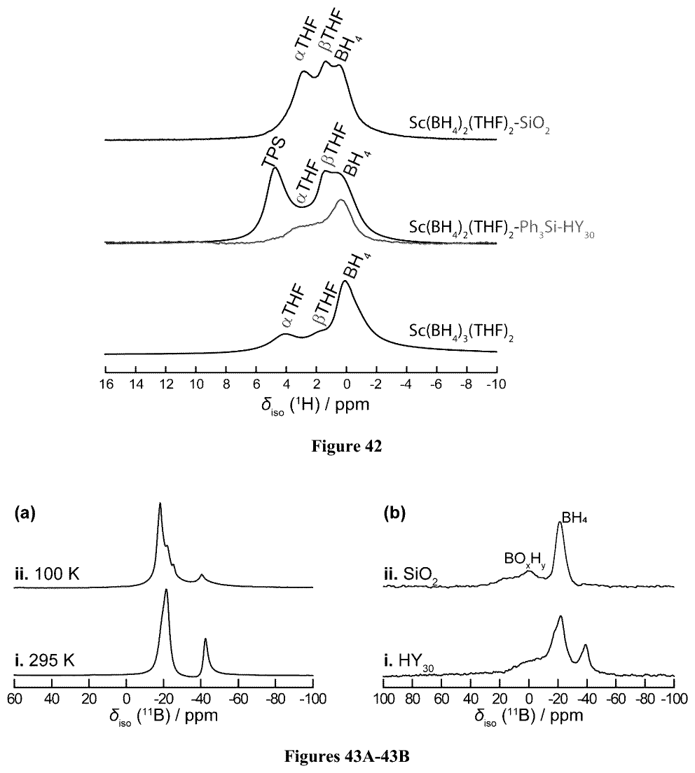

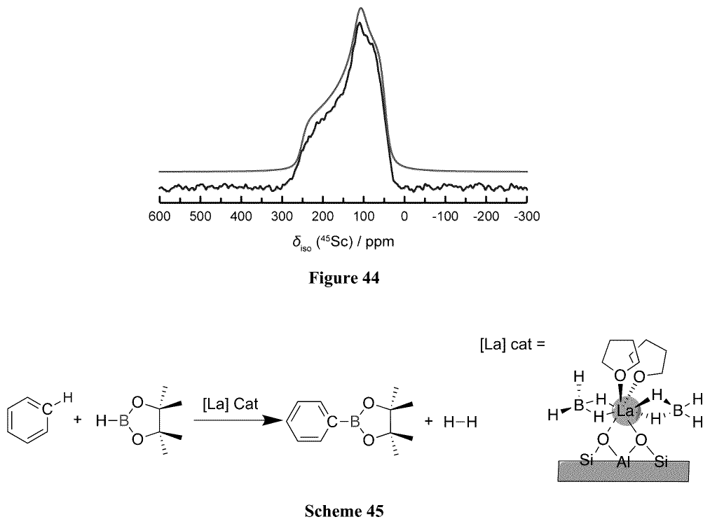

The THF adduct of scandium (III) borohydride was synthesized via the reported method (Guillaume et al., “Polymerization of ε-Caprolactone Initiated by Nd(BH₄)₃(THF)₃: Synthesis of Hydroxytelechelic Poly(ε-caprolactone),” Macromolecules 36:54-60 (2003); Peng et al., “Polymerization of α-Amino Acid N-Carboxyanhydrides Catalyzed by Rare Earth Tris(borohydride) Complexes: Mechanism and Hydroxy-Endcapped Polypeptides,” J. Polym. Sci., Part A: Polym. Chem. 50:3016-3029 (2012), which are hereby incorporated by reference in their entirety). ScCl₃ (0.757 g, 5.01 mmol) and excess sodium borohydride (0.758 g, 20.04 mmol) were heated at reflux in dry THF for 5 days. The solution was filtered through filter paper tied to a cannula to remove the residual NaBH₄ and NaCl. The filtrate was then evaporated under vacuum, giving a solid residue. The residue was extracted with toluene (3×25 mL). The extracts were concentrated and then cooled to −30° C. to crystallize Sc(BH₄)₃(THF)₂ as a colorless powder. The product was isolated by filtration at −30° C. and stored under N₂ in a glovebox. ¹H NMR (benzene-d₆, 400.17 MHz, 25° C.): δ 1.14 (t, 8H, THF—CH₂), 1.26 (br q, 12 H, ¹J_{BH}=80 Hz, BH₄), 3.76 (t, 8H, THF—OCH₂). ¹¹B NMR (benzene-d₆, 128.39 MHz, 25° C.): 6-18.39 (p, ¹J_{BH}=93 Hz, BH₄). Solid State ¹H NMR is shown in FIG. 42 (bottom). Solid State ⁴⁵Sc NMR is shown in FIG. 44 (black line). DRIFTS of Sc(BH₄)₃(THF)₃ (cm⁻¹): 2997 (m, ν_{CH}), 2987 (m, ν_{CH}), 2935 (m, ν_{CH}), 2902 (m, ν_{CH}), 2507 (s, ν_{BH}), 2421 (s, ν_{BH}), 2372 (S, ν_{BH}), 2310 (S, ν_{BH}), 2240 (S, ν_{BH}), 2157 (s, ν_{BH}) (FIG. 10). Anal. Calcd for C₈H₂₈B₃O₂Sc: C, 41.1; H, 12.0. Found: C, 39.4; H 12.4.

### Triphenylsilyl Capping of HY₃₀

Ph₃Si—HY₃₀ was prepared according to the previously reported procedure (Li et al., “Supported Lanthanum Borohydride Catalyzes CH Borylation Inside Zeolite Micropores,” Angew. Chem. Int. Ed. 61: e202117394 (2022), which is hereby incorporated by reference in its entirety). In short, Ph₃SiCl (0.088 g, 0.30 mmol) and HY₃₀ (0.300 g) were mixed in pentane (10 mL) and stirred at room temperature for 24 hours. The supernatant was decanted, the solid was washed with pentane (3×10 mL), and the isolated material was dried under dynamic vacuum (10⁻⁴ mbar) at room temperature for 24 hours.

Grafting of Sc(BH₄)₃(THF)₂

A toluene solution of Sc(BH₄)₃(THF)₂ (0.020 g, 0.08 mmol, 10 mL) was added to the 0.300 g of the corresponding support (Ph₃Si—HY₃₀ or SiO₂). The mixture was stirred at room temperature for 20 hours. The supernatant was decanted, the solid was washed with toluene (3×10 mL), and the material was dried under dynamic vacuum (10^{31 4} mbar) at room temperature for 24 hours. The isolated materials were characterized by DRIFTS (FIG. 10), and the Sc loadings and B/Sc molar ratios were determined by ICP-OES (1.1 wt % of Sc, B/Sc=2.6 for SiO₂ and 0.9 wt % of Sc, B/Sc=2.9 for HY₃₀, respectively). Solid State ¹H NMR is shown in FIG. 42 (middle and top). Solid State ¹¹B NMR is shown in FIGS. 43A-43B.

### Example 8—Catalytic Borylation Experiments

### Catalyst Reaction and Product Analysis

In a typical experiment, an air-tight, Teflon valved, re-sealable glass reactor was charged with the precatalyst (0.005-0.006 mmol Sc), benzene (0.50 mL), and HBpin (0.15 mL, 1.0 mmol) in a glovebox. The reaction vessel was heated in an aluminum heating block at 120° C. for 12 hours. The reaction mixture was cooled, and the solution was separated from the solid catalyst. Each experiment was repeated at least two times. The yield of PhBpin was determined by GC-MS following the previously reported procedure (Li et al., “Supported Lanthanum Borohydride Catalyzes CH Borylation Inside Zeolite Micropores,” Angew. Chem. Int. Ed. 61: e202117394 (2022), which is hereby incorporated by reference in its entirety), using the external standard 1,3,5-trimethoxylbenzene and a calibration response curve. The conversion of HBpin and yield of PhBpin were also analyzed by solution-phase ¹H and ¹¹B NMR spectroscopy.

### Portion-Wise Addition of HBpin

Benzene (1 mL), HBpin (0.15 mL, 1.0 mmol), and precatalyst Sc(BH₄)₂(THF)₂-Ph₃Si (0.040 g, 8 μmol Sc) were mixed and heated to 120° C. for 8 hours achieving ˜100% conversion of HBpin (Table 7). Then, after cooling the reaction solution to ˜20-30° C., an additional portion of HBpin (0.15 mL, 1.0 mmol) was added to the mixture. The new mixed solution was heated to 120° C. for 8 hours again. This process was repeated 8 times. In total 9 portions of HBpin (0.15 mL each portion) were added step-wise into the reaction solution.

TABLE 7
Potion-Wise Addition Experiments via Sc(BH₄)₂(THF)₂—Ph₃Si—HY₃₀^{a}

| | | Total HBpin | HBpin | PhBpin | PhBpin / | |
|---|---|---|---|---|---|---|
| Portion | t / h | Added / mmol | Conversion / % | Yield / % | mmol | TON |
| 1 | 8 | 1.0 | 98 | 4.7 | 0.05 | 6 |
| 2 | 16 | 2.1 | 90 | 6.8 | 0.14 | 17 |
| 4 | 32 | 4.1 | 94 | 7.6 | 0.32 | 39 |
| 5 | 40 | 5.2 | 99 | 8.8 | 0.45 | 57 |
| 6 | 48 | 6.2 | 99 | 10.5 | 0.65 | 81 |
| 8 | 64 | 8.3 | 97 | 11.2 | 0.92 | 115 |
| 9 | 72 | 9.4 | 99 | 10.0 | 0.95 | 119 |

^{a}Reaction conditions: Benzene (1 mL), Sc(BH₄)₂(THF)₂—Ph₃Si—HY₃₀ (0.040 g, ~8 μmol Sc), and Hbpin (0.15 mL, 1.04 mmol) were mixed, and the reaction was heated at 120° C. for 8 hours and analyzed.
A second portion of HBpin (0.15 mL) was added after 8 hours. Subsequently, HBpin (0.15 mL, 1.04 mmol) portions were added every 8 hours.

Solutions with 1, 2, 4, 5, 6, 8, and 9 portions were analyzed to obtain conversions of Hbpin and yields of PhBpin. Turnovers were calculated by dividing moles of PhBpin (formed) by moles of scandium.

### Example 9—Solid-State NMR

All experiments were carried out at 9.4 T using a Bruker Avance III 400 MAS-DNP spectrometer equipped with either a triple resonance 3.2 mm or 1.3 mm low-temperature magic angle spinning (MAS) probe. The dynamic nuclear polarization (DNP) instrumentation was chosen to ensure that the samples, which are highly air-sensitive, remained under an inert atmosphere for the duration of the experiments. Unless otherwise stated, the sample temperature for these experiments was maintained at 100 K, which helped slow down the motions and obtain meaningful dynamic data. A Bruker Avance Neo 600 MAS spectrometer equipped with a triple resonance 2.5 mm MAS probe was used to acquire data at 14.1 T with spinning under a constant flow of dry N₂ gas. The static spectrum for the molecular precursor was acquired at 9.4 T using an Agilent DD2 400 MHz spectrometer equipped with a 3.2 mm MAS probe using a constant flow of dry N₂ purge gas.

The ⁴⁵Sc{²⁷Al} transfer of population double-resonance (TRAPDOR) experiment (Grey et al., “¹⁴N Population Transfers in Two-Dimensional ¹³C¹⁴N ¹H Triple-Resonance Magic-Angle Spinning Nuclear Magnetic Resonance Spectroscopy,” Solid State Nucl. Magn. Reson. 4:113-120 (1995), which is hereby incorporated by reference in its entirety) was performed using an MAS frequency of 10 kHz. A central transition (CT)-selective ⁴⁵Sc excitation pulse of 10 s was used, while TRAPDOR dephasing was achieved by ²⁷Al continuous wave (CW) irradiation. The ²⁷Al radiofrequency (RF) was optimized to maximize the dephasing of the ⁴⁵Sc signal and was c.a. 100 kHz. Each spectrum was acquired using 4096 scans and a 0.5 s recycle delay. The probe was simultaneously tuned to ⁴⁵Sc (ν₀=97.27 MHz) and ²⁷Al (ν₀=104.34 MHz) using a REDOR Box frequency splitter from NMR-service GmbH (van Wüllen et al., “Modern Solid State Double Resonance NMR Strategies for the Structural Characterization of Adsorbate Complexes Involved in the MTG Process,” Phys. Chem. Chem. Phys. 4:1665-1674 (2002); Pourpoint et al., “Measurement of Aluminum-Carbon Distances Using S-RESPDOR NMR Experiments,” ChemPhysChem, 13:3605-3615 (2012), which are hereby incorporated by reference in their entirety). The uncertainty (σ) for each point in the TRAPDOR experiment was calculated as a function of the signal intensity (S and S₀) and the signal-to-noise ratio (SNR):

$${σ}_{TRAPDOR} = \frac{{σ}_{{S}_{0}}}{{S}_{0}^{2}} \sqrt{{S}_{0}^{2} + {S}^{2}} \qquad ( Eq . 2 )$$

$$Where$$

$${σ}_{{S}_{0}} = \sqrt{\frac{{S}_{0}}{2 * {SNR}_{{S}_{0}}}} \qquad ( Eq . 3 )$$

Symmetry-based rotational-echo saturation-pulse double-resonance (S-RESPDOR) experiments (Gan Z., “Measuring Multiple Carbon-Nitrogen Distances in Natural Abundant Solids Using R-RESPDOR NMR,” Chem. Commun. 4712-4714 (2006); Chen et al., “Measurement of Hetero-Nuclear Distances Using a Symmetry-Based Pulse Sequence in Solid-State NMR,” Phys. Chem. Chem. Phys. 12:9395-9405 (2010), which are hereby incorporated by reference in their entirety) were acquired using an MAS frequency of 35.714 kHz and ¹H SR4₁₂ heteronuclear dipolar recoupling (Brinkmann et a., “Proton-Selective¹⁷O-¹H Distance Measurements in Fast Magic-Angle-Spinning Solid-State NMR Spectroscopy for the Determination of Hydrogen Bond Lengths,” J. Am. Chem. Soc. 128:14758-14759 (2006), which is hereby incorporated by reference in its entirety). Recoupling increments equaled four rotor periods and the saturation pulse applied to ¹¹B, ⁴⁵Sc, ²⁷Al, or ¹⁷O lasted 1.5t_{R}. The RF fields for each X-nucleus was c.a. 62.5 kHz, and the pulse powers were optimized such that a maximum dephasing of the ¹H resonance was observed using 21 loops of recoupling. Each spectrum was acquired in 32-64 scans with a 3.5 s recycle delay.

1D ⁴⁵Sc and ¹¹B NMR spectra were acquired using Hahn-echo experiments. Samples were spun at either a 12.5 kHz (3.2, 2.5 mm rotors) or 35.714 kHz (1.3 mm) MAS rotation frequency with the echo delays set to one rotor period. For ⁴⁵Sc, up to ˜30 k scans were acquired, while for ¹¹B, only ˜10 k scans were needed. Experiments were carried out with recycle delays of 1 s, and CT selective excitation pulses of 10 μs for both ⁴⁵Sc and ¹¹B. 1D ¹H experiments were acquired using Bloch decay experiments using a 2.5 mm MAS probe, an MAS spinning frequency of 12.5 kHz, and excitation pulses lasting 2.5 μs.

### Example 10—Solid-State NMR Lineshape Fitting Procedures

Sc(BH₄)₃(THF)₂

The ⁴⁵Sc MAS spectra for the molecular precursor complex were simulated using ssNAKE, version 1.4 (van Meerten et al., “ssNake: A Cross-Platform Open-Source NMR Data Processing and Fitting Application,” J. Magn. Reson. 301:56-66 (2019), which is hereby incorporated by reference in its entirety). A static spectrum was acquired to measure the chemical shift anisotropy and fit the MAS spinning sidebands. These values were used to simultaneously simulate the MAS spectra using the following parameters, reported here using the Herzfeld-Berger (or Maryland) convention:

$${δ}_{iso} = ( {δ}_{11} + {δ}_{22} + {δ}_{33} ) / 3 = 137.7 ppm \qquad ( Eq . 4 )$$

$$Ω = {δ}_{11} - {δ}_{33} = 221.5 ppm \qquad ( Eq . 5 )$$

$$κ = 3 ( {δ}_{22} - {δ}_{iso} ) = - 0.45 , where ( - 1 \leq κ \leq 1 ) \qquad ( Eq . 6 )$$

The quadrupolar coupling parameters equaled C_{Q}=3.3 MHz and η_{Q}=1.0; with the Euler angles defining the rotation of the chemical shift anisotropy tensor from the electric field gradient tensor: α=12°, β=12°, and γ=1°. Due to a lack of second-order line shape, however, these parameters had large uncertainties. The quadrupolar product (P_{Q}=C_{Q}(1+η_{Q}²/3)^{1/2}) was predominantly determined using the field dependence of the peak position and was considered far more accurate.

Sc(BH₄)₂(THF)₂-Ph₃Si—HY₃₀

A homebuilt, open-source, C/C++ program was developed to simulate MAS NMR spectra from quadrupolar nuclei experiencing dynamic jump motions (https://github.com/fperras/Dynamic_Quad_lineshape). During simulations, the Larmor frequency was updated for different magnetic fields along with the MAS spinning frequency.

Sc(BH₄)₂(THF)₂—SiO₂

To account for its broad distribution of EFG tensor parameter, the ⁴⁵Sc CT lineshape was fitted to a Gaussian distribution of C_{Q} values and equally-probable r/Q values using the software Quadfit (Kemp et al., “QuadFitA New Cross-Platform Computer Program for Simulation of NMR Line Shapes From Solids with Distributions of Interaction Parameters,” Solid State Nucl. Magn. Reson. 35:243-252 (2009), which is hereby incorporated by reference in its entirety) (Table 8).

TABLE 8
Fitting Parameters

| Software Parameter Name | Value |
|---|---|
| Shift of the line (ppm) | 75 |
| No calc steps | 1000 |
| No freq steps = 2\hat{ }n | 4096 |
| Lowest freq to calc | −30 |
| Highest freq to calc | 30 |
| Min. Quad. Coup. | 0 |
| Min. Asym. | 0 |
| Max. Quad. Coup. | 30 |
| Max. Asym. | 1 |
| No. Quad. Dist. calcs | 30 |
| No. Asym. Dist. calcs | 10 |
| Broadening (Hz) | 1000 |
| 0 = Gaus., 1 = Lorent. | 0 |
| Model | MAS |
| Dist. Type | Gaussian |
| Width of Quad. Dist. | 10 |
| Center of Quad. Dist. | 19 |
| Width of Asym. Dist. | 0.5 |
| Center of Asym. Dist. | 0.5 |

### Example 11—Quantum Chemical Calculations

To predict the magnetic shielding (MS) and electric field gradient (EFG) tensors, first-principles density functional theory (DFT) calculations were carried out on cluster models of the complex grafted to either zeolite HY₃₀ or silica gel using the ADF program available in AMS 2022.102 (te Velde et al., “Chemistry with ADF,” J. Comput. Chem. 22:931-967 (2001), which is hereby incorporated by reference in its entirety). Geometry optimizations were carried out at the PBEO/TZP (H, B, C and O) and PBE/TZ2P+(Sc) level of theory using Grimme's D3 dispersion correction (Ernzerhof et al., “Assessment of the Perdew-Burke-Ernzerhof Exchange-Correlation Functional,” J. Chem. Phys. 110:5029-5036 (1999); Adamo et al., “Toward Reliable Density Functional Methods Without Adjustable Parameters: The PBEO Model,” J Chem. Phys. 110:6158-6170 (1999); Grimme et al., “A Consistent and Accurate ab Initio Parametrization of Density Functional Dispersion Correction (DFT-D) for the 94 Elements H—Pu,” J. Chem. Phys. 132:154104 (2010), which are hereby incorporated by reference in their entirety). Relativistic effects were included using the scalar zeroth order relativistic approximation (ZORA) (van Lenthe et al., “Relativistic Regular Two-Component Hamiltonians,” J. Chem. Phys. 9:4597-4610 (1993); van Lenthe et al., “Relativistic Total Energy Using Regular Approximations,” J. Chem. Phys. 101:9783-9792 (1994); van Lenthe et al., “Geometry Optimizations in the Zero Order Regular Approximation for Relativistic Effects,” J. Chem. Phys. 110:8943-8953 (1999), which are hereby incorporated by reference in their entirety). For the 2b, geometry optimizations were carried out on cluster models representing the complex undergoing a secondary dative interaction with the support surface by varying the SiO—Sc—O angle in increments of 100 between 700 and 120°. Angles of 60° and below were found to result in an unstable complex where the fragment involving the dative interaction drifted away over the course of the geometry optimization. MS and EFG tensors were calculated using the CPL module using the same level of theory (Schreckenbach et al., “Calculation of NMR Shielding Tensors Using Gauge-Including Atomic Orbitals and Modern Density Functional Theory,” J. Phys. Chem. 99:606-611 (1995); Krykunov et al., “Hybrid Density Functional Calculations of Nuclear Magnetic Shieldings Using Slater-Type Orbitals and the Zeroth-Order Regular Approximation,” Int. J. Quantum. Chem. 109:1676-1683 (2009); van Lenthe and Baerends, “Density Functional Calculations of Nuclear Quadrupole Coupling Constants in the Zero-Order Regular Approximation for Relativistic Effects,” J. Chem. Phys. 112:8279-8292 (2000), which are hereby incorporated by reference in their entirety). For 3a (Tables 9 and 12), the extended surface of the geometry-optimized cluster model was reduced in size to for the shielding calculation. To convert the calculated magnetic shielding constants to chemical shifts, the following equation was used:

$${δ}_{iso} \approx {σ}_{ref} - {σ}_{iso} \qquad ( Eq . 7 )$$

where σ_{ref} is the absolute magnetic shielding of the reference compound (⁴⁵Sc: 930.12 ppm calculated from hexaaquascandium(III) (Rossini et al., “Experimental and Theoretical Studies of ⁴⁵Sc NMR Interactions in Solids,” J. Am. Chem. Soc. 128:10391-10402 (2006), which is hereby incorporated by reference in its entirety); ¹¹B: 102.70 ppm calculated from OEtBF₃ (Hayashi et al., “Shift References in High-Resolution Solid-State NMR,” Bull. Chem. Soc. Jpn. 62:2429-2430 (1989), which is hereby incorporated by reference in its entirety).

### Example 12—Quadrupolar Product and Second-Order Quadrupolar Shift

The quadrupolar product (P_{Q}) and the isotropic chemical shift for the ⁴⁵Sc and ¹¹B MAS spectra were obtained as described previously (Hunger et al., “Characterization of Sodium Cations in Dehydrated Faujasites and Zeolite EMT by ²³Na DOR, 2D Nutation, and MAS NMR,” Solid State Nucl. Magn. Reson. 2:111-120 (1993); Engelhardt et al., “Strategies for Extracting NMR Parameters From MAS, DOR and MQMAS Spectra. A case study for Na₄P₂O₇,” Solid State Nucl. Magn. Reson. 15:171-180 (1999), which are hereby incorporated by reference in their entirety) and summarized below. The P_{Q} is given by:

$${P}_{Q} = {{C}_{Q} ( 1 + \frac{{{η}_{Q}}^{2}}{3} )}^{\frac{1}{2}} \qquad ( Eq . 8 )$$

where C_{Q} is the quadrupolar coupling constant and r/Q is the quadrupolar asymmetry parameter.

The apparent chemical shift of a quadrupolar nucleus measured at any magnetic field is given by a sum of the isotropic chemical shift, and the 2^{nd} order quadrupolar shift, δ_{QIS} and is given by:

$${δ}_{obs} = {δ}_{iso} + {δ}_{QIS} \qquad ( Eq . 9 )$$

$$where$$

$${δ}_{QIS} = - {D}_{I} \frac{{{P}_{Q}}^{2}}{{{v}_{L}}^{2}} \qquad ( Eq . 10 )$$

The isotropic chemical shift can, therefore, be obtained by measuring the apparent chemical shift at two magnetic field strengths:

$${δ}_{iso} = \frac{{{v}_{L , 1}}^{2} {δ}_{obs , 1} - {{v}_{L , 2}}^{2} {δ}_{obs , 2}}{{{v}_{L , 1}}^{2} {{v}_{L , 2}}^{2}} \qquad ( Eq . 11 )$$

P_{Q} can be obtained using:

$${P}_{Q} = {( \frac{40}{3} \times {10}^{- 6} ( \frac{{δ}_{obs , 1} - {δ}_{obs , 2}}{{{v}_{L , 2}}^{- 2} - {{v}_{L , 1}}^{- 2}} ) \times [ \frac{{{I}^{2} ( 2 I - 1 )}^{2}}{I ( I + 1 ) - \frac{3}{4}} ] )}^{\frac{1}{2}} \qquad ( Eq . 12 )$$

The random uncertainty in the chemical shift measurement is a function of the linewidth (LW) and the SNR and is given by Lee et al., “Quantitative Evaluation of Positive Angle Propensity in Flexible Regions of Proteins From Three-Bond J Couplings,” Phys. Chem. Chem. Phys. 18:5759-5770 (2016), which is hereby incorporated by reference in its entirety:

$$σ = \frac{LW}{2 \times SNR} \qquad ( Eq . 13 )$$

and is propagated throughout, assuming an uncertainty of 0 in ν_{L}.

### Example 13—Results and Discussion of Examples 7-12

Sc(BH₄)₃(THF)₂ (1) supported on silica (2) and Ph₃Si—HY₃₀ (3) were studied and advanced multinuclear NMR methods were used to rationalize the dramatic differences in the catalysts' activities (Vancompernolle et al., “On the Use of Solid-State ⁴⁵Sc NMR for Structural Investigations of Molecular and Silica-Supported Scandium Amide Catalysts,” Dalton Trans. 46:13176-13179 (2017); Culver et al., “Solid-State ⁴⁵Sc NMR Studies of Cp*₂Sc—OR (R═CMe₂CF₃, CMe(CF₃)₂, C(CF₃)₃, SiPh₃) and Relationship to the Structure of Cp*₂Sc-Sites Supported on Partially Dehydroxylated Silica,” Organometallics 39:1112-1122 (2020); Paterson et al., “Observing the Three-Dimensional Dynamics of Supported Metal Complexes,” Inorg. Chem. Front. 8:1416-1431 (2021); which are hereby incorporated by reference in their entirety). While homogeneous organoscandium compounds are known for C—H bond activation by σ-bond metathesis (Thompson et al., “σ Bond Metathesis for Carbon-Hydrogen Bonds of Hydrocarbons and Sc—R (R═H, alkyl, aryl) Bonds of Permethylscandocene Derivatives. Evidence for Noninvolvement of the π System in Electrophilic Activation of Aromatic and Vinylic C—H Bonds,” J. Am. Chem. Soc. 109:203-219 (1987), which is hereby incorporated by reference in its entirety) and have been used in catalytic dehydrocoupling of alkanes and silanes (Sadow et al., “Catalytic Functionalization of Hydrocarbons by σ-Bond-Metathesis Chemistry: Dehydrosilylation of Methane with a Scandium Catalyst,” Angew. Chem. Int. Edit. 42:803-805 (2003); Sadow et al., “Synthesis and Characterization of Scandium Silyl Complexes of the Type Cp*2ScSiHRR. σ-Bond Metathesis Reactions and Catalytic Dehydrogenative Silation of Hydrocarbons,” J. Am. Chem. Soc. 127:643-656 (2005), which are hereby incorporated by reference in their entirety), the present disclosure provides a first report of scandium catalysed C—H borylation.

The scandium borohydride complexes as molecular 1, silica-supported 2, and Ph₃Si—HY₃₀-supported 3 were investigated as pre-catalysts for benzene borylation to compare with the larger lanthanum analogues. For reference, (η⁵-C₅Me₅)₂ScMe reacted more slowly in σ-bond metathesis of benzene than the yttrium or lutetium analogues (Watson et al., “Organolanthanides in Catalysis,” Acc. Chem. Res. 18:51-56 (1985), which is hereby incorporated by reference in its entirety), whereas (η⁵-C₅Me₅)₂LaCH₂SiMe₃ catalyzed hydroboration rather than CH borylation of pyridine (Rothbaum et al., “Chemodivergent Organolanthanide-Catalyzed C—H α-Mono-Borylation of Pyridines,” J. Am. Chem. Soc. 144:17086-17096 (2022), which is hereby incorporated by reference in its entirety). Briefly, 1.04 mmol of pinacolborane (HBpin) and 0.6 mol % of the respective Sc species were heated in benzene at 120° C. for 12 hours (Table 9). HBpin itself barely reacted and PhBpin was not formed in detectable quantities with 1 and 2 under these conditions. In contrast, HBpin was entirely consumed and PhBpin was formed in >8% yield in the presence of the precatalyst 3, corresponding to a TON of 17. This yield was comparable to the value of 7.4% observed for the corresponding La(BH₄)₂(THF)_{2.5}-Ph₃Si—HY₃₀ borylation catalyst (Li et al., “Supported Lanthanum Borohydride Catalyzes CH Borylation Inside Zeolite Micropores,” Angew. Chem. Int. Ed. 61: e202117394 (2022), which is hereby incorporated by reference in its entirety). The molar loading of scandium on Ph₃Si—HY₃₀ is higher than that of lanthanum, presumably because the small size of scandium allows Sc(BH₄)₃(THF)₂ to penetrate deeper than La(BH₄)₃(THF)₃ into the zeolite microporous channel. As a result, the Sc precatalyst (3) had more active sites and gave a higher yield than the La material despite the lower turnovers.

TABLE 9
Comparison of Scandium Borohydride Complexes for Catalytic Borylation of Benzene^{a}

| | Sc loading^{b} | | HBpin | PhBpin | |
|---|---|---|---|---|---|
| Catalyst | % w/w | mmol · g⁻¹ | Conversion/% | Yield/% | TON |
| Sc(BH₄)₃(THF)₂ | n/a | n/a | ~0 | 0 | 0 |
| Sc(BH₄)₂(THF)₂—SiO₂ | 1.1 | 0.25 | ~4 | 0 | 0 |
| Sc(BH₄)₂(THF)₂—Ph₃Si—HY₃₀ | 0.9 | 0.19 | 100 | 8.1 ± 0.2 | 17 ± 2 |

^{a}Reaction conditions: HBpin (0.15 mL, 1.04 mmol), 0.5-0.6 mol % scandium borohydride, benzene (0.5 mL), 120° C., 12 hours.
^{b}Measured by ICP-OES.

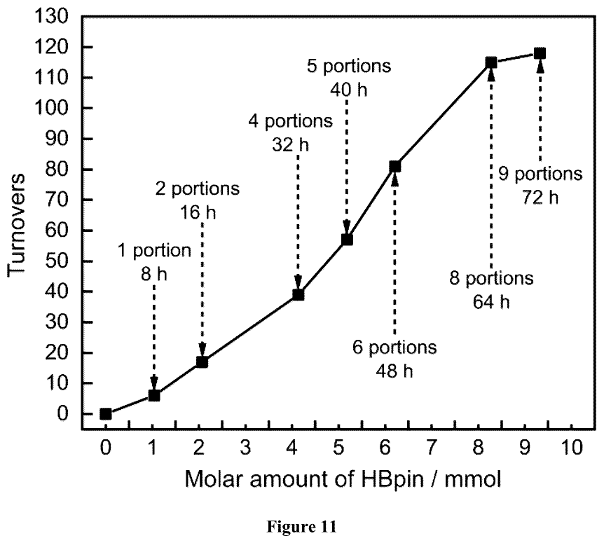

Because the lanthanum-catalyzed reaction has a zeroth-order rate dependence on the concentration of HBpin, while HBpin decomposition is concentration-dependent, lower concentrations of HBpin should increase the PhBpin selectivity and hence, yield. This behavior was previously observed in La(BH₄)₂(THF)_{2.5}-Ph₃Si—HY₃₀-catalysed benzene borylation. Accordingly, HBpin (1.35 mmols) was divided into 0.15 mL portions, which were added every 8 hours to the reaction mixture (1 mL benzene, 0.040 g 3 containing 8 μmol Sc). Under these conditions, turnovers giving PhBpin increased to 119 (FIG. 11). The 5% selectivity measured after the first 8 hours was actually lower than in the experiment of Table 9 because more catalyst was added (to increase the reaction rate). However, the overall selectivity for PhBpin increased to >10% by the end of the experiment.

Starting with the 2^{nd} portion addition, the turnovers increased nearly linearly with each addition, suggesting minimal catalyst deactivation. By the addition of the 9^{th} portion, a slight decrease in selectivity was observed, which likely resulted from the gradual deactivation of the scandium catalyst. In summary, Sc(BH₄)₂(THF)₂—SiO₂ and La(BH₄)₂(THF)_{2.2}—SiO₂ were similarly inactive, as were Sc(BH₄)₃(THF)₂ and La(BH₄)₃(THF)₃, while Sc(BH₄)₂(THF)₂-Ph₃Si—HY₃₀ and La(BH₄)₂(THF)_{2.5}-Ph₃Si—HY₃₀ had similar catalytic activity for benzene borylation.

These studies indicated a correspondence between the catalytic properties of the scandium and lanthanum-based species. While the lanthanum analogue did not allow for high-resolution structural and dynamical characterization, the use of a relatively NMR-friendly metal, scandium, may enable to uncover the structural basis for the strong influence of the support.

An approach to determine the conformations of oxide-supported complexes utilizing surface ¹⁷O-enrichment and atom-to-surface 170 distance measurements was recently reported (Perras et al., “Double-Resonance ¹⁷C NMR Experiments Reveal Unique Configurational Information for Surface Organometallic Complexes,” Chem. Commun. 59:4604-4607 (2023), which is hereby incorporated by reference in its entirety). To this end, a ca. 80% surface-¹⁷O-enriched silica was used to acquire ¹H{¹¹B, ¹⁷O, ⁴⁵Sc} symmetry-based rotational-echo saturation-pulse double-resonance (S-RESPDOR) experiments (Brinkmann et a., “Proton-Selective ¹⁷O-¹H Distance Measurements in Fast Magic-Angle-Spinning Solid-State NMR Spectroscopy for the Determination of Hydrogen Bond Lengths,” J. Am. Chem. Soc. 128:14758-14759 (2006); Gan Z., “Measuring Multiple Carbon-Nitrogen Distances in Natural Abundant Solids Using R-RESPDOR NMR,” Chem. Commun. 4712-4714 (2006); Chen et al., “Measurement of Hetero-Nuclear Distances Using a Symmetry-Based Pulse Sequence in Solid-State NMR,” Phys. Chem. Chem. Phys. 12:9395-9405 (2010), which are hereby incorporated by reference in their entirety) (FIGS. 12A-12B) at 100 K to limit motions and the data was analyzed using the INTERFACES program to determine the structure (Cunningham et al., “INTERFACES. A Program for Determining the 3D Structures of Surfaces Sites Using NMR Data,” J. Magn. Reson. Open 12-13:100066 (2022), which is hereby incorporated by reference in its entirety). The ¹H signals from BH₄ and α and β positions of THF (adjacent to and furthest from the ethereal oxygen, respectively) were discernible enabling the measurement of nine datasets. To fit the data, it was necessary to account for the motions of the ligands. For instance, the intra-BH₄ 1H—¹¹B order parameters ((S), which ranged from 1 in static molecules to 0 in the case of isotropic tumbling (Blanc et al., “Dynamics of Silica-Supported Catalysts Determined by Combining Solid-State NMR Spectroscopy and DFT Calculations,” J. Am. Chem. Soc. 130:5886-5900 (2008); Lipari et al., “Model-Free Approach to the Interpretation of Nuclear Magnetic Resonance Relaxation in Macromolecules. 1. Theory and Range of Validity,” J. Am. Chem. Soc. 104:4546-4559 (1982), which are hereby incorporated by reference in their entirety) were found to equal 0.015, indicative of rapid reorientation, while the α-THF ¹H—⁴⁵Sc (S) equals 0.625, corresponding to a C₂ rotation about the Sc—O bond. The determined ligand arrangement and fits are shown in FIG. 12B, which shows a preference for the THF ligands resting closest to the silica surface.

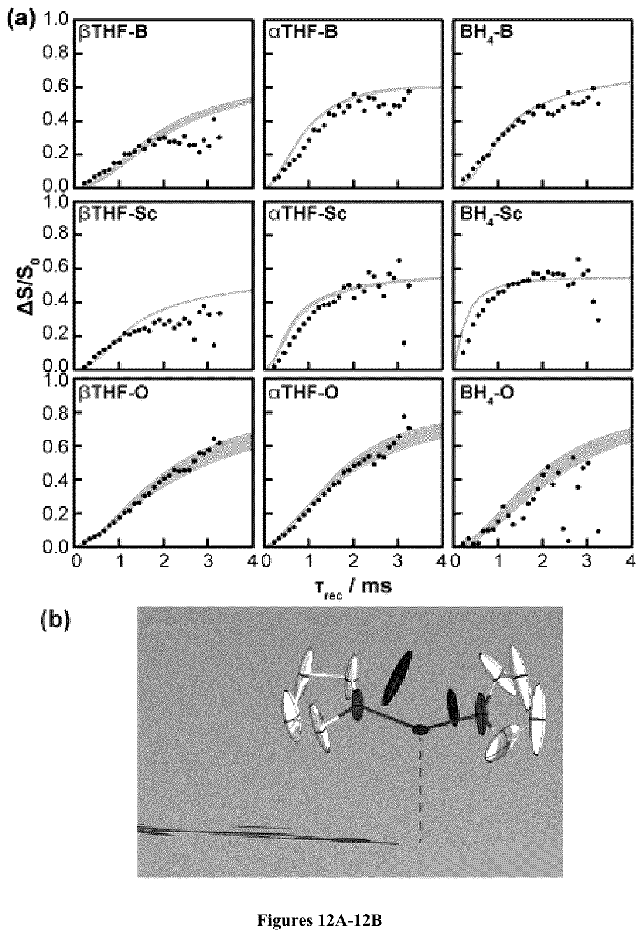

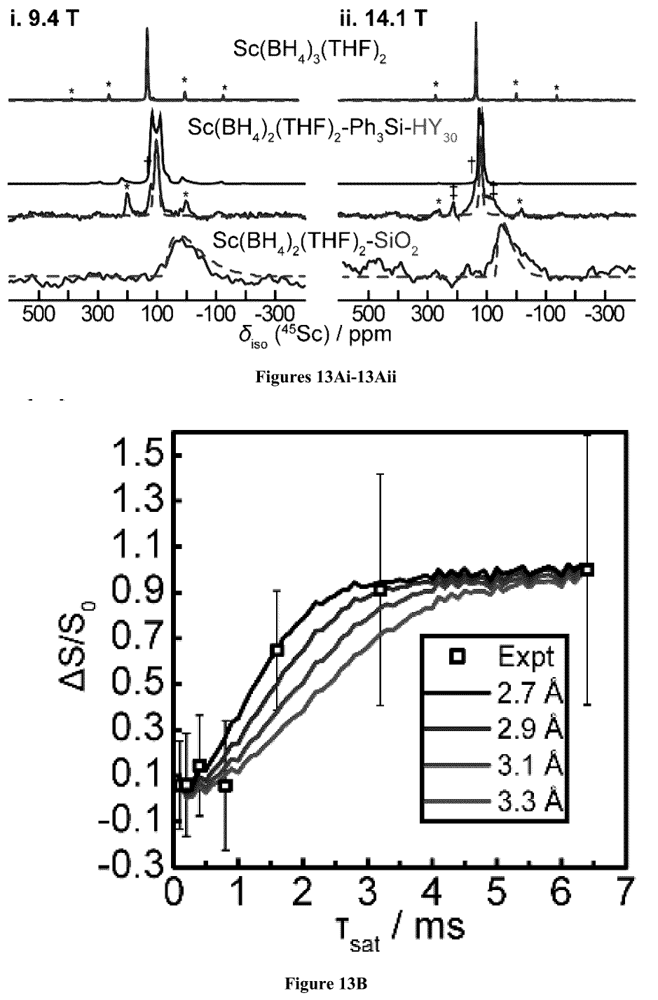

Next, the ligand arrangement in catalyst 3 was studied, which could contribute to differences in activity. First it was determined whether or not Sc was indeed associated with a BAS. Although prior ¹¹B NMR data and catalytic comparisons suggest BAS in HY₃₀ were important for generating the appropriate precatalyst, the binding location and the surface-metal bonding were inferred in those experiments by ¹¹B NMR chemical shifts and a presumption that external capping with Ph₃SiCl selected for silanols. As such, ⁴⁵Sc{²⁷Al} transfer of population double-resonance (TRAPDOR) experiment was performed (Grey et al., “¹⁴N Population Transfers in Two-Dimensional ¹³C ¹⁴N ¹H Triple-Resonance Magic-Angle Spinning Nuclear Magnetic Resonance Spectroscopy,” Solid State Nucl. Magn. Reson. 4:113-120 (1995), which is hereby incorporated by reference in its entirety) (FIG. 13B), which probed the proximity between Sc and Al. A clear response was observed which, when simulated using SIMPSON (Bak et al., “SIMPSON: A General Simulation Program for Solid-state NMR spectroscopy,” J. Magn. Reson. 147:296-330 (2000), which is hereby incorporated by reference in its entirety), indicated an aluminium centre within 2.7 to 3.1 Å of this Sc. This distance agreed well with the expected interatomic distance of 3.4 Å predicted using density functional theory (DFT) calculations and confirmed the assignment of the Sc centre in 3 to a ≡Si(≡Al)O—Sc species. The minor deviation between DFT and TRAPDOR was likely caused by the latter's semi-quantitative nature, and the presence of sites in proximity to two Al centres.

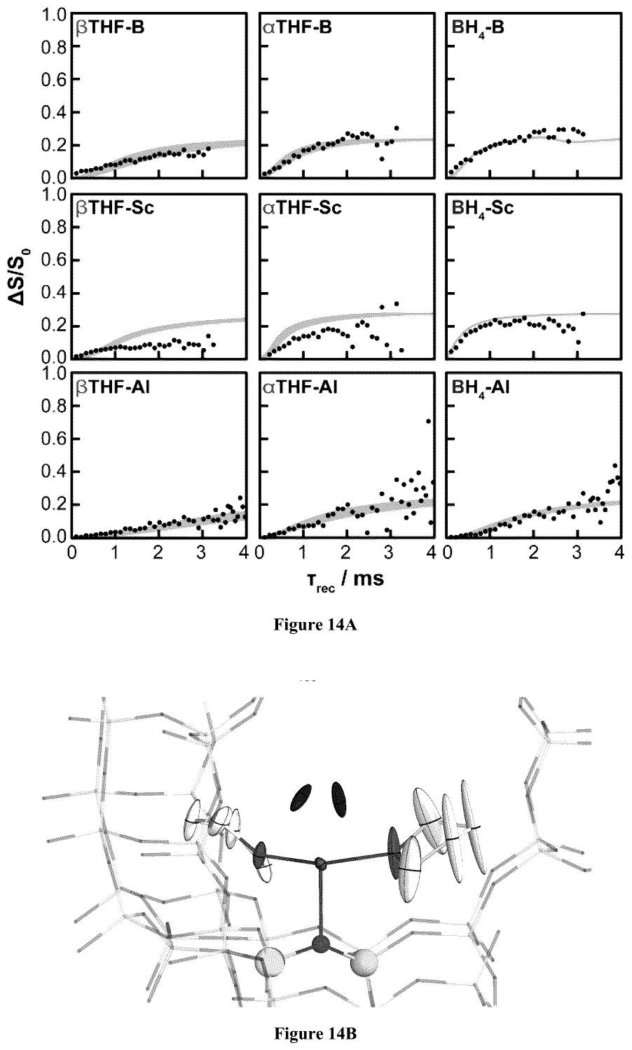

Similar ¹H{¹¹B, ²⁷Al, ⁴⁵Sc} S-RESPDOR experiments were applied to 2 to determine the configuration of the ligands in 3 and whether it differs from that in 2 (FIGS. 14A-14B). As was done for 2, the experiments were performed at a sample temperature of 100 K. Interestingly, despite the complete dephasing in the ⁴⁵Sc{²⁷Al} TRAPDOR experiment (FIG. 13B), the ¹H S-RESPDOR dephasing was reduced to only ⅓ of the theoretical value in 3 signifying that this species underwent more pronounced motions, such as rotations around the O_{BAS}—Sc bond. This contrasted with 2 where the observed dephasing reached 90% of the theoretical maximum. Further experiments performed at 300 K revealed that all sites in 3 were highly fluxional at that temperature while sites in 2 remain largely rigid (FIG. 15A-15B), demonstrating that the silica-supported Sc sites were far more tightly bound to the support.

The determined configuration for 3 closely matched that from 2, with the complex adopting a trigonal bipyramidal configuration, with the THF ligands occupying the axial positions close to the surface. As such, the high reactivity of 3 is more likely related to its rapid rotational motions rather than the configuration of its ligands. To obtain further details into the binding of Sc to the two supports, ⁴⁵Sc variable-field MAS NMR was performed. The spectra of 1-3 are shown in FIG. 13A. 3 had a chemical shift of 133 ppm, close to 1's 138 ppm, while 2 had a chemical shift of 62 ppm, demonstrating that the binding to the support was indeed very different. These values were obtained by analysing the centre of mass of the spectra at 9.4 and 14.1 T, given that well-defined lineshapes were not discernible.

Half-integer quadrupolar nuclei, such as 45Sc, offered unique insights into motions given that the magnitude of the quadrupolar interaction can be determined using both lineshape analysis and the isotropic second-order quadrupole shift. If the linewidth is narrower than predicted using the shift, then there must be dynamics at play. The 45Sc quadrupolar product (P_{Q}) for the faujasite-bound complex was determined to equal 10.3 MHz, which disagreed with its narrow linewidth (FIG. 13A). This suggested a reorientation of the complex about the OBAS-Sc bond, in agreement with the weaker S-RESPDOR dephasing (FIGS. 14A-14B). Indeed, this linewidth was reproduced by introducing a C2 rotation about the OBAS-Sc bond (Paterson et al., “Observing the Three-Dimensional Dynamics of Supported Metal Complexes,” Inorg. Chem. Front. 8:1416-1431 (2021); Schurko et al., “Dynamic Effects on the Powder Line Shapes of Half-Integer Quadrupolar Nuclei: A Solid-State NMR Study of XO₄⁻ Groups,” J. Phys. Chem. A 106:51-62 (2002), which are hereby incorporated by reference in their entirety). This molecular reorientation was not observed in the silica-bound complex whose linewidth was well represented by a Gaussian distribution of quadrupolar coupling constants ranging from 9 to 29 MHz (Kemp et al., “QuadFitA New Cross-Platform Computer Program for Simulation of NMR Line Shapes From Solids with Distributions of Interaction Parameters,” Solid State Nucl. Magn. Reson. 35:243-252 (2009), which is hereby incorporated by reference in its entirety), again, in agreement with the S-RESPDOR experiments (FIGS. 12A-12B).

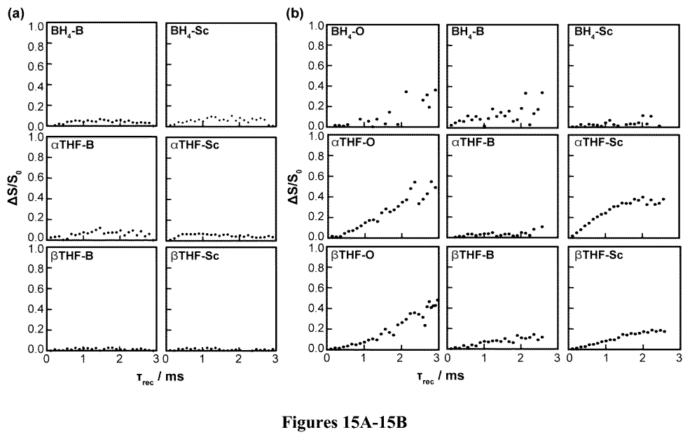

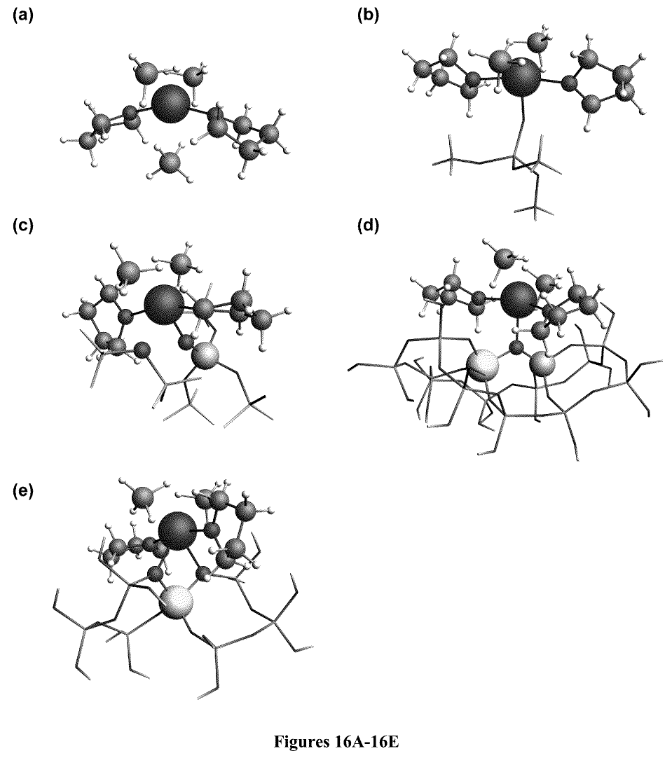

To explain the differences in chemical shifts and dynamics between the complexes, DFT calculations on a number of potential species were carried out (Table 10), including a model of the precursor (1) (Lobkovskii et al., “X-ray Structure Study of Crystals of the Tetrahydrofuranate of Scandium Borohydride,” J. Struct. Chem. 18:312-314 (1977), which is hereby incorporated by reference in its entirety) (FIGS. 16A-16E) and models of 2 and 3 that either exclude (2a, 3a) or include (2b, 3b) a secondary dative interaction from the support surface (Vancompernolle et al., “On the Use of Solid-State ⁴⁵Sc NMR for Structural Investigations of Molecular and Silica-Supported Scandium Amide Catalysts,” Dalton Trans. 46:13176-13179 (2017); Ajellal et al., “Polymerization of Racemic β-Butyrolactone Using Supported Catalysts: A Simple Access to Isotactic Polymers,” Chem. Commun. 46:1032-1034 (2010); Rosal et al., “Supported Neodymium Catalysts for MMA Polymerization: on the Origin of Surface-Induced Stereoselectivity,” Polym. Chem 3:1730-1739 (2012), which are hereby incorporated by reference in their entirety). Specifically, for 2b, a series of calculations were carried out varying the SiO—Sc—O_{surface} angle from 700 to 1200 to represent the amorphous character of the material (Table 11).

TABLE 10
DFT-Predicted ⁴⁵Sc NMR Parameters* for Various Structures

| | Structure | \|C_{Q}\|/MHz | η_{Q} | \|P_{Q}\|/MHz | δᵢₛₒ/ppm |
|---|---|---|---|---|---|
| 1 | Sc(BH₄)₃(THF)₂ | 4.2 | 0.30 | 4.3 | 124.7 |
| | | | | (3.9 ± 0.1) | (138 ± 2) |
| 2a | 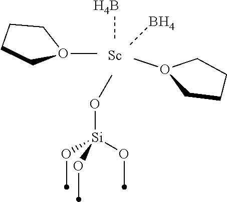 | 25.2 | 0.42 | 5.9 | 148.9 |
| 2b | 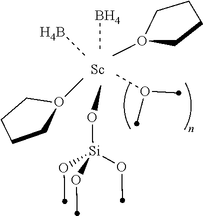 | 26.5-35.3 | 0.04-0.19 | 26.5-35.5 (13.3 ± 4.2) | 70.0-113.0 (62 ± 2) |
| 3a | 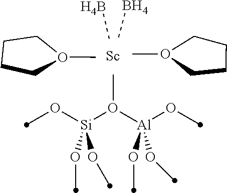 | 12.7 | 0.89 | 14.3 (10.3 ± 1.2) | 146.0 (133 ± 2) |
| 3b | 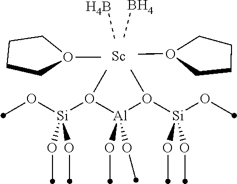 | 3.6 | 0.90 | 4.0 | 45.3 |

*experimental values are shown in parentheses

TABLE 11
DFT-Predicted ⁴⁵Sc and ¹¹B NMR Parameters for 3b as a Function of the SiO—Sc—O Angle

| | ⁴⁵Sc | | | | ¹¹B | | | |
|---|---|---|---|---|---|---|---|---|
| Angle | \|C_{Q}\| / MHz | η_{Q} | \|P_{Q}\| / MHz | δᵢₛₒ / ppm | \|C_{Q}\| / MHz | η_{Q} | \|P_{Q}\| / MHz | δᵢₛₒ / ppm |
| 120 | 35.3 | 0.19 | 35.5 | 103.4 | 1.15 | 0.61 | 1.25 | −18.0 |
| 110 | 35.0 | 0.17 | 35.2 | 113.0 | 1.14 | 0.87 | 1.28 | −18.9 |
| 100 | 32.5 | 0.11 | 32.5 | 70.0 | 0.86 | 0.74 | 0.93 | −23.2 |
| 90 | 31.7 | 0.04 | 31.7 | 71.6 | 0.89 | 0.67 | 0.95 | −23.1 |
| 80 | 31.1 | 0.05 | 31.1 | 77.0 | 0.92 | 0.60 | 0.99 | −22.6 |
| 76.1^{[a]} | 30.0 | 0.06 | 30.1 | 78.7 | 0.93 | 0.57 | 1.00 | −22.4 |
| 70 | 26.5 | 0.11 | 26.5 | 80.0 | 0.95 | 0.53 | 1.01 | −21.6 |

^{[a]}Lowest-energy structure

The calculated O—Sc distances from the four lowest energy structures differed significantly, with 2a and 2b having predicted —SiO—Sc interatomic distances of 1.905 and 1.995 Å, while the calculated ≡Si(≡Al)O—Sc distance equaled 2.198 Å in 3a, and 2.270 and 2.214 Å in 3b. These results strongly suggested that deprotonated BAS were far weaker electron donors than silanolates. The calculated ⁴⁵Sc NMR parameters are listed in Table 10. The predicted ⁴⁵Sc chemical shifts were strongly affected by an increase in coordination number, with 2b and 3b having predicted chemical shifts of 70-113 and 45.3 ppm, while 2a and 3a had predicted chemical shifts of 148.9 and 146.0 ppm, respectively. These trends indicated that the faujasite-bound scandium site bind to a single surface oxygen while an additional siloxane coordination is formed on silica. For the latter, the fact that DFT predicted C_{Q} and δᵢₛₒ values were still greater than experiment could suggest the existence of multiple such dative interactions. These results further explained the differences in the two complexes' dynamics, given that the silica-bound site was locked in a particular orientation on the surface while the ≡Si(≡Al)O—Sc site can rotate about its bond to the support.

Interestingly, if a DFT optimization of 3a was performed in the absence of its local microporous structure, the species reoriented to form 3b (FIG. 16D), suggesting that the micropore may be required to stabilize the monopodal site.

La(BH₄)₂(THF)_{2.2}—SiO₂ was previously shown to yield a ¹¹B NMR resonance at −22 ppm (Ajellal et al., “Polymerization of Racemic β-Butyrolactone Using Supported Catalysts: a Simple Access to Isotactic Polymers,” Chem. Commun. 46:1032-1034 (2010), which is hereby incorporated by reference in its entirety), which also appeared in the spectrum of La(BH₄)₂(THF)_{2.5}-Ph₃Si—HY₃₀ as a minor species. The spectrum of the latter material also displayed a more intense resonance at higher frequency of −15 ppm (Li et al., “Supported Lanthanum Borohydride Catalyzes CH Borylation Inside Zeolite Micropores,” Angew. Chem. Int. Ed. 61: e2021 17394 (2022); Ajellal et al., “Polymerization of Racemic β-Butyrolactone Using Supported Catalysts: a Simple Access to Isotactic Polymers,” Chem. Commun. 46:1032-1034 (2010), which are hereby incorporated by reference in their entirety). These resonances were assigned to ≡Si—O—La and ≡Si(≡Al)O—La sites, respectively. These assignments were further supported by the DFT calculations of the Sc analogues (Table 12), which predicted ¹¹B chemical shifts of −21.4 and −16.8 ppm for the two sites.

TABLE 12
DFT-Predicted ¹¹B NMR Parameters for Various Structures^{[a]}

| | Structure | \|C_{Q}\|/MHz | η_{Q} | \|P_{Q}\|/MHz | δᵢₛₒ/ppm |
|---|---|---|---|---|---|
| 1 | Sc(BH₄)₃(THF)₂ | 1.02 | 0.35 | 1.1 | −22.7 |
| 2a | 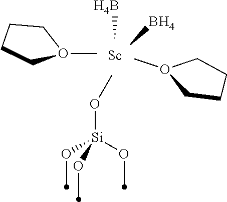 | 1.00 | 0.57 | 1.08 | −27.7 |
| 2b^{[b]} | 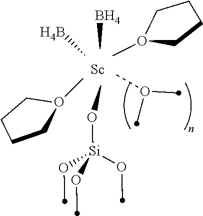 | 0.9-1.2 (0.97) | 0.61-0.87 (0.65) | 0.93-1.28 (1.06) | −23.2-−18.0 (−21.4) |
| 3a | 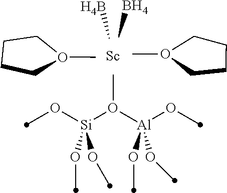 | 1.06 | 0.65 | 1.16 | −16.8 |
| 3b | 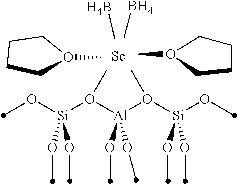 | 0.83 | 0.27 | 0.85 | −26.3 |

^{[a]}Reported values are the average of the calculated NMR parameters for the sites.
^{[b]}The average over the range of geometry optimized cluster models is given in parentheses.

A combination of NMR-based distance measurements, dynamics studies, and DFT calculations was used to shed light on the differences between silica- and zeolite-bound scandium borohydride complexes. The latter compound is the first example of a scandium-based precatalyst for CH borylation. Grafting in a zeolite micropore led to the formation of a highly dynamic monopodal site while silica can accommodate a more stable, and less reactive, siloxane-coordinated site. DFT results further suggested that micropore structure may be required to allow the formation of a coordinatively unsaturated monopodal species. As such, the enhanced catalytic activity of the zeolite-supported La catalyst likely resulted from both the weaker donor ability of the support and the accessibility of coordinatively unsaturated species, and that both a BAS and a microporous environment are required to produce these reactive complexes.

### Example 14—Chemicals and Materials for Examples 15-19

All anhydrous chemicals were stored in N₂-filled MBraun glove box unless otherwise indicated. Anhydrous solvents including tetrahydrofuran (THF) and pentane were obtained from Sigma Aldrich and purified using an IT PureSolv System. Anhydrous hexane, benzene (99.8%), toluene (99.8%), ethylbenzene (99.8%), anisole (99.7%), pyridine (99.8%), and cyclohexane (99.5%) were purchased from Sigma Aldrich and were further dried with molecular sieves. Bromobenzene (≥99.5%) was purchased from Sigma Aldrich. Oxygen was removed from bromobenzene via freeze-pump-thaw and it was dried with molecular sieves. 4,4,5,5-Tetramethyl-1,3,2-dioxaborolane (HBpin, 97%), 4,4,5,5-tetramethyl-2-phenyl-1,3,2-dioxaborolane (PhBpin, 97%), chlorotriphenylsilane (Ph₃Si—Cl, 96%), NaBH₄ (99.99%), and 1,3,5-trinethoxylbenzene (TMOB) were purchased from Sigma Aldrich. 2,4,4,5,5-pentamethyl-1,3,2-dioxaborolane (MeBpin, >98%) was obtained from TCI America. Trimethylaluminium (AlMe₃, 97%) and lithium dimethylamide (LiNMe₂) were purchased from Sigma Aldrich. LaCl₃ (99.9% anhydrous) was obtained from Strem. Benzene-d₆ and toluene-d₈ were heated to reflux with Na and vacuum-transferred to remove water and oxygen. Aerosil 380 was purchased from Evonik and treated at 550° C. for 5 hours under dynamic vacuum for dihydroxylation. HY₃₀ (CBV760, Si/Al=30) was purchased from Zeolyst and treated at 500° C. for 5 hours under dynamic vacuum for dihydroxylation. 4,4,5,5-Tetramethyl-2-(o-tolyl)-1,3,2-dioxaborolane (98.0%), 4,4,5,5-tetramethyl-2-(m-tolyl)-1,3,2-dioxaborolane (97.0%), 4,4,5,5-tetramethyl-2-(p-tolyl)-1,3,2-dioxaborolane (98.0%), 4,4,5,5-tetramethyl-2-phenethyl-1,3,2-dioxaborolane (96.0%), 2-(2-ethylphenyl)-4,4,5,5-tetramethyl-1,3,2-dioxaborolane (95.0%), 2-(3-ethylphenyl)-4,4,5,5-tetramethyl-1,3,2-dioxaborolane (95.0%), and 2-(4-ethylphenyl)-4,4,5,5-tetramethyl-1,3,2-dioxaborolane (98.0%) were purchased from Combi-Blocks. 2-Benzyl-4,4,5,5-tetramethyl-1,3,2-dioxaborolane (>97.0%), 2-(2-methoxyphenyl)-4,4,5,5-tetramethyl-1,3,2-dioxaborolane (97.0%), 2-(3-methoxyphenyl)-4,4,5,5-tetramethyl-1,3,2-dioxaborolane (97.0%), 2-(4-methoxyphenyl)-4,4,5,5-tetramethyl-1,3,2-dioxaborolane (97.0%), 2-(4,4,5,5-tetramethyl-1,3,2-dioxaborolan-2-yl)pyridine (98.0%), 3-(4,4,5,5-tetramethyl-1,3,2-dioxaborolan-2-yl)pyridine (98.0%), 4-(4,4,5,5-tetramethyl-1,3,2-dioxaborolan-2-yl)pyridine (98.0%), 2-(2-bromophenyl)-4,4,5,5-tetramethyl-1,3,2-dioxaborolane (98.0%), 2-(3-bromophenyl)-4,4,5,5-tetramethyl-1,3,2-dioxaborolane (98.0%), 2-(3-bromophenyl)-4,4,5,5-tetramethyl-1,3,2-dioxaborolane (98.0%), 2-(4-ethylphenyl)-4,4,5,5-tetramethyl-1,3,2-dioxaborolane (>95.0%), 2-(4-ethylphenyl)-4,4,5,5-tetramethyl-1,3,2-dioxaborolane (>95.0%), and 2-cyclohexyl-4,4,5,5-tetramethyl-1,3,2-dioxaborolane (98.0%) were purchased from AmBeed. All these chemicals were stored at −20° C. in the freezer of glove box.

### Example 15—Characterization Methods and Technologies

Inductively coupled plasma-optical emission spectrometry (ICP-OES) was performed on an Agilent 5800 to determine elemental composition (wt %) of lanthanum, boron, silicon, and aluminum in the catalysts.

Diffuse reflectance infrared Fourier transform spectroscopy (DRIFTS) experiments were conducted using a Bruker VERTEX 80 IR spectrometer equipped with a Harrick “Praying Mantis” accessory, and spectra of samples were recorded within the 4500-600 cm⁻¹ wavenumber range. Samples were prepared in the glovebox under N₂ and sealed before measurements.

Solution nuclear magnetic resonance: ¹H and ¹¹B NMR spectra were collected on a Bruker Avance NEO-400 spectrometer. Gas chromatography-mass spectrometry (GC-MS) analysis were performed using an Agilent 7890A GC and 5975C MS, equipped with a capillary Agilent J&W DB-5ht column.

Solid-state nuclear magnetic resonance (SS NMR) experiments were performed on a Varian NMR spectrometer operating at 9.4 T with a Chemagnetics 5 mm double-resonances magic-angle spinning (MAS) probe (one-dimensional ¹¹B direct polarization (DP)MAS, ¹³C{¹H} cross-polarization (CP)MAS, and two-dimensional ¹¹B triple-quantum (3Q)MAS experiments or a Bruker NEO spectrometer operating at 14.1 T with a Bruker 2.5 mm triple-resonance MAS probe (¹H DPMAS). All the samples are packed in MAS zirconia rotors in a glove box under argon or nitrogen atmosphere and capped tightly. The samples were spun using N₂ gas to minimize contamination from moisture. The detailed experimental conditions are summarized in Table 13 using the following symbols: ν_{R} denotes the magic-angle spinning (MAS) rate, ν_{RF}(X) the magnitude of the radio frequency (RF) magnetic field applied to X spins, TCP the cross-polarization (CP) contact time; τ_{RD} the recycle relay; NS the number of scans.

TABLE 13

| Experiment | Experimental Parameters |
|---|---|
| ¹¹B DPMAS | ν_{R} = 5 kHz, ν_{RF}(¹¹B) = ~4 kHz during |
| | soft π/2 pulse, ν_{RF}(¹H) = 20 kHz during TPPM |
| | ¹H decoupling. T_{RD} = 1 s, NS = 4000. |
| ¹¹B 3QMAS | ν_{R} = 5 kHz, ν_{RF}(¹¹B) = ~100 kHz for the |
| | excitation and conversion pulses, ν_{RF}(¹¹B) = ~4 kHz |
| | for the z-filter selective pulse, ν_{RF}(¹H) = 20 kHz |
| | during TPPM ¹H decoupling. T_{RD} = 0.8 s, 32 t₁ points with |
| | 50 μs interval, NS = 960 per row. |
| 13C{¹H} CPMAS | ν_{R} = 5 kHz, ν_{RF}(¹H) = 50 kHz during a π/2 pulse |
| | and CP contact pulse, and 20 kHz during TPPM ¹H decoupling. |
| | N_{RF}(¹³C) = ~55 kHz during the CP contact pulse, τ_{CP} = |
| | 2 ms, τ_{RD} = 1 s, NS = 32000. |
| ¹H DPMAS | ν_{R} = 25 kHz, ν_{RF}(¹H) = 100 kHz during a π/2 pulse. |
| | T_{RD} = 40 s, NS = 16. |

### Example 16—Catalyst Preparation

Synthesis of La(BH₄)₃(THF)₃

Lanthanum (III) borohydride—La(BH₄)₃(THF)₃ was synthesized via reported method (Mostajeran et al., “Base-Metal Nanoparticle-Catalyzed Hydrogen Release from Ammine Yttrium and Lanthanum Borohydrides,” Chem. Mater. 29:742-751 (2017), which is hereby incorporated by reference in its entirety). LaCl₃ (2.455 g, 10.01 mmol) and excess sodium borohydride (1.515 g, 40.05 mmol) were heated at reflux in dry THF for 5 days. The solution was filtered using a cannula filtration to remove the residual NaBH₄ and NaCl. The filtrate was then evaporated under vacuum, giving a solid residue that was extracted with toluene. The extracts were concentrated and then cooled to −30° C., giving La(BH₄)₃(THF)₃ as a colorless powder that was isolated and stored under N₂ in a glovebox. The solution ¹H and ¹¹B NMR spectra matched the literature (Guillaume et al., “Polymerization of ε-Caprolactone Initiated by Nd(BH₄)₃(THF)₃: Synthesis of Hydroxytelechelic Poly(ε-caprolactone),” Macromolecules 36:54-60 (2003); Ajellal et al., “Polymerization of Racemic β-Butyrolactone Using Supported Catalysts: A Simple Access To Isotactic Polymers,” Chem. Commun. 46:1032-1034 (2010), which are hereby incorporated by reference in their entirety). ¹H NMR (toluene-d₈, 400.17 MHz, 25° C.): δ 1.35 (t, 12H, THF—CH₂), 1.73 (br q, 12 H, ¹J_{BH}=80 Hz, BH₄), δ 3.82 (t, 12H, THF—OCH₂). ¹¹B NMR (toluene-d₈, 128.39 MHz, 25° C.): δ 19.03 (p, ¹J_{BH}=85 Hz, BH₄). DRIFTS of La(BH₄)₃(THF)₃ (cm⁻¹): 2996 (m, ν_{CH}), 2975 (m, ν_{CH}), 2946 (m, ν_{CH}), 2911 (m, ν_{CH}), 2458 (s, ν_{BH-terminal}), 2317 (s, ν_{BH}-combination), 2236 (s, ν_{BH-bridging}), 2176 (s, ν_{BH-bridging}).

Synthesis of La(AlMe₄)₃

Lanthanum (III) tris(tetramethylaluminate)—La(AlMe₄)₃ was synthesized using a reported method (Evans et al., “The Use of Heterometallic Bridging Moieties to Generate Tractable Lanthanide Complexes of Small Ligands,” Angewandte Chemie-International Edition in English 33(15-16):1641-1644 (1994); Zimmermann et al., “Homoleptic Rare-Earth Metal(III) Tetramethylaluminates: Structural Chemistry, Reactivity, and Performance in Isoprene Polymerization,” Chemistry—A European Journal 13(31):8784-8800 (2007); Fischbach et al., “Stereospecific Polymerization of Isoprene with Molecular and MCM-48-Grafted Lanthanide(III) Tetraalkylaluminates,” Angewandte Chemie International Edition 43(17):2234-2239 (2004), which are hereby incorporated by reference in their entirety). La(NMe₂)₃(LiCl)₃ was prepared from LaCl₃ and LiNMe₂. In a nitrogen-filled glovebox, to a suspension of La(NMe₂)₃(LiCl)₃ (2.0 g, 5.0 mmol, 1.0 eq) in anhydrous hexane (20 mL) was added dropwise a solution of AlMe₃ (2.0 M in hexane, 22.5 mL, 45.0 mmol, 9.0 eq.). The above reaction mixture was stirred vigorously at r.t. for 24 hours. The mixture was passed through a pad of Celite to remove the insoluble precipitate, and the filtrate was concentrated under reduced pressure. The resulting pale-yellow residue was extracted several times with hexane, and the pure product was obtained by recrystallizing three times from hexane at −40° C. The solution ¹H and ¹³C NMR spectra matched the literature (Fischbach et al., “Stereospecific Polymerization of Isoprene with Molecular and MCM-48-Grafted Lanthanide(III) Tetraalkylaluminates,” Angewandte Chemie International Edition 43(17):2234-2239 (2004), which is hereby incorporated by reference in its entirety). ¹H NMR (benzene-d₆, 400.17 MHz, 25° C.): δ −0.20 (s). ¹³C NMR (benzene-d₆, 285.8 MHz, 25° C.): δ 6.00 (s). DRIFTS of La(AlMe₄)₃ (cm⁻¹): 3016 (m, ν_{CH}), 2927 (s, ν_{CH}), 2886 (m, ν_{CH}), 2830 (m, ν_{CH}) 2772 (s, ν_{CH}).

### Silane Capping of HY₃₀

Ph₃Si—HY₃₀ was prepared by mixing the chlorotriphenylsilane Ph₃Si—Cl (0.070 g, ˜0.30 mmol) and HY₃₀ (0.300 g) in pentane (5 mL) (Li et al., “Supported Lanthanum Borohydride Catalyzes CH Borylation Inside Zeolite Micropores,” Angewandte Chemie International Edition 61(15): e2021 17394 (2022), which is hereby incorporated by reference in its entirety). The mixture was stirred at room temperature for 30 hours. The supernatant was decanted, the solid was washed with pentane (3×10 mL), and the isolated material was dried under dynamic vacuum (10-4 mbar) at room temperature for 24 hours. The obtained solids were characterized by DRIFTS and SSNMR.

General Procedure for Grafting of La(BH₄)₃(THF)₃

A toluene solution of La(BH₄)₃(THF)₃ (0.040 g, 0.10 mmol, 10 mL) was added to the support such as Ph₃Si—HY₃₀, HY₃₀, or SiO₂ (0.300 g). There were approximately 0.93, 0.47, and 0.66 mmol OH/g in HY₃₀, Ph₃-HY₃₀, and SiO₂, respectively, titrated via Mg(CH₂Ph)₂(OC₂C₄H₈)₂ at room temperature for 20 hours. The mixture was stirred at room temperature for 20 hours. The supernatant was decanted, the solid was washed with toluene (3×10 mL), and the material was dried under dynamic vacuum (10⁻⁴ mbar) at room temperature for 24 hours. The isolated materials were characterized by DRIFTS, and La loading was determined by ICP-OES.

General Procedure for Treating Supported La Catalysts with Trimethylaluminum

A 5 mL toluene solution containing excess trimethylaluminum (AlMe₃, 0.029 g, 0.4 mmol) was added to the grafted catalyst such as La(BH₄)₂(THF)₂-Ph₃Si—HY₃₀, La—HY₃₀, or La—SO (0.200 g, dispersed in 5 mL toluene). The mixture was stirred at room temperature overnight. The supernatant was decanted, the solid was washed with toluene (3×10 mL), and the material was dried under dynamic vacuum (10-4 mbar) at room temperature for 24 hours. The isolated materials were characterized by DRIFTS and La loading was determined by ICP-OES.

### Example 17—Catalytic Borylation Experiments

### Catalyst Testing and Optimization Studies

In a typical experiment, an air-tight, Teflon valved, re-sealable glass reactor was charged with the precatalyst (0.025 g, ˜0.002 mmol La), benzene (0.50 mL), and HBpin (0.15 mL, 1.0 mmol) in the glovebox. The reaction vessel was heated in an aluminum heating block at a typical temperature (120° C.) for certain reaction time (60 hours). The reaction mixture was cooled, the solution was separated from the solid catalyst, and then the reaction mixture was characterized by calibrated GC-MS and ¹¹B NMR spectroscopy. Each experiment was repeated at least two times.

Experiments with Varying Amounts of HBpin

A series of experiments were conducted with same amounts of La(BH₄)₂(AlMe₃)-Ph₃Si—HY₃₀ (0.025 g) and benzene (1.00 mL). 0.05 mL (˜0.35 mmol), 0.10 mL (0.69 mmol), 0.20 mL (1.4 mmol), and 0.30 mL (2.1 mmol) of HBpin were individually added into the above mixture of catalysts and benzene. Each reaction mixture was heated at 120° C. for 36 hours, 36 hours, 48 hours, and 48 hours to achieve conversion of HBpin at 82%, 77%, 80%, and 70%, respectively.

Experiments with Varying Amounts of Catalyst

A series of experiments were conducted with same amounts of benzene (1.00 mL) and HBpin (0.10 mL, 0.69 mmol). 0.010 g (˜0.001 mmol La), 0.030 g (˜0.002 mmol La), 0.050 g (˜0.004 mmol La), and 0.070 g (˜0.005 mmol La) of La(BH₄)₂(AlMe₃)-Ph₃Si—HY₃₀ were separately added into the above solution of benzene and HBpin. These reaction mixtures were heated at 120° C. for 72 hours, 60 hours, 48 hours, and 36 hours to achieve conversion of HBpin at 88%, 96%, 9800, and 95%, respectively.

Experiments with Variable Temperature

A series of experiments were conducted with same amounts of benzene (1.00 mL), HBpin (0.1 mL), and 0.030 g of La(BH₄)₂(AlMe₃)-Ph₃Si—HY₃₀ (˜0.002 mmol La). The above mixture was heated at different temperatures 110, 120, 130, 140, and 150° C. At first, high conversions of HBpin (69%, 77%, 88%, 95%, and 100%) at each temperature were achieved when the experiment was performed for 48 hours, 36 hours, 24 hours, 18 hours, 12 hours, respectively. Then, the reaction time was varied to be 24 hours, 20 hours, 16 hours, 12 hours, and 8 hours, respectively to control the conversion of HBpin less than 35% in each experiment (under kinetic control region).

### Kinetic Investigations

The time-resolved studies of benzene borylation catalyzed by La(BH₄)₂(AlMe₃)-Ph₃Si—HY₃₀ were performed by heating the catalyst (˜0.002 mmol La, 0.030 g), benzene (1.0 mL), and HBpin (0.10 mL, 0.7 mmol) at 120° C. The experiments were then stopped (cooled) and sampled after 3, 6, 12, 18, 24, 36, 48, 60, or 72 hours. Each time point was a separate experiment. In addition, the time-resolved studies of benzene-d₆ were conducted under similar process with (˜0.002 mmol La, 0.030 g), benzene-d₆ (1.0 mL), and HBpin (0.10 mL, 0.7 mmol) heated at 120° C. The experiments were then stopped (cooled) after 6, 12, 24, or 36 hours.

### Portion-Wise Addition of HBpin Experiments.

A small amount of HBpin (0.05 mL, 0.35 mmol) was introduced, in one portion, into the mixture of benzene (1.00 mL) and La(BH₄)₂(AlMe₃)-Ph₃Si—HY₃₀ (0.050 g, ˜0.003 mmol La). The HBpin conversion of ˜ 100% was reached when the above mixture was reacted at 120° C. for 24 hours. Then, a new portion of HBpin (0.05 mL) was added into reaction solution every 24 hours. In total 7 portions of HBpin were added to perform the catalysis.

### Substrates Scope

Borylation of toluene, anisole, pyridine, styrene, bromobenzene, and cyclohexane was conducted to investigate the substrate scope of catalyst La(BH₄)₂(AlMe₃)-Ph₃Si—HY₃₀. In general, 0.025 mg La(BH₄)₂(AlMe₃)-Ph₃Si—HY₃₀ was added into a solution of 0.50 mL substrates and 0.10 mL HBpin, and then the mixture was heated to a proper reaction temperature for a certain reaction time.

### Product Analysis

The yield of PhBpin in the above experiments was determined using calibrated GC-MS. An aliquot of the reaction solution (0.100 g) was withdrawn and mixed with 1,3,5-trimethoxybenzene (TMOB) in benzene (100 mM, 0.20 mL). This mixture was then diluted to 1.00 mL solution by adding benzene.

Quantification was achieved using external calibration with TMOB. A calibration curve for quantifying PhBpin was constructed by plotting the molar amount of PhBpin as a function of ratio of peak area between PhBpin and TMOB to obtain the response factor (RF). The amount of PhBpin obtained with the calibration curve, using the following equation:

$$Molar amount of PhBpin = \frac{Peak Area ( PhBpin )}{Peak Area ( TMB )} \times RF \times \frac{weight ( total reaction mixture )}{weight ( withdrawn reaction mixture )} \qquad ( Eq . 14 )$$

The conversion of HBpin was monitored with solution ¹H and ¹¹B NMR spectroscopy. Typically, 0.100 g reaction solution was added and mixed with 0.4 mL benzene-d₆ to measure NMR spectra. The recycle delay times for obtaining ¹H NMR and ¹¹B NMR spectra were 10 s and 2 s, respectively. Yield and selectivity of PhBpin were both with respect to HBpin. Specifically, the yield of PhBpin was estimated by dividing molar amount of PhBpin by molar amount of added HBpin. The selectivity of PhBpin was calculated by dividing yield of PhBpin by conversion of HBpin. The production of PhBpin was further confirmed using ¹¹B NMR spectroscopy by spiking the reaction solution with authentic PhBpin.

### Example 18—Density Functional Theory for NMR Simulation

Density functional theory (DFT) calculations of structures and NMR parameters were carried out for La complex supported on Faujasite using the Quantum Espresso package, version 7.1 (Giannozzi et al., “QUANTUM ESPRESSO: A Modular and Open-Source Software Project for Quantum Simulations of Materials,” Journal of Physics: Condensed Matter 21(39):395502 (2009); Giannozzi et al., “Advanced Capabilities for Materials Modelling with Quantum ESPRESSO,” Journal of Physics: Condensed Matter 29(46):465901 (2017); Giannozzi et al., “Quantum ESPRESSO Toward the Exascale,” The Journal of Chemical Physics 152(15): 154105 (2020), which are hereby incorporated by reference in their entirety). Models were first constructed in which La complex located near the Brønsted acid site of Faujasite, based on the results of SSNMR experiments. The crystal structure of Faujasite was taken from the report of Louwen et al., “Role of Rare Earth Ions in the Prevention of Dealumination of Zeolite Y for Fluid Cracking Catalysts,” The Journal of Physical Chemistry C 124(8):4626-4636 (2020), which is hereby incorporated by reference in its entirety. Then, the structural optimization was performed using the projector augmented wave (PAW) method (Blöchl, P. E., “Projector Augmented-Wave Method,” Phys. Rev. B 50(24):17953-17979 (1994), which is hereby incorporated by reference in its entirety) and Perdew, Bruke, and Ernserhof (PBE) (Perdew et al., “Atoms, Molecules, Solids, and Surfaces: Applications of the Generalized Gradient Approximation for Exchange and Correlation,” Phys. Rev. B 46(11):6671-6687 (1992), which is hereby incorporated by reference in its entirety) with ultrasoft pseudopotentials, SSSP PBE Precision v1.0 (Prandini et al. “Precision and Efficiency in Solid-State Pseudopotential Calculations,” Npj Computational Materials 4(1):72 (2018); http://materialscloud.org/sssp, which are hereby incorporated by reference in their entirety). During the structural optimization, none of the atomic positions were fixed. Finally, for the structure-refined models, the NMR shielding tensor and electric field gradient were computed using the gauge-including PAW (GIPAW) method (Pickard et al., “All-Electron Magnetic Response with Pseudopotentials: NMR Chemical Shifts,” Phys. Rev. B 63(24):245101 (2001), which is hereby incorporated by reference in its entirety) with the gipaw pseudopotentials developed by Ceresoli et al. (Tantardini et al., “GIPAW Pseudopotentials of d Elements for Solid-State NMR,” Materials 15(9):3347 (2022); https://github.com/dceresoli/qe-gipaw/tree/master/pseudo, which are hereby incorporated by reference in their entirety). For all calculations, a kinetic energy cutoff of 80 Ry and a 2×2×2 k-point grid (Monkhorst et al., “Special Points for Brillouin-Zone Integrations,” Phys. Rev. B 13(12):5188-5192 (1976), which is hereby incorporated by reference in its entirety) were used.

### Example 19—Results and Discussion of Examples 14-18

Modification of Supported Lanthanum Borohydrides Via Post-Treatment with AlMe₃

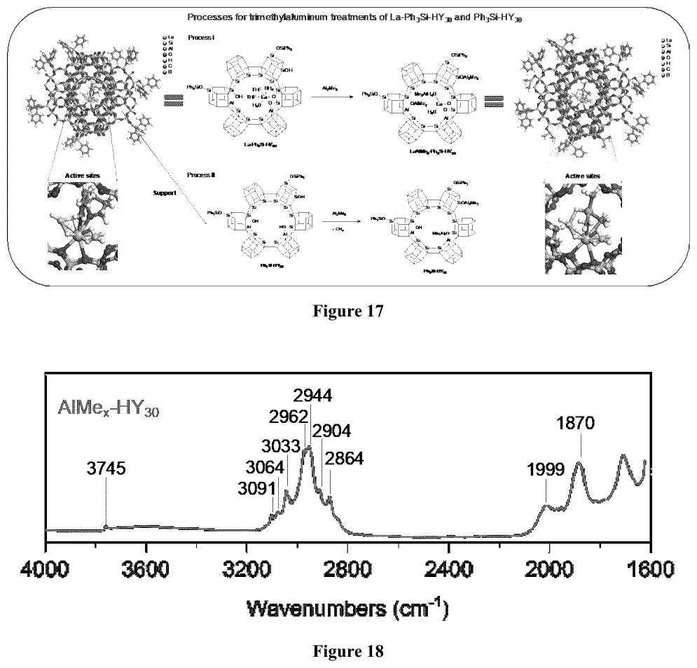

The precatalyst La-Ph₃Si—HY₃₀ contained 0.07+0.03 mmol La/g, as measured by inductively coupled plasma-optical emission spectroscopy (ICP-OES, Tables 14 and 15). A total of n-0.93 mmol OH/g was found in FAU zeolite (Si/Al=30) via OH titration measurement. These OH's are comprised of SiOH and approximately 0.3-0.4 mmol BAS/g, as reported in literature (Lakiss et al., “Probing the Brønsted Acidity of the External Surface of Faujasite-Type Zeolites,” ChemPhysChem 21(16):1873-1881 (2020); Almutairi et al., “Influence of Extraframework Aluminum on the Brønsted Acidity and Catalytic Reactivity of Faujasite Zeolite,” ChemCatChem 5(2):452-466 (2013), which are hereby incorporated by reference in their entirety). La(BH₄)₂(THF)₂-Ph₃Si—HY₃₀ reacted with excess AlMe₃ (2.5 mmol/g), giving the precatalyst La(BH₄)₂(AlMe₃)-Ph₃Si—HY₃₀ (FIG. 17). The same lanthanum loading (0.07+0.02 mmol La/g) was found (Tables 14 and 15), indicating that lanthanum does not leach from the zeolitic support upon reaction with AlMe₃.

TABLE 14
Catalytic Performance of Supported Lanthanum Borohydrides with AlMe₃ Treatment^{a}

| | La | | Conversion | | | Yield of |
|---|---|---|---|---|---|---|
| | loading | t | of HBpin | Yield of | Turnovers | MeBpin |
| Catalyst | (mmol/g) | (h) | (%) | PhBpin (%) | of PhBpin | (%) |
| La(BH₄)₂(THF)₂—Ph₃Si—HY₃₀ | 0.07 ± | 12 | 98 ± 2 | 7.6 ± 0.4 | 50 ± 6 | n.a.^{b} |
| | 0.03 | | | | | |
| La(BH₄)₂(AlMe₃)—Ph₃Si—HY₃₀ | 0.07 ± | 60 | 97 ± 3 | 21 ± 4 | 107 ± 6 | 5.9 ± 0.4 |
| | 0.02 | | | | | |
| La—HY₃₀ | 0.10 ± | 12 | 99 ± 1 | 1.8 ± 0.2 | 10 ± 1 | n.a.^{b} |
| | 0.02 | | | | | |
| AlMe₃—La—HY₃₀ | 0.10 ± | 60 | 98 ± 2 | 8.3 ± 0.3 | 36 ± 3 | 6.2 ± 0.3 |
| | 0.02 | | | | | |
| La—SO | 0.11 ± | 12 | ~0 | 0 | n.a.^{b} | n.a.^{b} |
| | 0.01 | | | | | |
| AlMe₃—La—SO | 0.11 ± | 60 | 96 ± 4 | 6.4 ± 0.4 | 26 ± 2 | 6.9 ± 0.3 |
| | 0.02 | | | | | |

^{a}reaction conditions: 0.025 g precatalysts, 0.50 mL benzene, 0.15 mL HBpin (~1.0 mmol) at 120° C.
^{b}not applicable

TABLE 15
Content of La, and Molar Ratio of Si/Al and B/La in Different Catalyst

| | | La | Molar ratio | Molar ratio | B |
|---|---|---|---|---|---|
| | Catalysts | (wt %) | of Si/Al | of B/La | (mmol/g) |
| 1 | La—HY₃₀ | 1.1 ± 0.3 | 30.2 ± 1.1 | 2.9 ± 0.4 | |
| 2 | La—Ph₃Si—HY ₃₀ | 0.8 ± 0.2 | 31.9 ± 1.7 | 3.1 ± 1.1 | |
| 3 | La—SO | 1.3 ± 0.3 | n.a.^{a} | | |
| 4 | AlMe₃—La—HY₃₀ | 1.1 ± 0.2 | 11.7 ± 1.9 | 1.7 ± 0.3 | |
| 5 | AlMe₃—La—Ph₃Si—HY₃₀ | 0.8 ± 0.2 | 12.2 ± 2.6 | 1.9 ± 0.4 | |
| 6 | AlMe₃—La—SO | 1.2 ± 0.3 | 21.9 ± 2.0 | 1.8 ± 0.2 | |
| 7 | BOₓH_{y}—HY₃₀ | n.a.^{a} | 29.2 ± 2.1 | n.a.^{a} | 0.35 |
| 8 | AlMe₃—BOₓH_{y}—HY₃₀ | n.a.^{a} | 10.1 ± 2.5 | n.a.^{a} | 0.04 |
| 9 | La(AlMe₄)ₓ—Ph₃Si—HY₃₀ | 0.9 ± 0.2 | 28.6 ± 1.9 | n.a.^{a} | |
| 10 | La(AlMe₄)ₓ—HY₃₀ | 1.2 ± 0.2 | 24.6 ± 2.5 | n.a.^{a} | |
| 11 | La(AlMe₄)ₓ—SO | 1.4 ± 0.3 | 41.1 ± 4.5 | n.a.^{a} | |

^{a}not applicable

Lanthanum borohydrides grafted on parent HY₃₀ before and after reacting with AlMe₃ (La—HY₃₀ and AlMe₃-La—HY₃₀) were also tested as precatalysts for benzene borylation (under the same conditions). Both the yield of PhBpin and turnovers from catalysis in the presence of AlMe₃-La—HY₃₀ increased approximately four times compared to those conducted in the presence of La—HY₃₀ (Table 14).

SiO₂ grafted lanthanum borohydrides La—SO was treated with AlMe₃, and the resulting material AlMe₃-La—SO was tested as a precatalyst for benzene borylation. About 6.4% yield of PhBpin was obtained from benzene borylation using AlMe₃-La—SO, corresponding to turnovers of 26 (Table 14). Although AlMe₃-La—SO was less active than La(BH₄)₂(AlMe₃)-Ph₃Si—HY₃₀ and AlMe₃-La—HY₃₀, treatment with AlMe₃ clearly resulted in activation of the material.

The underlying properties leading to improved PhBpin yield and selectivity observed after treating lanthanum-grafted catalysts with AlMe₃ were studied. AlMe₃ could potentially modify the zeolite support, alter the coordination chemistry of the lanthanum site, and/or increase the number of active sites. These changes could affect the rates of reactions because of productive benzene borylation or deleterious HBpin decomposition.

### Influence of AlMe₃ on Zeolite Support

The reaction of AlMe₃ and oxides, such as silica, gave multi-site products which contained Si—O—Al₂Me₅ and Si—O—AlMe₂ as a major surface species among a mixture of structures. A substitution of the BAS protons in FAU zeolite with Al species was reported by Pidko et al., “Chemical Vapor Deposition of Trimethylaluminum on Dealuminated Faujasite Zeolite,” ACS Catal. 3(7):1504-1517 (2013), which is hereby incorporated by reference in its entirety, through chemical vapor deposition (CVD) of trimethylaluminum process. Similar structures may be expected from the room-temperature reaction of BAS in zeolite and AlMe₃ (FIG. 17).

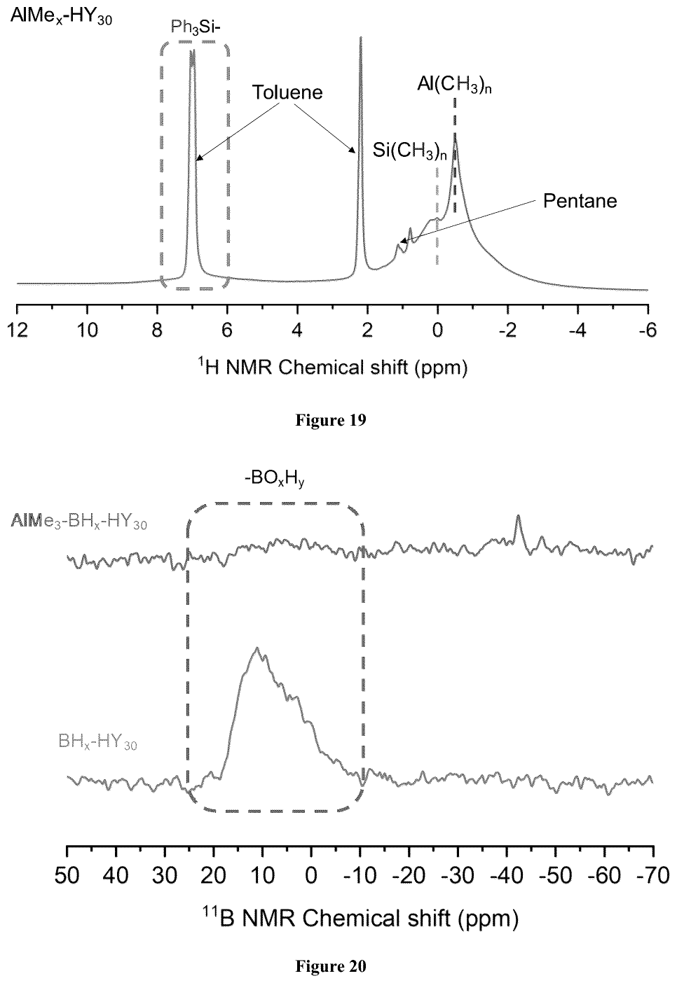

Reaction of zeolite HY₃₀ and AlMe₃ (2.5 mmol/g) provided the surface organoaluminum-supported material AlMeₓ-HY₃₀. In the diffuse reflectance infrared Fourier transform spectrum (DRIFTS) of AlMeₓ-HY₃₀ (FIG. 18), the one signal at 3743 cm⁻ and two signals at 3630, 3565 cm⁻¹ attributed to SiOH and BAS in HY₃₀, were at detection limits. The large peak at 2938 cm⁻¹ could be assigned to vC_{H} from AlMeₓ species. Likewise, the signal at ˜4.0 ppm in solid-state ¹H NMR spectrum of HY₃₀ assigned to BAS was not detected in the corresponding spectrum of AlMeₓ-HY₃₀ (FIG. 19), while peaks at ˜0.7 and ˜0.0 ppm were assigned to Al—(CH₃)ₙ and —SiO—(CH₃)ₙ, respectively, consistent with Pidko et al., “Chemical Vapor Deposition of Trimethylaluminum on Dealuminated Faujasite Zeolite,” ACS Catal. 3(7):1504-1517 (2013), which is hereby incorporated by reference in its entirety. Thus, AlMe₃ was found to react with both SiOH and BAS in HY₃₀.

HBpin, when heated at 120° C. with benzene in the presence of HY₃₀ or Ph₃Si—HY₃₀, was 100% catalytically consumed within 2 hours (Li et al., “Supported Lanthanum Borohydride Catalyzes CH Borylation Inside Zeolite Micropores,” Angewandte Chemie International Edition 61(15): e202117394 (2022), which is hereby incorporated by reference in its entirety). In contrast, HBpin reacted with silanols on SiO₂ to give Si—O-Bpin surface species (Wang et al., “Silica-Supported Organolanthanum Catalysts for C—O Bond Cleavage in Epoxides,” J. Am. Chem. Soc. 142(6):2935-2947 (2020), which is hereby incorporated by reference in its entirety), and the remaining HBpin was intact in solution after 24 hours. AlMe₃ treatment of HY₃₀ may affect these processes at silanol or BAS. AlMeₓ-HY₃₀ (0.025 g) was mixed with HBpin (0.15 mL, ˜1.0 mmol) in benzene (0.50 mL) and heated at 120° C. for 2 hours (Table 16). This reaction provided only ˜ 22% conversion of HBpin. This decrease in BAS-catalyzed HBpin degradation suggested that AlMe₃-HY₃₀ contained fewer accessible BAS than HY₃₀ as a result of AlMe₃ treatment.

TABLE 16
Control Experiments of HBpin Decomposition via Zeolitic Supports^{a}

| | | | | Yield of | Amount of |
|---|---|---|---|---|---|
| | Reaction | Conversion | Yield of | MeBpin | MeBpin |
| | time (h) | of HBpin (%) | PhBpin (%) | (%) | (mmol) |
| HY₃₀ | 2 | 100 | 0 | — | — |
| Ph₃Si—HY₃₀ | 2 | 100 | 0 | — | — |
| AlMe₃—HY₃₀ | 2 | 22 | 0 | 11 | 0.112 |
| AlMe₃—HY₃₀ | 12 | 100 | 0 | 18 | 0.184 |

^{a}Reaction conditions: 0.025 g catalysts, 0.50 mL benzene, 0.15 mL HBpin (~1.0 mmol), at 120° C.

Moreover, PhBpin was not detected in the reaction of AlMe₃-HY₃₀ and HBpin. Instead, MeBpin was formed in ˜11% yield (0.112 mmol) after 2 hours at 120° C. After heating for 12 hours, the maximum yield of MeBpin was obtained at ˜18% (0.184 mmol) when the conversion of HBpin was 100% (Table 16). MeBpin was also observed in benzene borylation catalyzed by AlMe₃-treated La catalysts, including La(BH₄)₂(AlMe₃)-Ph₃Si—HY₃₀, AlMe₃-La—HY₃₀, and AlMe₃-La—SiO₂, consuming approximately 5-8% of total HBpin (Table 14). Compared to AlMe₃-HY₃₀, lower yields of MeBpin could be related to less amount of active —CH₃ remained in supports with grafted La complexes.

Furthermore, molar ratios of B/La in three precatalysts La(BH₄)₂(THF)₂-Ph₃Si—HY₃₀, La—HY₃₀, and La—SO were reduced from −3:1 to ˜2:1, after reacting with AlMe₃ (Table 15). Two types of boron species were present, BH₄ complexing to La and —OBₓH_{y} formed from reactions of side product B₂H₆ upon grafting with surface OH. The detachment of latter boron species through the addition of AlMe₃ was further confirmed via organoboron-supported material BHₓ—HY₃₀ that was prepared by reacting borane-tetrahydrofuran complex (BH₃-THF) and HY₃₀ to form the —OBₓH_{y} or —BOₓH_{y} on the zeolite support. The observation of a broad signal at ˜+10 ppm in ¹¹B NMR spectrum of BHₓ—HY₃₀ supported the formation of boron oxygen species. After adding AlMe₃, this broad signal disappeared in the spectrum of AlMe₃-BHₓ—HY₃₀ (FIG. 20). Correspondingly, boron molar loading has decreased from 0.35 mmol/g in BHₓ—HY₃₀ to 0.04 mmol/g in AlMe₃-BHₓ—HY₃₀ (Table 15). This difference suggested that AlMe₃ could replace the BₓH_{y} species attached to HY₃₀ surface.

### Possible Structure of Lanthanum Precatalyst

In addition to the interaction with protic species in the zeolite, AlMe₃ may also react with grafted lanthanum borohydride sites, forming species such as La(AlMe₄)ₓ, La(AlHₙMe₄₋ₙ)ₓ, or La(BHₙMe₄₋ₙ)ₓ that could possibly be precursors to catalytically active species.

To investigate the possibility that lanthanum methylaluminate sites could be used as precatalysts for CH borylation, La(AlMe₄)₃ (prepared as described in Zimmermann et al., “Homoleptic Rare-Earth Metal(III) Tetramethylaluminates: Structural Chemistry, Reactivity, and Performance in Isoprene Polymerization,” Chemistry—A European Journal 13(31):8784-8800 (2007), which is hereby incorporated by reference in its entirety) was reacted with Ph₃Si—HY₃₀, HY₃₀, and SiO₂ to give La(AlMe₄)ₓ-Ph₃Si—HY₃₀ (0.07 mmol La/g), La(AlMe₄)ₓ—HY₃₀ (0.09 mmol La/g), and La(AlMe₄)ₓ—SO (0.11 mmol La/g). Benzene borylation using these precatalysts formed PhBpin with turnover of 21, 18, and 10, respectively, when conversion of HBpin achieved higher than 70% within 24 hours (Table 17). Moreover, La(AlMe₄)₃ homogeneously catalyzed benzene borylation to form about 2.5% PhBpin in terms of 2.1 turnovers at 120° C. for 24 hours. On the other hand, MeBpin was also formed from the reaction of HBpin and methyl in La(AlMe₄)₃, La(AlMe₄)ₓ-Ph₃Si—HY₃₀, La(AlMe₄)ₓ—HY₃₀, and La(AlMe₄)ₓ—SO, reaching yields of 4.2%, 3.6%, and 3.2%, respectively.

TABLE 17
Benzene Borylation With Precatalyst La(AlMe₄)₃, La(AlMe₄)ₓ—
Ph₃Si—HY₃₀, La(AlMe₄)ₓ—HY₃₀, and La(AlMe₄)ₓ—SO

| | Added | | | | | | |
|---|---|---|---|---|---|---|---|
| | amount | La | HBpin | PhBpin | PhBpin | | MeBpin |
| | of La | loading | Conversion | Yield | Selectivity | | Yield |
| Precatalysts | (mmol) | (mmol/g) | (%) | (%) | (%) | Turnovers | (%) |
| La(AlMe₄)₃ | 0.015^{b} | n.a. | 61 ± 4 | 2.4 ± 0.3 | 3.9 ± 0.4 | 2.1 ± 0.4 | 16 ± 3 |
| La(AlMe₄)ₓ—Ph₃Si—HY₃₀ | 0.002 | 0.07 | 89 ± 3 | 4.2 ± 0.5 | 4.7 ± 0.5 | 21 ± 2 | 3.6 ± 0.8 |
| La(AlMe₄)ₓ—HY₃₀ | 0.002 | 0.09 | 69 ± 5 | 3.6 ± 0.3 | 5.2 ± 0.4 | 18 ± 1 | 5.5 ± 0.5 |
| La(AlMe₄)ₓ—hSO | 0.003 | 0.11 | 77 ± 4 | 3.2 ± 0.4 | 4.1 ± 0.3 | 10 ± 2 | 6.7 ± 1.1 |

^{a}reaction condition: 0.025 g of precatalysts, 0.5 mL benzene, 0.15 mL HBpin (~1.0 mmol) at 120° C. for 24 hours
^{b}0.006 g La(AlMe₄)₃ was used for benzene reaction.

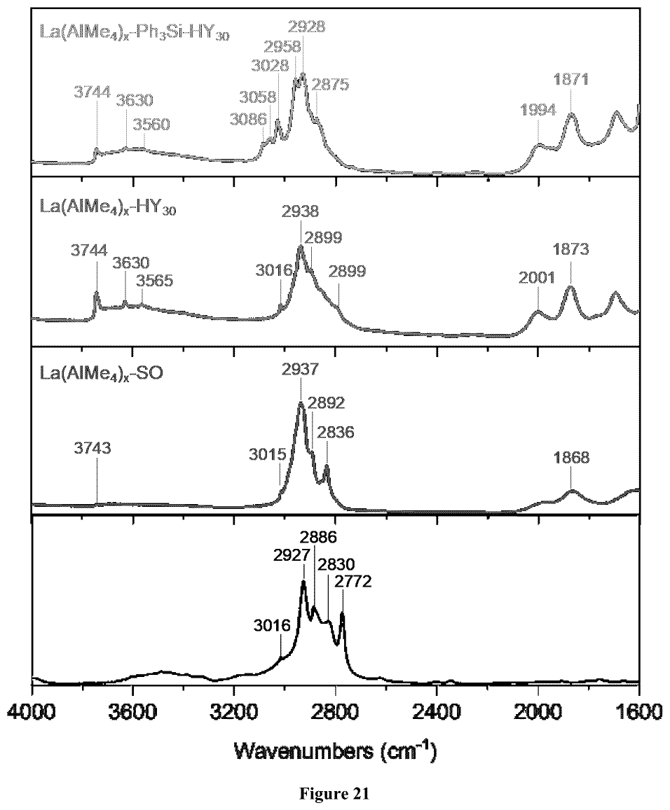

Grafting of La(AlMe₄)₃ on three supports was indicated by DRIFTS analysis. Signals (3016, 2927, 2886, 2830, and 2772 cm⁻¹) associated to C—H stretches of La(AlMe₄)₃ existed in all spectra of La(AlMe₄)ₓ-Ph₃Si—HY₃₀, La(AlMe₄)ₓ—HY₃₀, and La(AlMe₄)ₓ—SO (FIG. 21). BAS signals (˜3630 and ˜3560 cm⁻¹) were also observed clearly in Ph₃Si—HY₃₀ and HY₃₀ grafted materials. Such observation suggested that BAS inside zeolite micropores were not effectively reacting with La(AlMe₄)₃ due to the relatively larger size of La(AlMe₄)₃ (˜9.2×9.2×7.8 Å) than micropore aperture of HY₃₀. The lower yields of PhBpin from La(AlMe₄)ₓ-Ph₃Si—HY₃₀ and La(AlMe₄)ₓ—HY₃₀ can result from less amount of formed active lanthanum species compared with La(BH₄)₂(AlMe₃)-Ph₃Si—HY₃₀.

Zeolite-grafted La(AlMe₄)₃ has shown to be active to C—H borylation, and thus the related lanthanum species could be formed when AlMe₃ reacted with lanthanum borohydrides grafted on zeolitic supports by changing La coordination. Therefore, multiple characterization approaches and computing studies were applied to investigate the structure and coordination environment of La species in AlMe₃-treated supported lanthanum organometallics. La(BH₄)₂(THF)₂-Ph₃Si—HY₃₀ and La(BH₄)₂(AlMe₃)-Ph₃Si—HY₃₀ were studied.

### Identification of Active Species in the Ideal Supported Lanthanum Organometallics

### DRIFTS

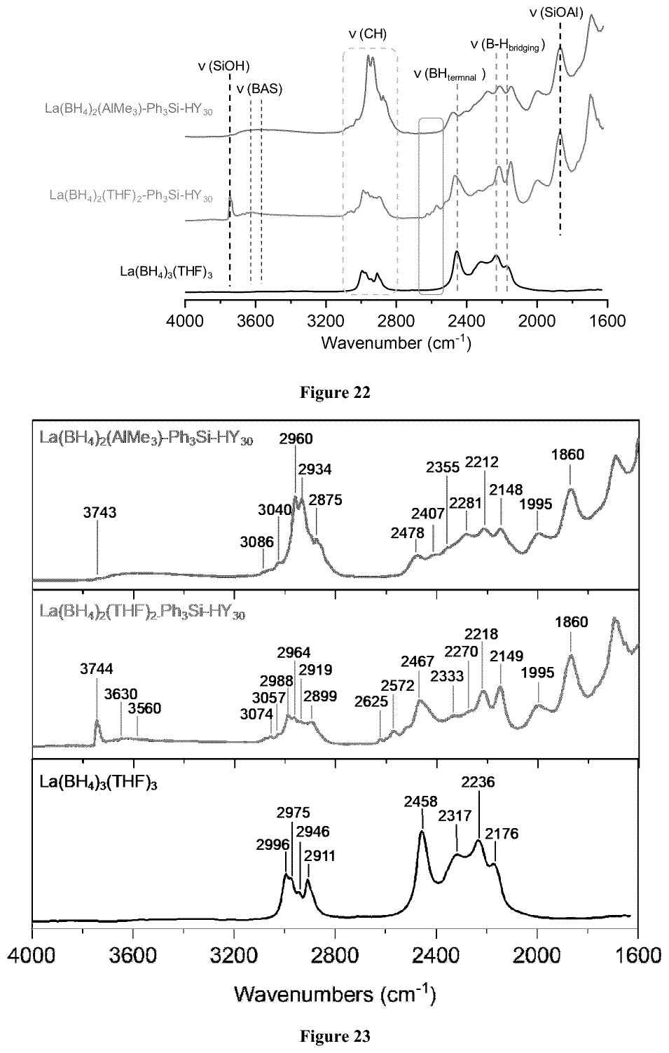

As an initial reference point, the IR spectrum of La(BH₄)₃(THF)₃ contained four bands assigned to ν_{CH} of coordinated THF at 2996, 2975, 2946, and 2911 cm⁻¹ (FIGS. 22 and 23). These signals were less intense than the four ν_{BH} signals at 2458 (terminal: A₁), 2317 (combination), 2236, and 2176 cm⁻¹ (bridging: A₁, E), which indicated 3-BH₄ coordination to lanthanum (Marks et al., “Covalent Transition Metal, Lanthanide, and Actinide Tetrahydroborate Complexes,” Chemical Reviews 77(2):263-293 (1977), which is hereby incorporated by reference in its entirety). The spectrum of La(BH₄)₂(THF)₂-Ph₃Si—HY₃₀ contained four ν_{BH} peaks at similar positions (2467, 2333, 2248, and 2149 cm⁻¹) indicating that the La(3-BH₄) motif remained after grafting. Specifically, compared to the spectrum of La(BH₄)₃(THF)₃, the intensity of bridging bands A₁ and E bands increased relative to the combination band, but the ratio between the intensity of the terminal signal to that of bridging signals was relatively similar. A combination band at 2270 cm⁻¹ was observed, as well as two signals at 2625 and 2572 cm⁻¹ assigned to O—BₓH_{y} species produced from the interaction between surface silanols and BAS with BH₃ (or B₂H₆) that generated during Ph₃Si—HY₃₀ grafting La(BH₄)₃(THF)₃.

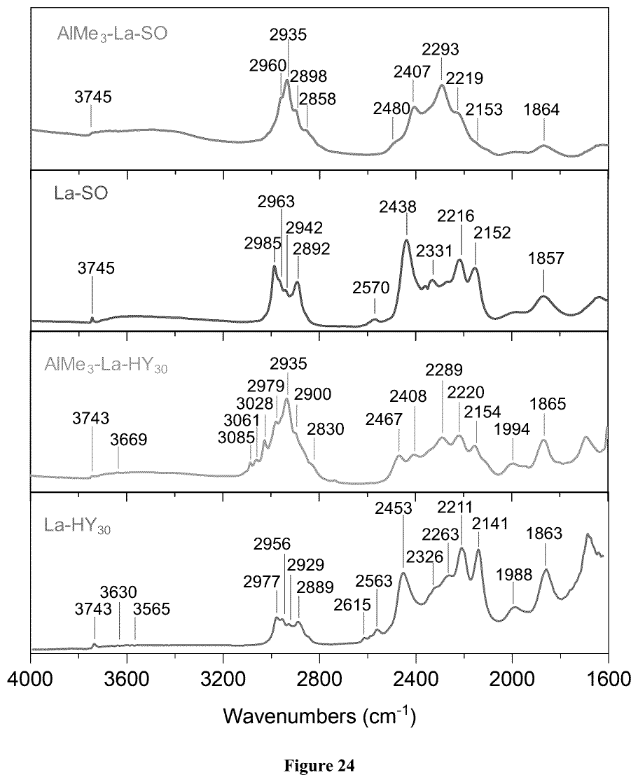

Moreover, DRIFTS spectra of La—HY₃₀ and La—SO, obtained from grafting La(BH₄)₃(THF)₃ onto parent HY₃₀ and silica, contained similar features (FIG. 24). Specifically, after grafting on HY₃₀, four ν_{CH} signals (2977, 2956, 2929, and 2889 cm⁻¹), five ν_{BH} signals (2453, 2326, 2263, 2211, and 2141 cm⁻¹), and two —O—BₓH_{y} signals (2615 and 2563 cm⁻¹) were still observed in La—HY₃₀ spectrum. In La—SO spectrum signals of combination band and —Si—O—BₓH_{y} species were observed at 2331 and 2570 cm⁻¹. Compared to La(BH₄)₂(THF)₂-Ph₃Si—HY₃₀, the terminal ν_{BH} appeared at lower energy (2438 cm⁻¹) while the bridging ν_{BH} signals were at higher energy (2216 and 2152 cm⁻¹). The terminal ν_{BH} of La(BH₄)₂(THF)₂-Ph₃Si—HY₃₀ was broader, with some intensity at the frequency where La—SO adsorbs. The apex of the terminal ν_{BH} in La-Ph₃Si—HY₃₀, however, was at higher energy. This higher energy region of the peak was tentatively assigned to the BAS-grafted La(BH₄)₂ in Ph₃Si—HY₃₀.

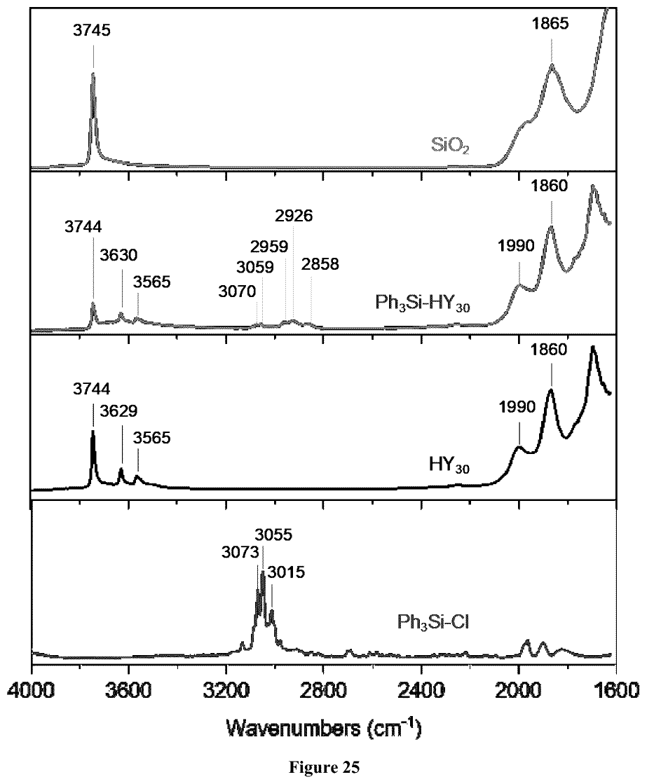

Interestingly, the vC_{H} bands in La(BH₄)₂(THF)₂-Ph₃Si—HY₃₀ were less intense than the ν_{BH} bands, even with Ph₃Si groups (peaks at 3093, 3076, 2959, 2926, 2858 cm⁻¹ shown in FIG. 25) in the sample. The signals assigned to THF coordinated to lanthanum were also clearly evident. Significantly, the band at 3743 cm⁻¹ assigned to ν_{SIOH} was observed in La(BH₄)₂(THF)₂-Ph₃Si—HY₃₀, indicating that the isolated silanols were present on the zeolite after grafting of the lanthanum borohydride. Additionally, two tiny signals at 3630 and 3565 cm⁻¹ associated to BAS suggested that potentially a certain amount of BAS remained in Ph₃Si—HY₃₀ after grafting with La(BH₄)₃(THF)₃. On another hand, the peak associated to SiOH decreased dramatically in spectra of both La—HY₃₀ and La—SO, suggesting quite more —Si—O—La(BH₄)₂(THF)₂ generated in these two samples.

The DRIFTS of La(BH₄)₂(AlMe₃)-Ph₃Si—HY₃₀ showed several interesting features. First, the terminal ν_{BH} peak at 2478 cm⁻¹ appeared at higher energy by >11 cm⁻¹ than in the molecular and grafted precursor. In addition, the intensity of this band was half that of the ν_{BH}-bridging at 2212 and 2148 cm⁻¹. The intensity of the combination band at 2281 cm⁻¹ also increased relative to the terminal ν_{BH}, and two new signals at 2410 and 2358 cm⁻¹ were also observed. The spectrum indicated that La(3-BH₄) moieties were present after AlMe₃ treatment; however, Ln(μ³—H₃BMe)₃(THF)ₓ contained bands at 2180-2190 cm⁻¹, and lacked a signal around 2500 cm⁻¹ (Shinomoto et al., “Preparation of Some Lewis Base Adducts of Tris(methyltrihydroborato) Ho and Yb and Crystal Structures of Tris(methyltrihydroborato) Ytterbium(III)Etherate and Tris(methyltrihydroborato) Holmium(III)Bis(Pyridine),” Inorganica ChimicaActa 139(1):97-101 (1987), which is hereby incorporated by reference in its entirety). The reduced intensity of the terminal ν_{BH} peak relative to bridging signals could have resulted from the exchange of BH for BMe upon reaction with AlMe₃. However, the NMR data did not provide support for the formation of H₃BMe surface species.

Second, the ν_{OH} bands assigned to isolated SiOH and BAS were barely detected in La(BH₄)₂(AlMe₃)-Ph₃Si—HY₃₀ (FIG. 22). Similarly, peaks of SiOH and BAS were almost disappeared in spectra of AlMe₃-La—HY₃₀ and AlMe₃-La—SO (FIG. 24). Such observations were also consistent to finding from DRIFTS of AlMeₓ-HY₃₀ that formed from reaction of HY₃₀ with AlMe₃ (FIG. 18).

Finally, the ν_{BH} signals at 2625 and 2521 cm⁻¹ assigned to BOₓH_{y} in La(BH₄)₂(THF)₂-Ph₃Si—HY₃₀ (FIG. 22), La—HY₃₀ and La—SO (FIG. 24) were not detected in the DRIFTS analysis of materials with AlMe₃ treatment, La(BH₄)₂(AlMe₃)-Ph₃Si—HY₃₀, AlMe₃-La—HY₃₀, and AlMe₃-La—SO. Such change agreed with the observation from BHₓ—HY₃₀ and AlMe₃-BHₓ—HY₃₀ and also corroborated that AlMe₃ would interact with SiOH and/or BAS in oxide support.

### ¹¹B NMR

¹¹B SSNMR was useful in establishment of a lower limit for the number of boron-containing species on the material, the symmetry (i.e., coordination number of the boron center), and structure. Deshielded signals (commonly 10-80 ppm) were associated with three-coordinate borane, while shielded signals were assigned to four-coordinate species with shielding increasing with charged species (Wrackmeyer, B., “Nuclear Magnetic Resonance Spectroscopy of Boron Compounds Containing Two-, Three- and Four-Coordinate Boron,” In Annual Reports on NMR Spectroscopy, Webb, G. A. Ed.; Vol. 20; Academic Press, pp 61-203 (1988), which is hereby incorporated by reference in its entirety).

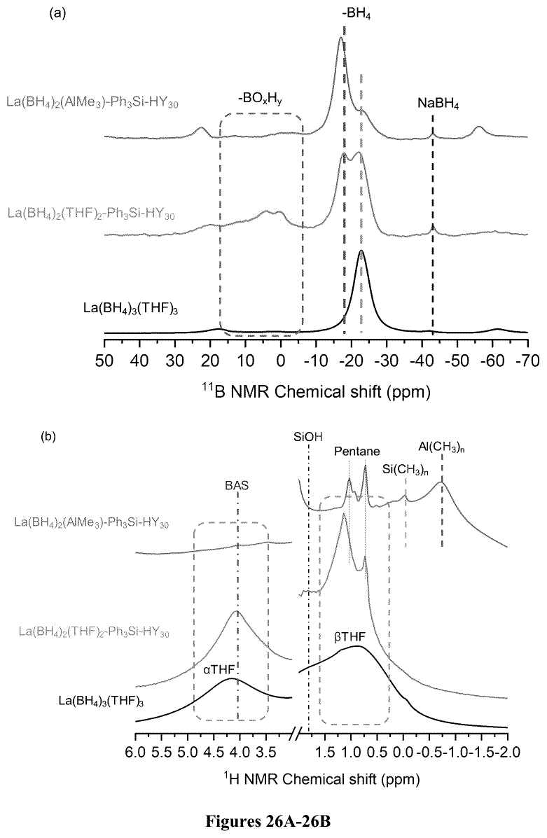

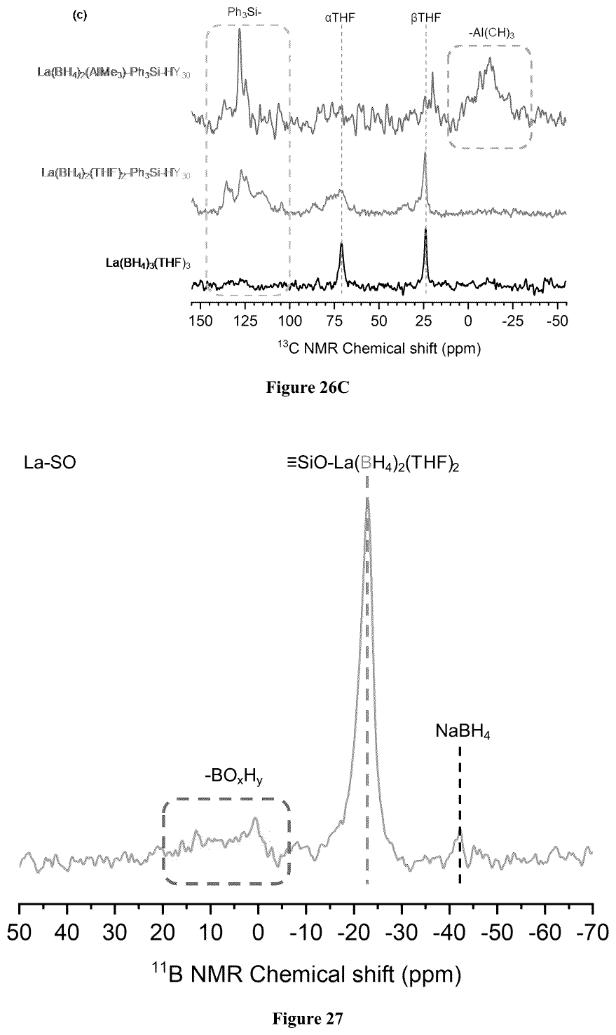

The ¹¹B NMR signal of La(BH₄)₃(THF)₃ precursor was overserved at −22.9 ppm in FIG. 26A. And ¹¹B NMR spectrum of La(BH₄)₂(THF)₂-Ph₃Si—HY₃₀ showed three important signals at −22.0, −17.0, and +3.2 ppm, assigned to the single-site species ≡Si—O—La(BH₄)₂(THF)₂, ≡Si(≡Al)—O—La(BH₄)₂(THF)₂, and —O—BₓH_{y} or —BOₓH_{y} species, respectively (Li et al., “Supported Lanthanum Borohydride Catalyzes CH Borylation Inside Zeolite Micropores,” Angewandte Chemie International Edition 61(15): e202117394 (2022), which is hereby incorporated by reference in its entirety). The first signal was assigned, referencing La(BH₄)₃(THF)₃ grafted onto silica material La—SO (23.0 ppm, FIG. 27); the assignment of —OBₓH_{y} species was supported from the observation of the as-mentioned BHₓ—HY₃₀ (FIG. 20). These assignments were also consistent to signals of ≡SiO—La(BH₄)₂(THF)_{2.2} (at −23.2 ppm) and —SiO—BₙH₂ₙ₊₁ (at +1.2 ppm), reported in Ajellal et al., “Polymerization of Racemic β-Butyrolactone Using Supported Catalysts: A Simple Access To Isotactic Polymers,” Chemical Communications 46(7):1032-1034 (2010), which is hereby incorporated by reference in its entirety.

The ¹¹B SSNMR spectrum of La(BH₄)₂(AlMe₃)-Ph₃Si—HY₃₀ revealed a very strong signal at −16.9 ppm and a small shoulder signal at −23.2 ppm. Notably, the broad signal centered at +3.2 ppm (O—BₓH_{y}) in La(BH₄)₂(THF)₂-Ph₃Si—HY₃₀ was not found in La(BH₄)₂(AlMe₃)-Ph₃Si—HY₃₀ (FIG. 26A). As noted above, the loadings of La on the zeolite were equivalent before and after AlMe₃ treatment, while the molar ratio of B/La decreased. The reduction of boron content could have resulted from the removal of O—BₓH_{y} species and/or change of BH₃ ligand surrounding La metal sites.

The appearance of a strong ¹¹B NMR single at −16.9 ppm was important because the La—SO spectrum contained borate signals only associated with —Si—O—La(BH₄)₂(THF)₂ and did not form active sites for CH borylation, while the ¹¹B NMR spectrum of La(BH₄)₂(THF)₂-Ph₃Si—HY₃₀ also contained an additional signal at −17.0 ppm and the material was active in benzene borylation. Thus, the higher yield and higher turnovers in benzene borylation in La(BH₄)₂(AlMe₃)-Ph₃Si—HY₃₀ may be at least partly attributed to the presence of the −17.0 ppm strong signal.

Apparently, the overall peak area of —BH₄ signals in the catalysts before and after AlMe₃ treatment were nearly identical, suggesting that species associated with −23.2 ppm signal were converted into species that appear at −16.9 ppm. This was because the reaction of AlMe₃ aluminates the —Si—O—La(BH₄)₂(THF)₂ sites into ≡Si(≡Al)—O—La(BH₄)₂(THF)₂, or other chemical changes to the coordination environment of La site occur to perturb the ¹¹B NMR shift.

¹H and ¹³C SSNMR

Two wide signals at 4.3 ppm and 0.8 ppm in the ¹H SSNMR spectrum of La(BH₄)₃(THF)₃ (FIGS. 26B and 39) were associated to α-H and β-H in THF and the broad signal around 1.7 ppm was assigned to BH₄. In the ¹³C SSNMR spectrum of La(BH₄)₃(THF)₃ (FIG. 26C), two signals of THF for α- and β-carbons were observed at 70.9 and 23.7 ppm.

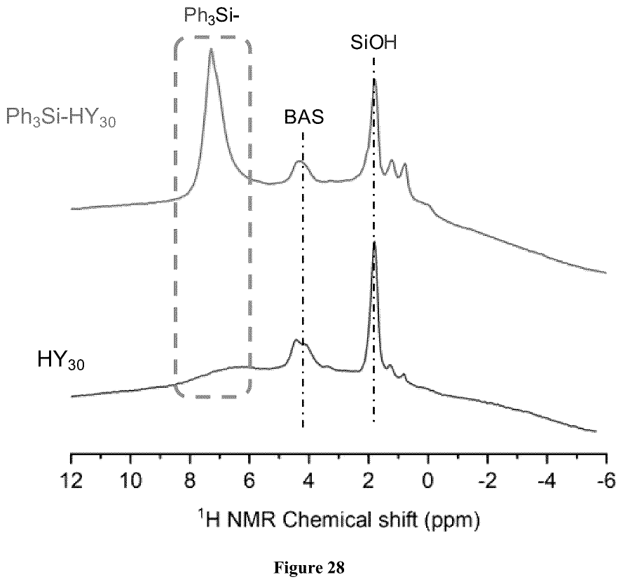

These signals of THF and BH₄ were still observed from the ¹H SSNMR spectrum of La-Ph₃Si—HY₃₀ after grafting on Ph₃Si—HY₃₀ (FIG. 26B), suggesting the presence of THF and BH₃ in La species grafted on Ph₃Si—HY₃₀. A shoulder peak at ˜1.9 ppm was consistent with the signal of SiOH in Ph₃Si—HY₃₀ and the peak around 7.1 ppm was the signal of phenyl group of Ph₃Si— (FIG. 28). The BAS signal at ˜4.0 ppm was still observed in ¹H SSNMR spectrum of La(BH₄)₂(THF)₂-Ph₃Si—HY₃₀, although it overlapped with THF signals. Likewise, ¹³C SSNMR of La(BH₄)₂(THF)₂-Ph₃Si—HY₃₀ contained THF signals at ˜25 and ˜70 ppm and Ph₃Si— signals around 125 ppm (FIG. 26C).

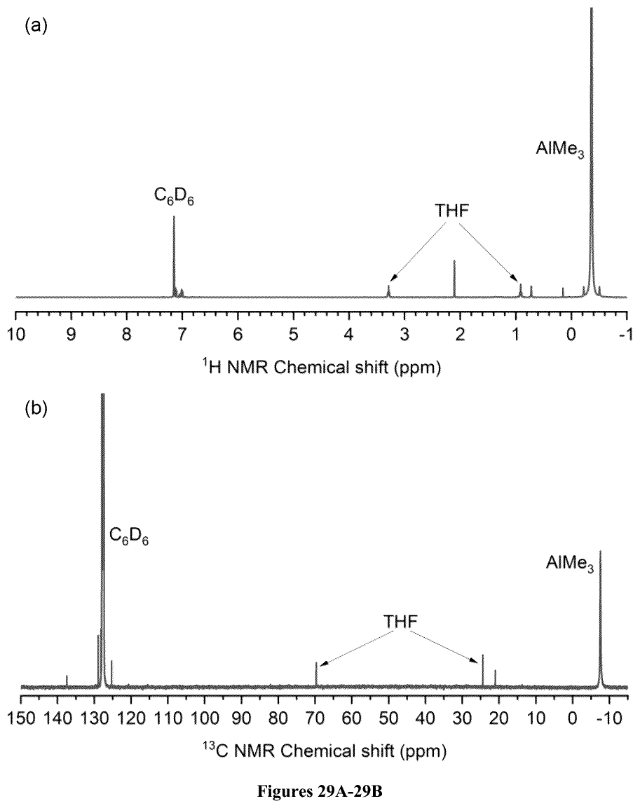

The BAS signal was barely detected in the ¹H SS NMR spectrum of La(BH₄)₂(AlMe₃)-Ph₃Si—HY₃₀ (FIG. 26B). The disappearance of BAS signal (˜4.0 ppm) also supported the conclusion that AlMe₃ will react with residual BAS in zeolite after grafting lanthanum borohydrides, which was consistent with the observation from AlMeₓ-HY₃₀ (FIG. 19). More interestingly, ¹H and ¹³C NMR signals associated to THF were barely observed in the spectra of La(BH₄)₂(AlMe₃)-Ph₃Si—HY₃₀ (FIG. 26C), suggesting the loss of THF upon the addition of AlMe₃. The dissolved THF from La was further supported by THF signals that appeared in the solution mixing La(BH₄)₂(THF)₂-Ph₃Si—HY₃₀ and AlMe₃ measured via solution ¹H and ¹³C NMR measurements (FIGS. 29A-29B).

### Computational Studies

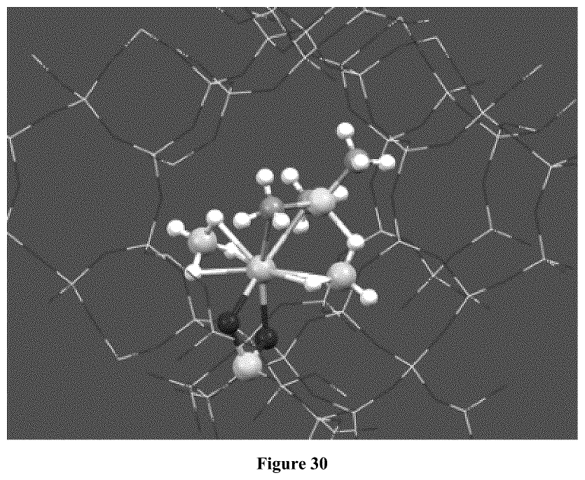

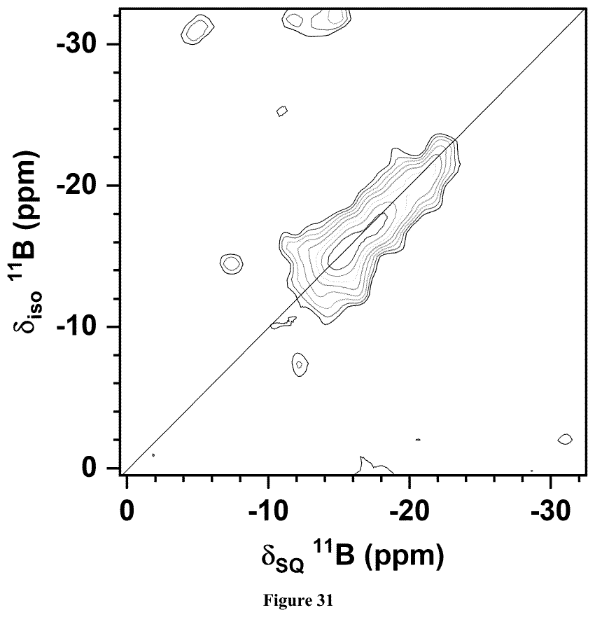

The coordination geometry of La(BH₄)₂(AlMe₃)-Ph₃Si—HY₃₀ was further studied through the application of theoretical calculations to the model created based on findings from DRIFT, and SSNMR. The proposed model (FIG. 30) revealed La—O, La—C, La—B, and La—Al (in AlMe₃) distances of 2.5 Å, 2.9 Å, 2.9 Å, and 3.2 Å, respectively. Computation of ¹¹B NMR parameters for this model yielded an isotropic shift −17 ppm, which closely aligned with the experimentally observed value. Given that 11B is a quadrupole nucleus, its resonance frequency is influenced by the quadrupolar coupling in addition to the chemical shift. Indeed, the NMR computations showed that ¹¹B in the model has a quadrupolar coupling constant of ˜1.1 MHz. The ¹¹B signal in the ¹¹B triple-quantum magic-angle spinning (3QMAS) spectrum appeared along the diagonal (FIG. 31), however, suggesting that the quadrupolar interactions are motionally averaged out and its influence on the resonance frequency is negligible.

Overall, upon the integral of experimental studies, characterization investigations, and DFT simulations, roles of AlMe₃ on promotion of supported lanthanum organometallic catalysts were explored: (1) reduce residual BAS leading to less HBpin degradation; (2) activate SiOH and silanol grafted lanthanum species (≡SiO—La(BH₄)ₓ) in both zeolite and silica supports; and (3) modify the BAS grafted lanthanum species ≡Si(≡Al)—O—La(BH₄)₂(THF)₂ to generated a more active catalytic sites —Si(—Al)—O—La(BH₄)₂(AlMe₃).

### Catalytic Mechanism

Catalytic sites ≡Si(≡Al)—O—La(BH₄)₂(AlMe₃) were formed in precatalyst La(BH₄)₂(AlMe₃)-Ph₃Si—HY₃₀ through the reaction of La(BH₄)₂(THF)₂-Ph₃Si—HY₃₀ and AlMe₃. In order to further improve catalytic performance and understand the reaction mechanism, HBpin concentration and catalyst amount were adjusted to obtain higher selectivity of PhBpin production.

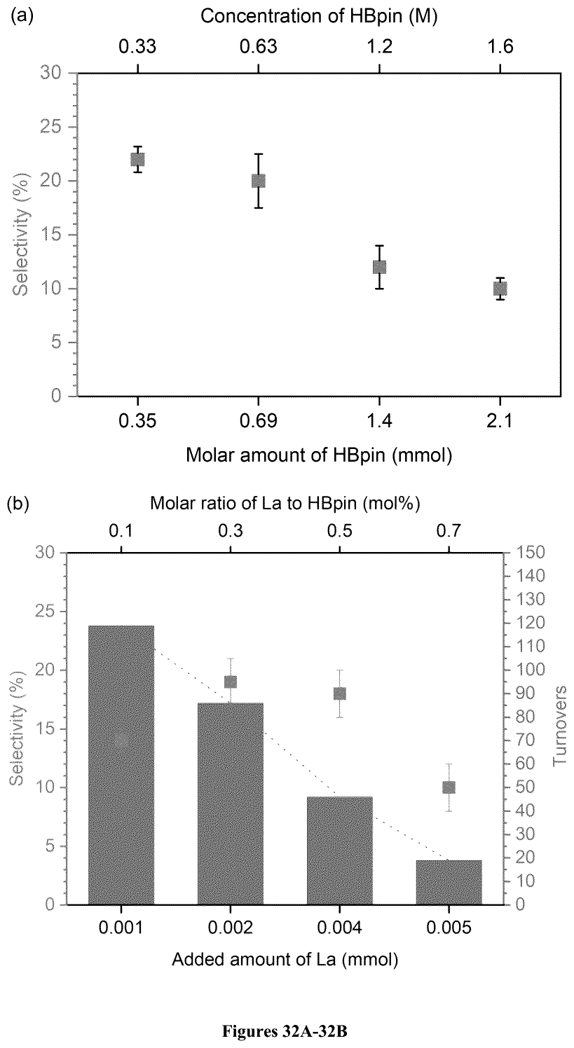

Specifically, 0.05, 0.10, 0.20, or 0.30 mL of HBpin (0.35, 0.70, 1.4, and 2.1 mmol) was mixed with benzene (1.00 mL) and precatalyst (0.025 g). At 120° C., reaction time was varied from 36 hours to 48 hours to achieve >70% conversion of HBpin. The selectivity of PhBpin increased from 9.5% to 23% when the molar amount of HBpin added was reduced from 2.1 mol to 0.35 mol (FIG. 32A). The increase of PhBpin selectivity was potentially related to the slowdown of HBpin decomposition which is concentration-dependent (Li et al., “Supported Lanthanum Borohydride Catalyzes CH Borylation Inside Zeolite Micropores,” Angewandte Chemie International Edition 61(15): e202117394 (2022), which is hereby incorporated by reference in its entirety).

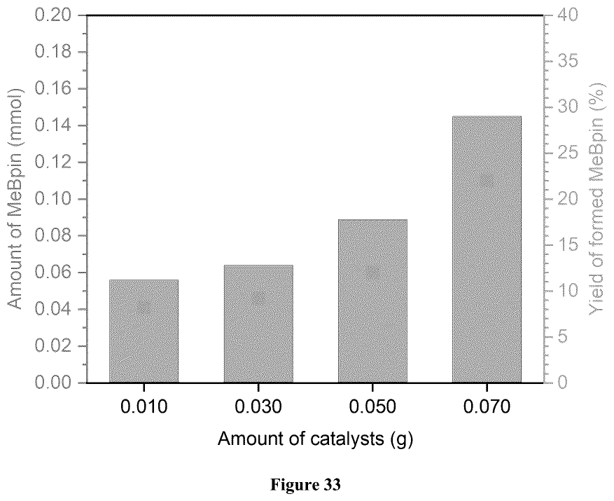

In addition, selectivity of PhBpin can be also be affected by varying the amount of precatalyst. Same concentration of HBpin in benzene (0.70 mmol HBpin in 1.00 mL benzene) was mixed with varied amounts of catalysts (0.010, 0.030, 0.050, and 0.070 g) (FIG. 32B). Borylation of benzene was conducted at 120° C. for different time (36-72 hours) resulting in close to 70-82% conversion of HBpin. In particular, ˜20% selectivity of PhBpin was obtained by using either 0.030 or 0.050 g precatalyst, referring to turnovers of 86 and 41, respectively. Higher turnovers of ˜120 were obtained from the reaction with 0.010 g precatalyst, while the selectivity slightly decreased to 15%, likely relevant to increased HBpin decomposition in longer reaction time (>72 hours). In contrast, lowest turnovers (˜21) and selectivity of PhBpin (˜11%) obtained by using 0.070 g precatalyst in the reaction. A larger amount of MeBpin (˜30% of HBpin consumption) as the side product was obtained with 0.070 g precatalyst (FIG. 33), and total HBpin decomposition increased as catalyzed by higher La to HBpin ratio, 0.7 mol % of La into HBpin.

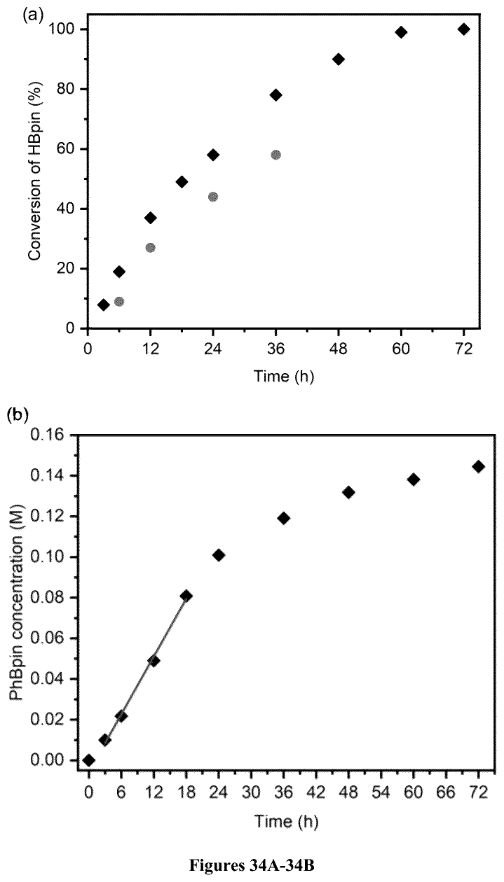

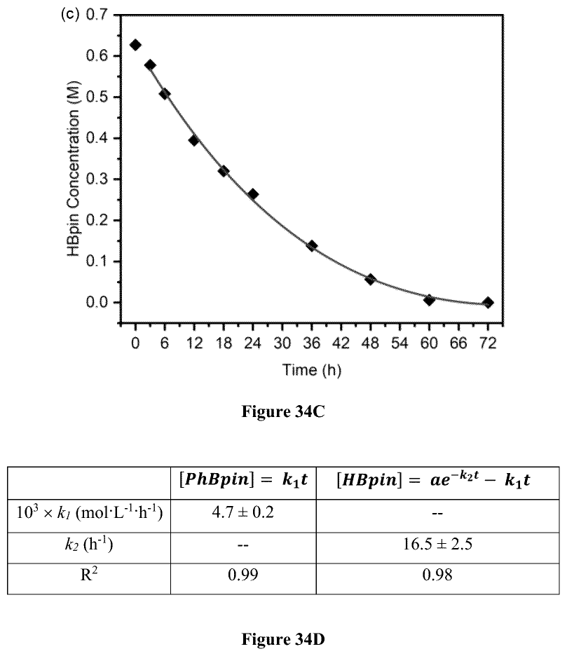

A kinetic study of catalytic borylation via La(BH₄)₂(AlMe₃)-Ph₃Si—HY₃₀ was examined through time studies for both benzene and benzene-d₆. Experiments were conducted under the ideal reaction condition of 0.030 g of catalysts, 1.00 mL benzene or benzene-d₆, and 0.10 mL HBpin at 120° C. Conversions of HBpin in benzene and benzene-d₆ were less than 50% when the reaction time was shorter than 18 hours and 36 hours (FIG. 34A). In this region, turnovers presented a linear increase as a function of time, so zero-order rate constants of benzene and benzene-d₆ borylation were calculated from slopes of two trendlines. A kinetic isotope effect (k_{H}/k_{D}=4.2) was obtained, which is in the range of metalations of hybridized sp² C—H bond via 6-bond metathesis steps (Gangwar et al., “Surface Organometallic Chemistry on Zeolites: Synthesis of Group IV Metal Alkyls and Metal Hydrides on Hierarchical Mesoporous H-ZSM-5,” Chem. Mat. 34(19):8777-8789 (2022), which is hereby incorporated by reference in its entirety). Additionally, rates of PhBpin production and HBpin consumption were calculated based on curves of [PhBpin] vs t and [HBpin] vs t, respectively (FIGS. 34B and 34C). The PhBpin formation rate for La(BH₄)₂(AlMe₃)-Ph₃Si—HY₃₀ is ˜4.7 mM/h (Eq. 15) was about 2 times higher than that for La(BH₄)₂(THF)₂-Ph₃Si—HY₃₀ under equivalent reaction conditions, showing the increased catalyst activity with the new active site. Rate of HBpin conversion was obtained as ˜10.3 mM/h on the basis of pseudo-first-order (Eq. 16). Thus, HBpin decomposition rate for La(BH₄)₂(AlMe₃)-Ph₃Si—HY₃₀ was calculated as 5.6 mM/h (Eq. 17), which was ˜40 times slower than that for La(BH₄)₂(THF)₂-Ph₃Si—HY₃₀ (0.24M/h) (Li et al., “Supported Lanthanum Borohydride Catalyzes CH Borylation Inside Zeolite Micropores,” Angewandte Chemie International Edition 61(15): e202117394 (2022), which is hereby incorporated by reference in its entirety)

$${r}_{PhBpin formation} = {k}_{PhBin formation} \times {[ HBpin ]}^{0} = {k}_{PhBin formation} \qquad ( Eq . 15 )$$

$${r}_{HBpin conversion} = {k}_{HBPin conversion} \times {[ HBpin ]}^{1} \qquad ( Eq . 16 )$$

$${r}_{HBpin decompostion} = {r}_{HBpin conversion} - {r}_{PhBpin formation} \qquad ( Eq . 17 )$$

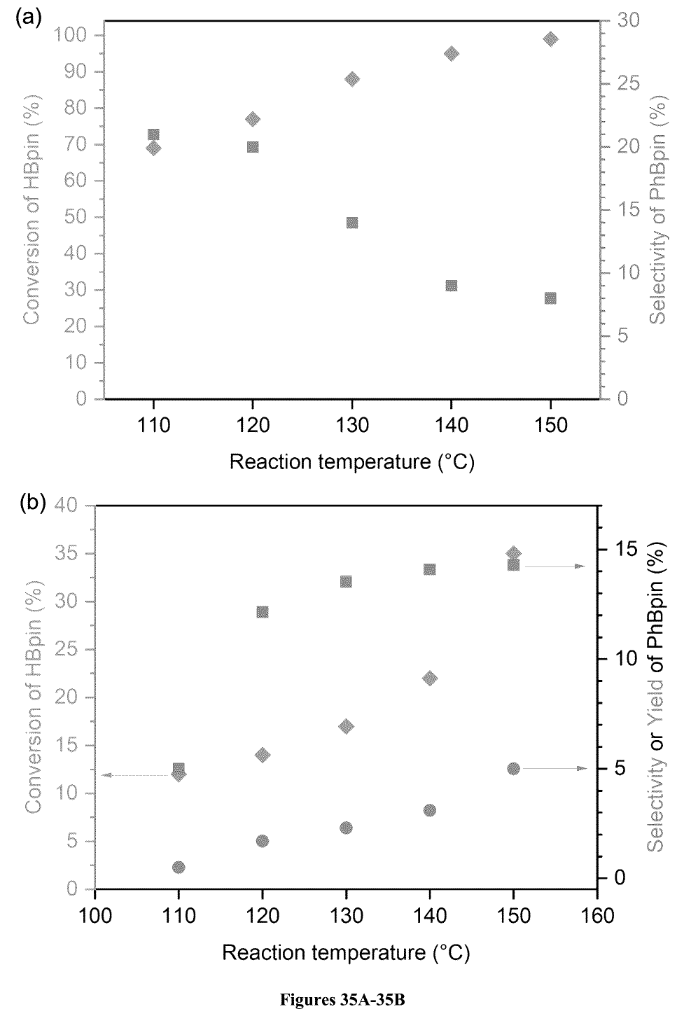

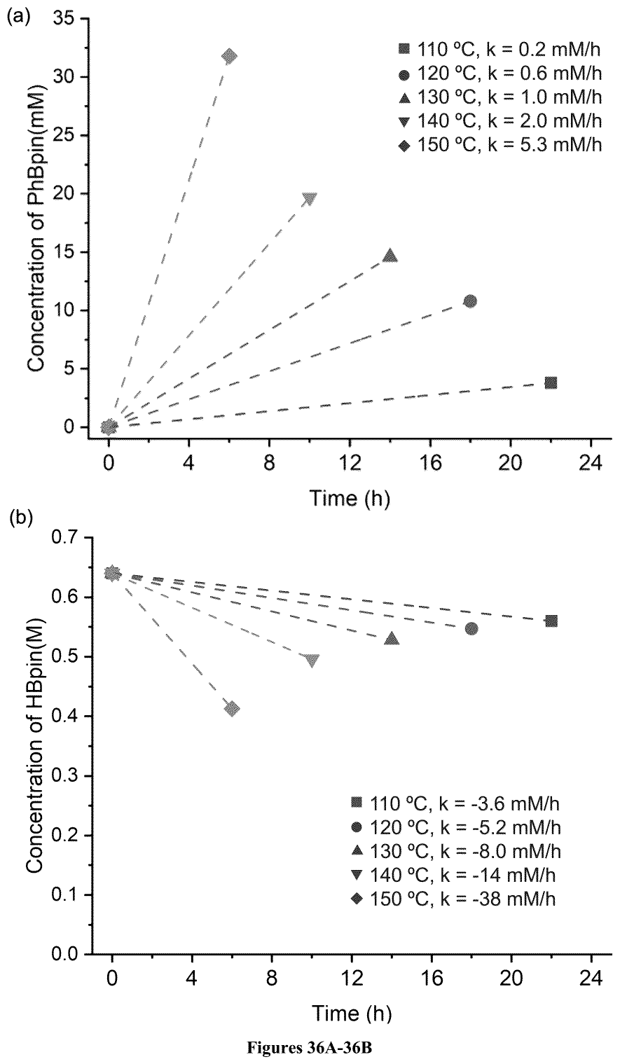

Rates for PhBpin and HBpin were also investigated at various temperatures (110-150° C.). Firstly, the selectivity of PhBpin was reduced from 22% to 6.9% when the temperature was increased from 110° C. to 150° C. (FIG. 35A). Concentrations of formed PhBpin and consumed HBpin were plotted as functions of time at each temperature when HBpin conversions were less than 35% (conversion and selectivity are shown in FIG. 35B). Under such kinetic control region, PhBpin production and HBpin conversion were linear with time, so zero-order rate constants of PhBpin formation and HBpin consumption were calculated from slops of two plots (FIGS. 36A and 36B).

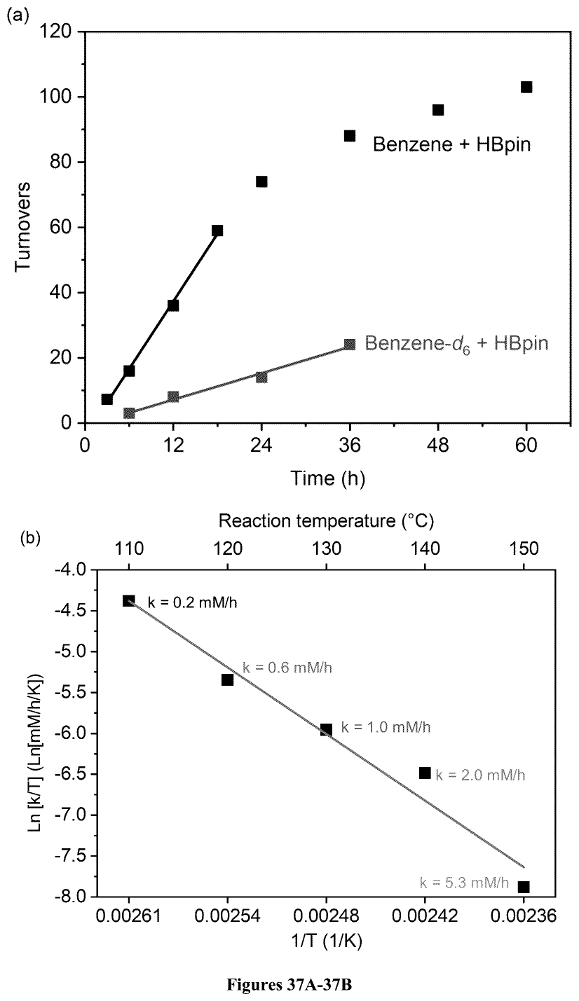

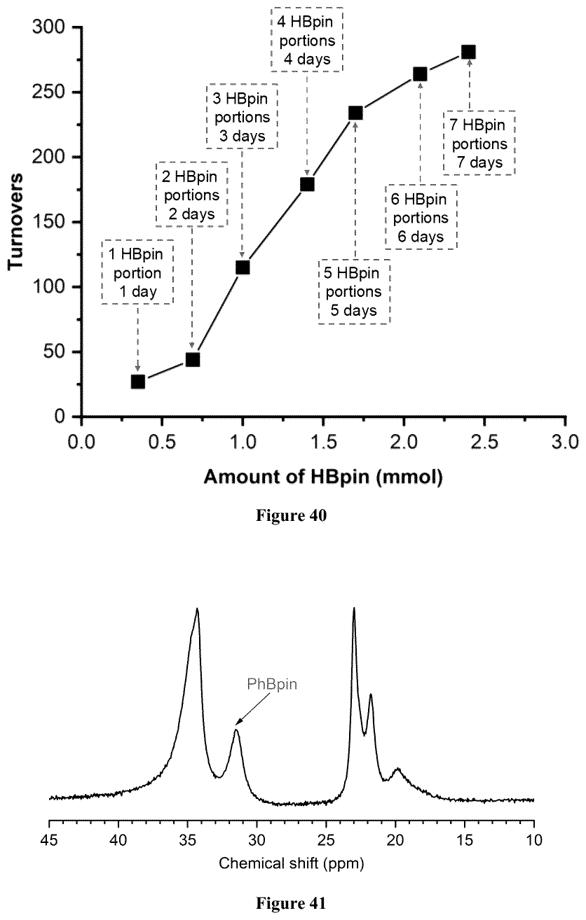

In order to achieve higher turnovers of PhBpin, portion-wise addition experiments were performed by adding 0.050 mL of HBpin every 24 hours into reaction mixture started with 1.00 benzene and 0.030 g precatalyst La(BH₄)₂(AlMe₃)-Ph₃Si—HY₃₀. Each portion of HBpin (0.050 mL) was completely converted within 24 hours. The suppressed HBpin decomposition and improved selectivity to PhBpin was observed (FIGS. 32A and 41). A maximal turnover of PhBpin was reached at 281 after completing a total of 7 portions of HBpin (FIGS. 37A-37B, and 40). Selectivity of PhBpin (Table 18) was lower in the first two portions but significantly enhanced at later three portions because of the side reaction of HBpin (HBpin reacted with methyl species in the pre-catalyst). The slower increase of turnovers was observed in the last two portion-wise additions most likely due to the partial catalyst deactivation.

TABLE 18
Portion-Wise Addition of HBpin Into the Mixture of Benzene and Catalyst
La(BH₄)₂(AlMe₃)—Ph₃Si—HY₃₀ at 120° C.

| | | Total | Total | | | | | |
|---|---|---|---|---|---|---|---|---|
| | | volume of | moles of | | Conversion | Yield of | | Selectivity |
| | C₆H₆ | HBpin | HBpin | t | of HBpin | PhBpin | | of PhBpin |
| Portion | (ml) | (ml) | (mmol) | (h) | (%) | (%) | Turnovers | (%) |
| 1 | 1.0 | 0.05 | 0.35 | 12 | 67 | 7.2 | 13 | 10.7 |
| 1 | 1.0 | 0.05 | 0.35 | 24 | 100 | 15 | 27 | 15 |
| 2 | 1.0 | 0.10 | 0.69 | 48 | 100 | 14 | 44 | 14 |
| 3 | 1.0 | 0.15 | 1.0 | 72 | 98 | 23 | 115 | 23 |
| 4 | 1.0 | 0.20 | 1.4 | 96 | 93 | 25 | 179 | 26 |
| 5 | 1.0 | 0.25 | 1.7 | 120 | 100 | 28 | 234 | 28 |
| 6 | 1.0 | 0.30 | 2.1 | 144 | 100 | 26 | 264 | 26 |
| 7 | 1.0 | 0.35 | 2.4 | 168 | 100 | 24 | 281 | 24 |

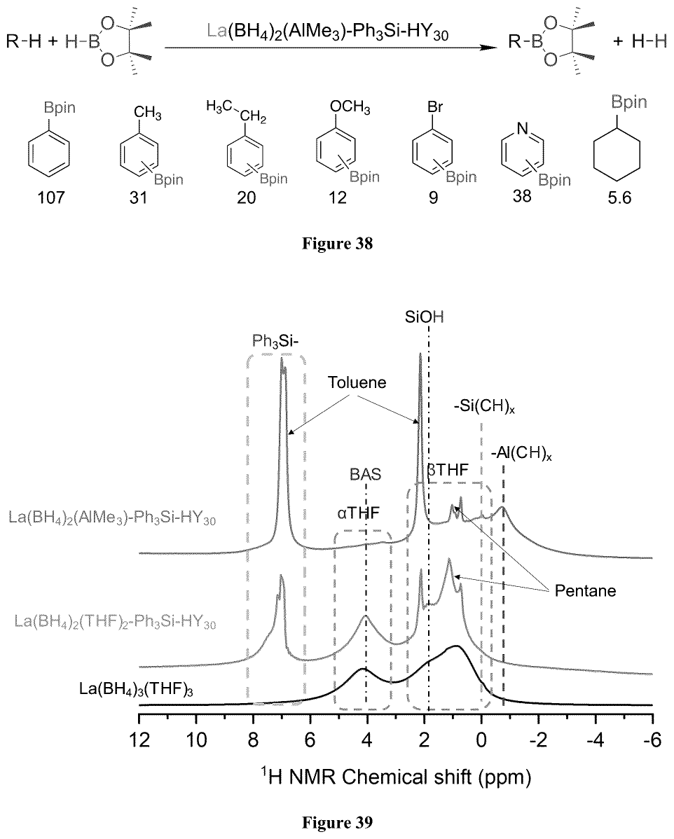

A scope of substrate for catalytic borylation was also studied, including toluene, ethylbenzene, anisole, bromobenzene, pyridine, and cyclohexane. FIG. 38 and Table 19 show turnovers and yields for borylated products. Relatively higher reaction temperatures and longer reaction times were utilized for the other reaction substrates in order to obtain a complete or near-complete HBpin conversion. Decreased turnovers were observed for toluene and ethylbenzene, 31 and 20, respectively, compared to the turnover for benzene (107), showing the steric effect on the reactions under micropore confinement. A turnover of 6 was observed at 150° C. for cyclohexane showing the reactivity of La to sp² hybridized carbon. Consequently, catalytic C—H borylation of substrates other than benzene were achieved through employment of the desired precatalyst La(BH₄)₂(AlMe₃)-Ph₃ Si—HY₃₀.

TABLE 19
Substrate Scope Experiments

| | | | Conversion | Yield of | |
|---|---|---|---|---|---|
| | T | t | of | Borylated | Selectivities of |
| Substrate | (° C.) | (h) | HBpin (%) | products (%) | Products (%) |
| 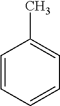 | 120 | 60 | 91 | 11 | 0:23:42:31 (—CH₂:o:m:p) |
| Toluene | | | | | |
| 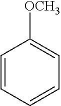 | 140 | 48 | 100 | 4.3 | 9:62:28 (-o:-m:-p) |
| Anisole | | | | | |
| 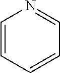 | 140 | 48 | 100 | 13 | 4:22:74 (-o:-m:-p) |
| Pyridine | | | | | |
| 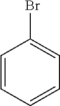 | 140 | 48 | 100 | 3.2 | 0:19:81 (-o:-m:-p) |
| Bromobenzene | | | | | |
| 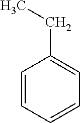 | 120 | 60 | 96 | 7.1 | 15:14:42:29 (—CH₂CH₂:-o:-m: -p) |
| Ethylbenzene | | | | | |
| 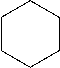 | 150 | 36 | 100 | 1.9 | 1.9 |
| Cyclohexane | | | | | |

In summary, the borylation precatalyst La(BH₄)₂(AlMe₃)-Ph₃Si—HY₃₀ was obtained via reaction of La(BH₄)₂(THF)₂-Ph₃Si—HY₃₀ with AlMe₃, presenting enhanced activities in terms of HBpin selectivity and PhBpin yield. Roles of AlMe₃ were found to include: (1) 5-fold decrease in HBpin decomposition resulting from reduction of residual BAS; (2) activation of Si—O—La(BH₄)₂(THF)₂ sites by reaction with AlMe₃; and (3) modification of lanthanum catalytic sites to form ≡Si(≡Al)—O—La(BH₄)₂(AlMe₃) that were 3-fold more active for borylation. In particular, elevated selectivity (˜25%) of borylated products was obtained through mitigated reaction conditions and more than 280 turnovers were achieved via portion addition of THBpin. Borylation of various aromatic derivatives and hydrocarbons were also achieved with this AlMe₃-modified zeolite supported lanthanum organometallics La(BH₄)₂(AlMe₃)-Ph₃Si—HY₃₀.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A supported rare earth-catalyst comprising:
a metal oxide support having Brønsted acid sites; and
a rare earth element-catalyst, wherein said rare earth element-catalyst is bound to the Brønsted acid sites on the metal oxide support.

2. The supported rare earth-catalyst of claim 1, wherein the metal oxide support is a silica/alumina support.

3. The supported rare earth-catalyst of claim 1, wherein the metal oxide support is a zeolite having capped silanol groups and micropores within which are the Brønsted acid sites.

4. The supported rare earth-catalyst of claim 1, wherein the Brønsted acid sites have the following structure: Al—O—Si.

5. The supported rare earth-catalyst of claim 1, wherein the metal oxide support is a zeolite base selected from the group consisting of FAU, BEA, MFI, FER, MOR, LTA, and LTL.

6. The supported rare earth-catalyst of claim 1, wherein the rare earth element-catalyst is a group 3 or lanthanide containing catalyst.

7. The zeolite-supported rare earth-catalyst of claim 6, wherein the rare earth element-catalyst contains Sc, Y, La, Ce, Pr, Nd, Sm, Eu, Gd, Tb, Dy, Ho, Er, Tm, Yb, or Lu.

8. The supported rare earth-catalyst of claim 1, wherein the rare earth element-catalyst has the formula La(BH₄)ₓ(THF)ₙ, wherein x is from 1-2 and n is 0-4.

9. The supported rare earth-catalyst of claim 1, wherein the supported rare earth-catalyst has the formula La(BH₄)ₓ(THF)—CG-HY₃₀, wherein
CG is a capping group and
HY₃₀ is a microporous faujasite zeolite.

10. The supported rare earth-catalyst of claim 1, wherein the supported rare earth-catalyst has the formula La(BH₄)ₓ(AlR₃)_{y}-CG-HY₃₀, wherein
R is C₁₋₆ alkyl, C₃₋₆ cycloalkyl, aryl, or H;
x is 0-3;
y is 0-4; and
HY₃₀ is a microporous faujasite zeolite.

11. The supported rare earth-catalyst of claim 1, wherein the rare earth element-catalyst is located within about 3.5 Å from the Brønsted acid sites.

12. A method of producing a supported rare earth-catalyst, said method comprising:
providing a metal oxide support having Brønsted acid sites;
providing a capping agent;
reacting the metal oxide support with the capping agent under conditions effective to produce a metal oxide support containing capped functional groups;
providing a rare earth element-catalyst; and
depositing the rare earth element-catalyst on the metal oxide support containing capped functional groups to produce the supported rare earth-catalyst, wherein said rare earth element-catalyst is bound to the Brønsted acid sites on the metal oxide support.

13. The method of claim 12, further comprising reacting the supported rare earth-catalyst with a secondary capping agent.

14. The method of claim 12, wherein the capping agent is a silanol capping agent.

15. The method of claim 14, wherein the silanol capping agent is selected from the group consisting of Ph₃SiCl (TPSCl), Ph₃SiI, Ph₃SiBr, Ph₃SiF, Ph₃SiOTf, Ph₃Si(C₃H₅), (C₆H₄Me)₃SiCl, (C₆H₄Me)₃SiI, (C₆H₄Me)₃SiBr, (C₆H₄Me)₃SiF, (C₆H₄Me)₃SiOTf, (C₆H₄Me)₃Si(C₃H₅), (C₆H₃Me₂)₃SiCl, (C₆H₃Me₂)₃SiI, (C₆H₃Me₂)₃SiBr, (C₆H₃Me₂)₃SiF, (C₆H₃Me₂)₃SiOTf, (C₆H₃Me₂)₃Si(C₃H₅), Ph₂MeSiCl, Ph₂MeSiI, Ph₂MeSiBr, Ph₂MeSiF, Ph₂MeSiOTf, Ph₂MeSi(C₃H₅), Ph₂EtSiCl, Ph₂EtSiI, Ph₂EtSiBr, Ph₂EtSiF, Ph₂EtSiOTf, Ph₂EtSi(C₃H₅), PhMe₂SiCl (DMPSCl), PhMe₂SiI, PhMe₂SiBr, PhMe₂SiF, PhMe₂SiOTf, and PhMe₂Si(C₃H₅).

16. The method of claim 13, wherein the secondary capping agent is selected from the group consisting of Ph₃SiCl (TPSCl), Ph₃SiI, Ph₃SiBr, Ph₃SiF, Ph₃SiOTf, Ph₃SiNMe₂, Ph₃Si(C₃H₅), (C₆H₄Me)₃SiCl, (C₆H₄Me)₃SiI, (C₆H₄Me)₃SiBr, (C₆H₄Me)₃SiF, (C₆H₄Me)₃SiOTf, (C₆H₄Me)₃SiNMe₂, (C₆H₄Me)₃Si(C₃H₅), (C₆H₃Me₂)₃SiCl, (C₆H₃Me₂)₃SiI, (C₆H₃Me₂)₃SiBr, (C₆H₃Me₂)₃SiF, (C₆H₃Me₂)₃SiOTf, (C₆H₃Me₂)₃SiNMe₂, (C₆H₃Me₂)₃Si(C₃H₅), Ph₂MeSiCl, Ph₂MeSiI, Ph₂MeSiBr, Ph₂MeSiF, Ph₂MeSiOTf, Ph₂MeSi(C₃H₅), Ph₂EtSiCl, Ph₂EtSiI, Ph₂EtSiBr, Ph₂EtSiF, Ph₂EtSiOTf, Ph₂EtSi(C₃H₅), PhMe₂SiCl (DMPSCl), PhMe₂SiI, PhMe₂SiBr, PhMe₂SiF, PhMe₂SiOTf, PhMe₂Si(C₃H₅), PhMeHSiCl, PhMeHSiI, PhMeHSiBr, PhMeHSiF, PhMeHSiOTf, PhMeHSi(C₃H₅), Ph₂HSiCl, Ph₂HSiI, Ph₂HSiBr, Ph₂HSiF, Ph₂HSiOTf, Ph₂HSi(C₃H₅), PhH₂SiCl, PhH₂SiI, PhH₂SiBr, PhH₂SiF, PhH₂SiOTf, PhH₂Si(C₃H₅), Me₃SiCl, Me₃SiI, Me₃SiBr, Me₃SiF, PhMe₂SiOTf, PhMe₂Si(C₃H₅), Me₂HSiCl, Me₂HSiI, Me₂HSiBr, Me₂HSiF, Me₂HSiOTf, and Me₂HSi(C₃H₅).

17. The method of claim 12, wherein the metal oxide support is a zeolite selected from the group consisting of FAU, BEA, MFI, FER, MOR, LTA, and LTL.

18. The method of claim 12, wherein the rare earth element-catalyst is a group 3 or lanthanide containing catalyst.

19. The method of claim 18, wherein the rare earth element-catalyst contains Sc, Y, La, Ce, Pr, Nd, Sm, Eu, Gd, Tb, Dy, Ho, Er, Tm, or Yb.

20. The method of claim 12, wherein the lanthanide containing catalyst has the formula La(BH₄)ₓ(THF)ₙ, wherein x is from 0-2 and n is 0-4.

21. The method of claim 12, wherein the supported rare earth-catalyst has the formula La(BH₄)ₓ(THF)—CG-HY₃₀, wherein
CG is a capping group and
HY₃₀ is a microporous faujasite zeolite.

22. The method of claim 12, further comprising:
providing a compound of Formula (A): 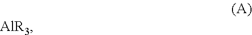
wherein R is C₁₋₆ alkyl, C₃₋₆ cycloalkyl, aryl, or H; and
reacting the supported rare earth-catalyst with the compound of Formula (A) under conditions effective to produce a modified supported rare earth-catalyst.

23. The method of claim 22, wherein the modified supported rare earth-catalyst has the formula La(BH₄)ₓ(AlR₃)_{y}-CG-HY₃₀, wherein
CG is a capping group;
R is C₁₋₆ alkyl, C₃₋₆ cycloalkyl, aryl, or H;
x is 0-3;
y is 0-4; and
HY₃₀ is a microporous faujasite zeolite.

24. A method for borylation of hydrocarbons comprising:
providing a hydrocarbon;
providing a supported rare earth-catalyst;
providing a borylation reagent; and
reacting the hydrocarbon with the borylation reagent in the presence of a supported rare earth-catalyst under conditions effective to borylate the hydrocarbon.

25. The method of claim 24, wherein the supported rare earth-catalyst comprises:
a metal oxide support having Brønsted acid sites; and
a rare earth element-catalyst,
wherein said rare earth element-catalyst is bound to the Brønsted acid sites on the metal oxide support.

26. The method of claim 24, wherein the hydrocarbon is selected from the group consisting of unsubstituted and substituted aromatic hydrocarbon, unsubstituted and substituted heteroaromatic hydrocarbon, unsubstituted and substituted polyolefin, and unsubstituted and substituted alkane, unsubstituted and substituted cycloalkane.

27. The method of claim 26, wherein the hydrocarbon is benzene.

28. The method of claim 26, wherein the hydrocarbon is toluene.

29. The method of claim 26, wherein the hydrocarbon is selected from the group consisting of poly(propylene), poly(butene), and poly(ethylene-co-octene).

30. The method of claim 26, wherein the hydrocarbon is an unsubstituted or substituted alkane or unsubstituted or substituted cycloalkane.

31. The method of claim 26, wherein the hydrocarbon is methane.

32. The method of claim 24, wherein the borylation reagent is selected from the group consisting of pinacolborane, bis(pinacolborane), catechol borane, 9-BBN, R₃N—BH₃, R₂S—BH₃, pyridine-BH₃, NaBH₄, RBH₂, and R₂BH, wherein R is C₁₋₆ alkyl or aryl.

33. The method of claim 24, wherein said reacting is conducted at a temperature of from about 100° C. to about 150° C.

34. The method of claim 24, wherein said reacting is conducted for about 3 to about 72 hours.

35. The method of claim 24, wherein the borylated hydrocarbon is monoborylated.

36. The method of claim 24, wherein the borylated hydrocarbon is diborylated.

37. The method of claim 24, wherein the borylation reagent is added once during said reacting.

38. The method of claim 24, wherein the borylation reagent is added twice during said reacting.

39. The method of claim 24, wherein the borylation reagent is added three time during said reacting.

40. The method of claim 24, wherein the borylation reagent is added four times during said reacting.
